(19) United States
(12) Patent Application Publication
(10) Pub. No.: US 2025/0280295 A1
(43) Pub. Date: Sep. 4, 2025

(54) A METHOD OF JOINING A COMMUNICATION NETWORK

(71) Applicant: KONINKLIJKE PHILIPS N.V., EINDHOVEN (NL)

(72) Inventors: Oscar Garcia Morchon, Valkenswaard (NL); Noureddine Sabah, Eindhoven (NL); Robert James Davies, Eindhoven (NL)

(21) Appl. No.: 18/863,746

(22) PCT Filed: May 8, 2023
(86) PCT No.: PCT/EP2023/062089

§ 371 Date: Nov. 7, 2024

(30) Foreign Application Priority Data
May 9, 2022 (EP) 22172337.2
May 13, 2022 (EP) 22173225.8
Jun. 17, 2022 (EP) 22179674.1
Jun. 27, 2022 (EP) 22181188.8
Aug. 7, 2022 (EP) 22189166.6
Sep. 7, 2022 (EP) 22194455.6
Sep. 22, 2022 (EP) 22197173.2
Sep. 30, 2022 (EP) 22199031.0
Oct. 12, 2022 (EP) 22201160.3
Nov. 4, 2022 (EP) 22205459.5
Nov. 11, 2022 (EP) 22207014.6
Jan. 16, 2023 (EP) 23151643.6
Jan. 18, 2023 (EP) 23152133.7
Jan. 19, 2023 (EP) 23150646.0
Jan. 30, 2023 (EP) 23153838.0
Feb. 19, 2023 (EP) 23157430.2
Feb. 23, 2023 (EP) 23158306.3
Mar. 24, 2023 (EP) 23163947.7
Apr. 19, 2023 (EP) 23168795.5

(51) Int. Cl. H04W 12/106; H04W 12/0431; H04W 12/06; H04W 60/04; H04W 74/0833

(52) U.S. Cl. CPC H04W 12/106; H04W 12/0431; H04W 12/06; H04W 60/04; H04W 74/0833

(57) ABSTRACT

The invention relates to an apparatus for verifying the information sent to a second device, the apparatus comprising a memory adapted to store information and a transceiver adapted to send and receive messages, wherein the apparatus is configured to send a first message with the information to the second device, wherein the apparatus is configured to receive a verification challenge from the second device, wherein the apparatus is adapted to compute and send to the second device a response based on the verification challenge, keying material shared between the first and second device, and the information exchanged in the first message.

### FIELD OF THE INVENTION

The invention relates to security application and in particular to a secure method for joining and communicating in a communication network, such as—but not limited to—cellular networks.

### BACKGROUND OF THE INVENTION

In cellular networks, a primary station serves a plurality of secondary stations located within a cell served by this primary station. Wireless communication from the primary station towards each secondary station is done on downlink channels. Conversely, wireless communication from each secondary towards the primary station is done on uplink channels. The wireless communication can include data traffic (sometimes referred to as User Data), and control information (also referred to sometimes as signalling). This control information typically comprises information to assist the primary station and/or the secondary station to exchange data traffic (e.g. resource allocation/requests, physical transmission parameters, information on the state of the respective stations).

In the context of cellular networks as standardized by 3GPP, the primary station is referred to a base station, or a gNodeB (or gNB) in 5G (NR) or an eNodeB (or eNB) in 4G (LTE). The eNB/gNB is part of the Radio Access Network RAN, which interfaces to functions in the Core Network (CN). In the same context, the secondary station corresponds to a mobile station, or a User Equipment (or a UE) in 4G/5G, which is a wireless client device or a specific role played by such device. The term “node” is also used to denote either a UE or a gNB/eNB.

Additionally, for example, in the case of PC5 interface or Sidelink communication, it is possible to have Direct communication between secondary stations, here UEs. It is then also possible for UEs to operate as Relays to allow for example out of coverage UE to get an intermediate (or indirect) connection to the eNB or gNB. To be able to work as a relay, a UE may use discovery messages to establish new connections with other UEs.

Secondary stations perform an initial authentication procedure with the core network to authenticate each other and establish an initial security context. The core network also offers means for the secondary stations to establish a secure communication link with application functions. New access networks are also being designed and deploy to enable secondary stations to access the core network over a non-terrestrial network, by using mobile primary stations or smart repeaters extending the range of the primary stations.

Network access protocols may be susceptible to a Man in the Middle attacks or an overshadow attacks. A Man-in-the-middle (MitM) attacker is an attacker who is placed between a primary station and a secondary station and is capable of forwarding, modifying, injecting, or dropping messages. In an overshadow attack, an attacker injects a signal that modifies the received message by the receiver. Several specific attacks that a MitM can carry out are described in the literature. For instance the MitM may be capable of modifying the security capabilities of a secondary station. The security capabilities might include the confidentiality or integrity algorithms that the UE supports or that the UE prefers, e.g., a New Radio Integrity Algorithm (NIA) or a New Radio Encryption Algorithm (NEA) in 5G. By modifying the preferred or supported security capabilities, the MitM can manage to trigger different types of attacks such as a SUPI catching attack or IP spoofing attack.

Based on the authentication and key agreement phase between a secondary station and the core network, a main key might be derived and stored at a network function, e.g., 5G AUSF, and secondary station. Based on this key, further keys might be derived, e.g., to serve applications. Regarding the derivation and management of keys, there are multiple issues. For instance, (1) when a secondary station moves from an LTE to a 5G network, (2) when an application has used an application key for a long time, or (3) when a secondary station is roaming. This last aspect also has implications with regard to, e.g., lawful interception since when a secondary station is roaming in the VPLMN, the VPLMN may wish to have the decryption keys for the communication between AF and secondary station independently of the location of the AF (VPLMN, HPLMN, or outside).

Furthermore, a secondary station may also need to share certain parameters (or personal identifiable information) with, e.g., a primary station (RAN) or some network functions. For instance, a secondary station accessing via a non-terrestrial network (NTN) may need to share its coarse location. Indeed, in this example, the coarse location of the secondary station may be required, e.g., to assign a correct AMF to the secondary station. The sharing of such parameters may happen after the establishment of a secure connection between a secondary station and a primary station to ensure that this information is not eavesdropped. Even if the sharing of such a location information may be done in a secure way (protected by AS security), user consent may still be required.

A secondary station might also share certain identifiers over the wireless interface without protection. For instance, the “priority access” value exchanged in the initial random-access procedure is not protected, in other words, the 5G standard allows the establishment causes like “highPriorityAccess”, “mps-PriorityAccess”, “mcs-PriorityAccess” to be sent in clear over the air. The disclosure of this information in the clear might allow an attacker to identify the features of a UE or a communication posing a privacy risk. Current solutions are not capable of protecting these fields.

Similarly, in 3GPP, new RAN components such as mobile primary stations or the network-controlled repeater (NCR) are being developed. Still, it is unclear how such NCR or mobile primary stations are to be authenticated and authorized in the network when they connect to the network.

### SUMMARY OF THE INVENTION

An aim of the invention is to provide a method that is resilient to these types of attacks.

Another aim of the invention is to provide enhanced security capabilities, e.g., supporting AKMA in roaming scenarios.

Another aim of the invention is to provide a communication device that is resilient to attacks, and in particular this type of MitM attacks. Another aim of the invention is to provide a communication system that can detect an attacker using this type of attacks when attempted in a network.

Another aim of the invention is to enhance the overall key agreement and derivation procedures.

Another aim of the invention is to provide enhanced security capabilities, e.g., user consent.

Another aim of the invention is to provide enhanced security capabilities, e.g., means to authenticate and authorize an NCR.

Another aim of the invention is to provide enhanced security capabilities, e.g., protection of identifiers over the wireless interface.

A reason why the attacks can succeed in certain scenarios is because the MitM is capable of modifying message 110 in such a way that parameters such as the preferred/supported security capabilities of the UE 100 (or its location, or the type of device the UE is) are changed giving a wrong indication to the core network 104, for example the usage of the NIA0 and NEA0 integrity/encryption algorithms that are equivalent to no integrity and no encryption.

Thus, in accordance with a current definition of the invention, it is described how this information, namely the security capabilities, can be protected, e.g., by including it in the authentication and key agreement phase 106 so that the performed authentication checks depend on the security parameters sent by the UE.

According to a first aspect of the invention, it is proposed an apparatus for verifying the sensitive fields sent to a second device, the apparatus comprising
a memory adapted to store information and
a transceiver adapted to send and receive messages,
wherein the apparatus is configured to
   send a first message with the sensitive fields to the second device,
receive a verification challenge from the second device,
   compute and send to the second device a response based on the verification challenge, keying material shared between the first and second device, and the sensitive fields exchanged in the first message.

In accordance with a second aspect of the invention, it is proposed an apparatus for verifying the sensitive fields received from a first device, the apparatus comprising
a memory to store information and
a transceiver to send and receive messages,
wherein the apparatus is configured to
receive a first message with the sensitive fields from the first device,
receive a response from the first device, and
check whether a function of the response matches a value dependent on the received sensitive fields in the first message.

In accordance with a third aspect of the invention, it is proposed a system comprising at least a first communication device of the first aspect of the invention and and at least one second device of the second aspect of the invention.

Besides, in accordance with a fourth aspect of the invention, it is proposed a method for verifying the sensitive fields sent to a second device, the method comprising:
a. a first device sending a first message with the information to the second device,
b. receiving verification challenge from the second device,
c. computing and sending to the second device a response based on the verification challenge, keying material shared between the first and second device, and the sensitive fields exchanged in the first message.

In accordance with a fifth aspect of the invention, it is proposed an apparatus for securing a message with a second device, wherein the apparatus is configured to perform the following steps
a) if a security context is available and a configured policy allows it, retrieving a symmetric-key; or
if no security context is available or a configured policy requires it, generating a symmetric-key and using a first public-key bounded to a private-key owned by the second device to encrypt the generated symmetric-key, and
(b) sending to the second device a secure message protected with the symmetric key and the protected symmetric-key or an indication to retrieve the symmetric-key.

In accordance with a sixth aspect of the invention, it is proposed an apparatus for secure communication in a UE to Network relay scenario whereby the apparatus is adapted to:
store a policy determining the apparatus behavior when a Direct Security Mode Command is received; and
reject and/or accept a received Direct Security Mode Command that is unprotected and/or includes NULL ciphering and integrity algorithms based on the policy, said policy including determining whether the apparatus had previously sent a DCR message including an emergency RSC.

In a variant of the sixth aspect of the invention, it is proposed that the apparatus is adapted to only accept a received Direct Security Mode Command that is unprotected and/or includes NULL ciphering and integrity algorithms if the apparatus had previously sent a DCR message including an emergency RSC.

Further, the apparatus may be adapted to reject a received Direct Security Mode Command that is unprotected and/or includes NULL ciphering and integrity algorithms if the apparatus has not previously sent a DCR message including an emergency RSC.

In accordance with a seventh aspect of the invention, it is proposed a method for secure communication in a UE to Network relay scenario wherein a remote UE is adapted to:
store a policy determining the UE behavior when a Direct Security Mode Command is received; and
reject and/or accept a received Direct Security Mode Command that is unprotected and/or includes NULL ciphering and integrity algorithms based on the policy including
determining whether the apparatus had previously sent a DCR message including an emergency RSC.

In accordance with an eighth aspect of the invention, it is proposed a method for lawful interception wherein:
a second network function, NF, in a second network optionally signaling Lawful Interception requirements to a first NF in a first network, and
the second NF receiving from the first NF key material, and
the second NF decrypting intercepted traffic exchanged between a User Equipment, UE, and an application function, AF based on the provided key material.

In accordance with a ninth aspect of the invention, it is proposed a method for lawful interception wherein:
a first network function, NF, in a first network optionally receiving signaling of Lawful Interception requirements from a second NF in a second network, and
the first NF transmitting key material to the first NF, so that the second NF can decrypt intercepted traffic exchanged between a User Equipment, UE, and an application function, AF based on the provided key material.

In accordance with a tenth aspect of the invention, it is proposed a second Network Function, NF, apparatus in a second network comprising
a transmitter for optionally signaling Lawful Interception requirements to a first NF in a first network, and
a receiver adapted to receive from the first NF key material, and
a controller adapted to decrypt intercepted traffic exchanged between a User Equipment, UE, and an application function, AF based on the provided key material.

In accordance with an eleventh aspect of the invention it is proposed a first Network Function, NF, apparatus in a first network comprising:
a receiver for receiving signaling of Lawful Interception requirements from a second NF in a second network, and
a transmitter for transmitting key material to the first NF, so that the second NF can decrypt intercepted traffic exchanged between a User Equipment, UE, and an application function, AF based on the provided key material.
   Further, the invention can be implemented by software and thus an aspect of the invention includes a storage media including a code which, once loaded on a computer, enables the computer to perform the steps of the various methods described in this application.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE FIGURES

FIG. 1 and FIG. 2 represent a connection protocol as used in a conventional system and are used to illustrate some of the embodiments.

FIG. 3 represents an exemplary attack scenario involving a MitM.

FIG. 4 represents an embodiment for the renewal of Kaf.

FIG. 5 represents an additional embodiment for the renewal of Kaf.

FIG. 6 represents an embodiment to deal with a MitM.

FIG. 7 represents an embodiment for AKMA roaming.

FIG. 8 represents an additional embodiment for AKMA roaming.

FIG. 9 represents an additional embodiment for secure access to the NTN service.

FIG. 10 represents an embodiment for the establishment of a shared key.

FIG. 11 represents an embodiment for AKMA roaming.

FIG. 12 represents an embodiment for a secure access to the NTN service.

FIG. 13 represents an embodiment for a secure access to the NTN service.

FIG. 14 represents an embodiment for authentication and authorization of an NCR.

FIG. 15 represents an embodiment for authentication and authorization of an NCR by means of EAP-TLS.

FIG. 16 represents a key hierarchy.

FIG. 17 represents an embodiment for lawful interception.

### DETAILED DESCRIPTION OF THE INVENTION

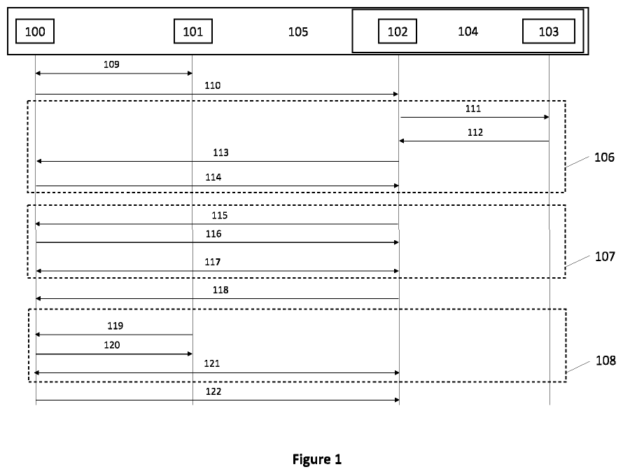

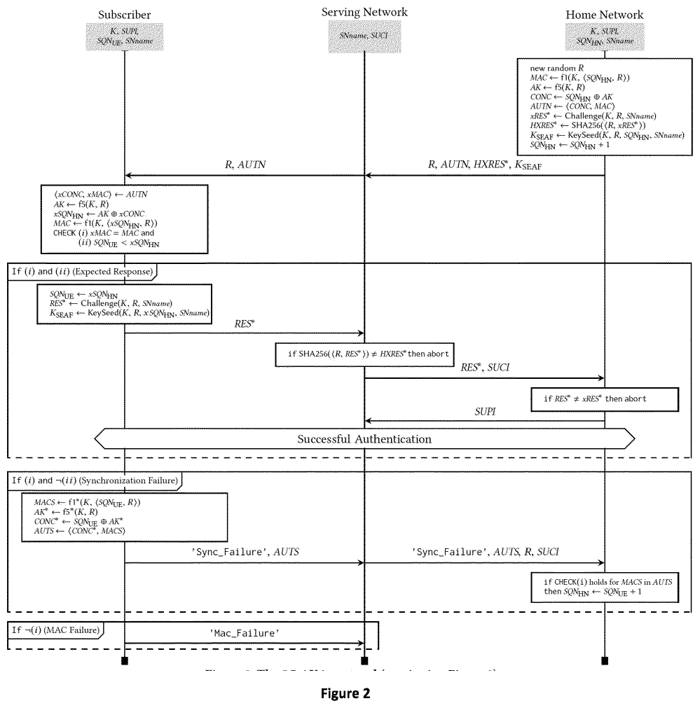

With reference to FIG. 1 it is herein described an example of a protocol including the main phases for a terminal (e.g. a UE) to join a telecommunication work such as a 5G telecommunication network involving multiple entities, e.g.:
100 might be a user equipment in a telecommunications system owned by a user attempting to join the telecommunications system.
101 might be a base station in the telecommunications system such as a 5G gNB.
104 might be the core network of the telecommunication system.
102 might be a function handling the authentication of UEs in a telecommunication system such as the Authentication and Mobility Function (AMF) of the 5G core network.
103 might be a function storing user data such as the Unified Data Management (UDM) function of the 5G core network.
105 represents the overall telecommunications system.

The arrows in the figure represent message interactions between those entities. In this example,
109 represents an initial connection setup that might involve multiple messages, e.g., the RRC connection request.
110 refers to an authentication request, e.g., an attach or registration request.
111 refers to the request of some authentication values given an identity provided in 110, e.g., SUPI.
112 refers to the delivery of an authentication challenge.
113 is an authentication request that might include some input, e.g., from 112.
114 is an authentication response.
106 comprising messages 111-114 refers to an authentication and key agreement phase.
115 represents a message confirming security parameters for communication between 100 and 102.
116 represents a confirmation message indicating that the security link establishment for communication between 100 and 102 is completed.
117 represents the protected communication between 100 and 102.
107 represents several messages (e.g., 115, 116 and 117) for the establishment of a secure link between 100 and 102 and later secure exchange of messages.
119 represents a message indicating the establishment of a secure link between 100 and 101.
120 represents a message indicating the completion of the secure link establishment between 100 and 101.
121 represents the secure exchange of messages between, e.g., 100 and 101.
108 represents multiple messages for the establishment of a secure link between 100 and 101 and later secure exchange of messages.
122 represents a message indicating that 100 has successfully joined 105.

Note that FIG. 1 is illustrative and some entities might be missing or included in other entities. For instance, in 5G the Security Anchor Function (SEAF) or the Authentication Server Function (AUSF) play an important role. The AMF and the SEAF are in the serving network while the AUSF and the UDM are in the home network. The AMF interacts with the SEAF that interacts with the AUSF that interacts with the UDM. The SEAF might reject a UE, however, it relies on the UE's home network to accept the authentication.

One of the authentication procedures in 3GPP is 5G AKA authentication procedure, e.g., where the home network obtains challenges as:
xRES*=Challenge(K, R, SNname), and
HXRES*=SHA256(R, xRES*)

Where K is a symmetric-key, R is a nonce generated by the home network and SNname is the serving network name. Furthermore, the home network obtains MAC as
f_1(K, SQN∥RAND∥AMF)

The home network then provides the serving network with HXRES*. Note that in particular, the UDM/ARPF starts 5G-AKA by sending the authentication response to the AUSF with an authentication vector consisting of an AUTH token, an XRES token, the key K_{AUSF}, and the SUPI if applicable (e.g., when a SUCI is included in the corresponding authentication request), among other data. The AUSF computes a hash of the expected response token (HXRES), stores the key K_{AUSF}, and sends the authentication response to the SEAF, along with the AUTH token and the HXRES. Note that the SUPI is not sent to the SEAF in this authentication response. It is only sent to the SEAF after UE authentication succeeds.

The UE at its side performs similar operations and checks the received MAC and computes a response RES* as:
RES*=Challenge(K, R, SNname)
   The UE then sends the value RES* to the core network.

The serving network checks whether SHA256(R, RES*) equals HXRES*. If it does not, it rejects it.

The home network checks whether RES* equals xRES*. If it does not, it rejects it.

However, this kind of protocol may be susceptible to a Man in the Middle attack or an overshadow attack. A Man-in-the-middle (MitM) attacker is an attacker who is placed between 100 and 101 and is capable of forwarding, modifying, injecting, or dropping messages. In an overshadow attack, an attacker injects a signal that modifies the received message by the receiver.

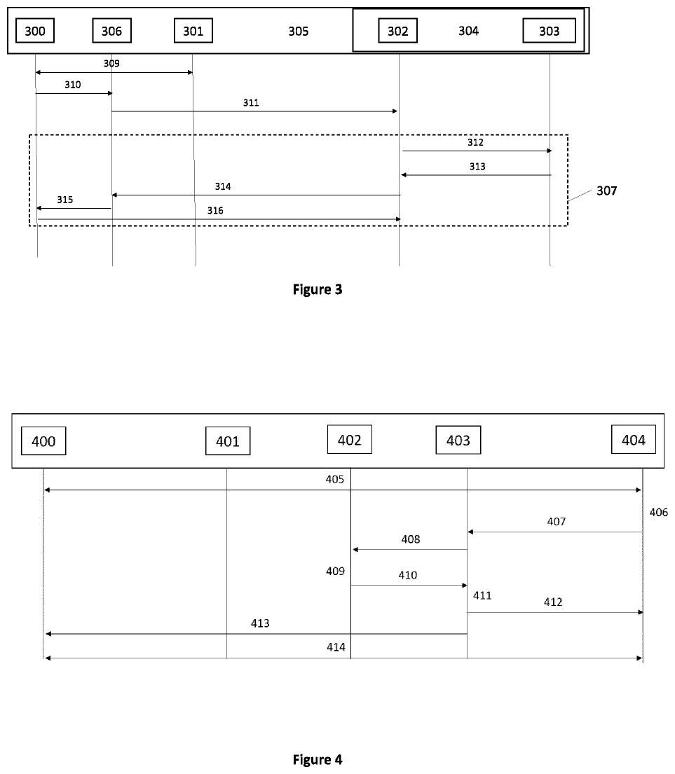

Several specific attacks that a MitM can carry out are described in the literature. The main feature of the attacks—referring to FIG. 1—is that the MitM may be capable of modifying the fields such as security capabilities of 100 in message 110. This is illustrated by means of FIG. 3 where 300, 301, 302, 303, 304, 305 correspond to 100, 101, 102, 103, 104, 105 in FIG. 1. 306 represents a MitM. 309 is equivalent to 109. 310, equivalent to 110, is modified by the MitM that crafts message 311.

The security capabilities might include the confidentiality or integrity algorithms that the UE supports or that the UE prefers, e.g., a New Radio Integrity Algorithm (NIA) or a New Radio Encryption Algorithm (NEA) in 5G.

By modifying the preferred or supported security capabilities, the MitM can manage to trigger a SUPI catching where the long-term identifier of the UE 100 can be captured by the MitM or an IP spoofing attack.

Based on above authentication and key agreement phase 106, a main key, e.g., K_ausf, might be derived and stored at a network function, e.g., 5G AUSF, and UE. Based on this key, further keys might be derived, e.g., to serve applications. These keys might include 5G K_akma (stored at AAnF and UE) or K_af (stored at an application function (AF)) and UE as described in TS 33.535. As described in Clause 6.1 in TS 33.535, the AUSF derives K_akma and an AKMA Key Identifier (A-KID) from Kausf and deploys it to the AAnF. The A-KID includes the AKMA Temporary UE Identifier (A-TID), the Home Network Identifier (HNI) and the Routing Indicator (RID). Clauses A2, A3, and A4 in TS 33.535 define how Kakma, A-TID, and Kaf are derived.

Based on the authentication and key agreement phase between a secondary station and the core network, a main key might be derived and stored at a network function, e.g., 5G AUSF, and UE. Based on this key, further keys might be derived, e.g., to serve applications. These keys might include 5G K_akma (stored at AAnF and UE) or K_af (stored at an application function (AF)) and UE as described in TS 33.535. As described in Clause 6.1 in TS 33.535, the AUSF derives K_akma and an AKMA Key Identifier (A-KID) from Kausf and deploys it to the AAnF. The A-KID includes the AKMA Temporary UE Identifier (A-TID), the Home Network Identifier (HNI) and the Routing IndDicator (RID). Clauses A2, A3, and A4 in TS 33.535 define how Kakma, A-TID, and Kaf are derived.

Regarding the derivation and management of keys dependent on K_ausf, there are multiple issues. For instance, (1) when a UE moves from an LTE to a 5G network, the LTE K_asme is mapped into a K_amf key so that both UE and gNB as well as UE and AMF can communicate in a secure way, however, the K_ausf is missing, and thus, K_akma and K_af as well. Similarly, (2) when an application has used a K_af for a long time, the key K_af might expire, however, there is no way of updating it. Or finally, (3) the current AKMA architecture does not describe how it operates with roaming. This last aspect also has implications with regard to, e.g., lawful interception since when a UE is roaming in the VPLMN, the VPLMN may wish to have the decryption keys for the communication between AF and UE independently of the location of the AF (VPLMN, HPLMN, or outside). A UE might also need to share certain parameters (or personal identifiable information) with, e.g., the gNB (RAN) or some network functions, e.g., a UE accessing via a non-terrestrial network (NTN) may need to share its coarse location. Indeed, in this example, the coarse location of the UE may be required, e.g., to assign a correct AMF to the UE. The sharing of such parameters may happen after the establishment of a secure connection between UE and gNB to ensure that this information is not eavesdropped. Even if the sharing of such a location information may be done in a secure way (protected by AS security), user consent may still be required before the location is actually shared, and knowledge of the UE location might be beneficial for the user consent decision itself. Furthermore, the UE should be securely informed about the user consent preferences. However, current solutions do not fulfil such requirements.

A UE might also share certain identifiers over the wireless interface without protection. For instance, the “priority access” value exchanged in the initial random-access procedure is not protected, in other words, the 5G standard allows the establishment causes like “highPriorityAccess”, “mps-PriorityAccess”, “mcs-PriorityAccess” to be sent in clear over the air. The disclosure of this information in the clear might allow an attacker to identify the features of a UE or a communication posing a privacy risk. Current solutions are not capable of protecting these fields.

Similarly, in 3GPP, a new component, the network-controlled repeater (NCR) is being developed. An NCR is used to improve coverage of a gNB by repeating/forwarding its wireless signals. Still, it is unclear how such NCR is to be authenticated and authorized in the network when it connects to the network.

### Embodiment 1

In a first embodiment, the security capabilities received from the UE in message 110 in the core network should be used in the authentication procedure between core network and UE, e.g., in messages 113 and 114. In particular, in reference to FIG. 1, security challenge xRES* or HXRES* might be computed using as input information provided in a previous message received from the UE, e.g., the initial message 110, e.g., the initial attach or registration request sent by the UE. An example of the input information used refers to the security capabilities of the UE as received by the core network (e.g, serving and/or home network), e.g.
xRES*=Challenge(K, R, SNname, UE security_capabilities)
HXRES*=SHA256(R, xRES*)

Other parameters requiring protection or validation are parameters included in an attach or registration request, such as the AN Parameters in NG-RAN, Registration type, SUCI or 5G-GUTI or PEI, last visited TAI (if available), Security parameters, Requested NSSAI, Mapping of Requested NSSAI, Default Configured NSSAI Indication, UE Radio Capability Update, UE MM Core Network Capability, PDU Session status, etc. Note that the Registration type indicates if the UE wants to perform an Emergency Registration that would force the use of null cipher and integrity algorithms. Other parameters requiring protection may be contextual UE parameters such as its location.

HXRES* could also be computed including explicitly UE security_capabilities although that is not required since those are implicitly included through xRES*. Similarly, the UE has to obtain its response RES* in a similar way, i.e., including the UE security_capabilities that it included in the initial message.
In an example, RES*=Challenge(K, R, SNname, UE security_capabilities)

If this is done, then the check performed by the serving network on whether HXRES* equals SHA256(R, xRES*) will only hold if the UE security_capabilities have not been modified (by a MitM). Furthermore, the check performed by the home network on whether RES* equals xRES* will only hold if the UE security_capabilities have not been modified (by a MitM).

A remark is that instead of having the information “info” to be verified (e.g., other fields exchanged in the initial messages such as NAS registration request) as part of input to the function generating one of above challenges, e.g., in xRES*=Challenge(K, R, SNname, info), the information might be used together with one of the internal parameters, e.g., the key K, to derive another internal parameter, e.g., K′. This could be done by, e.g., applying a key derivation (KDF). For instance, K′=KDF(K, info). Then this new parameter K′ can be used to derive the challenge/response as usual: xRES*=Challenge(K′, R, SNname). This remark also applies to other embodiments.

The above computations refer to Clause 6.1.1.3 in TS 33.501.

An additional remark is that the generation of above parameter xRES* including UE security_capabilities may require the exchange of the UE security_capabilities received by the AMF in the Initial UE Message NAS-PDU: Registration Request in the Nausf_UEAuthenticate_authenticate Request sent from the AMF to the AUSF and including the SUCI. Similarly, it might require sending said UE security_capabilities from the AUSF to the UDM in the Nudm_UEAuthenticate_Get Request message so that the UDM can perform above computation.

### Embodiment 2

In an alternative embodiment, the UE security capabilities can be included in the home network MAC. Hence, instead of computing the MAC as
f_1(K, SQN∥RAND∥AMF),
   the home network may compute it as
MAC=f_1(K,SQN∥RAND∥AMF∥UE_SC_F).
   Where UE_SC_F refers to the UE security_capabilities, or in general, the information that requires verification.

This may be done prior to the transmission of message 113 in FIG. 1. On the UE side, upon reception of message 113, once USIM retrieves SQN, the UE can compute XMAC in the same way (i.e., using as input the parameters that require verification) and compare it against the received MAC.

### Embodiment 3

The introduction of a new type of check (as in the other Embodiments) can lead to the situation that the telecommunications system has to differentiate between legacy UEs that do not support the enhanced authentication procedure and new UEs that support the enhanced authentication procedure. It might be assumed that home networks hosting new UEs are new home networks, i.e., supporting new authentication methods even if they might still host legacy UEs. However, a new UE might interact with a new home network through a legacy service network.

To address this, in a first embodiment alternative, a new UE might transmit in an initial message 110 the preferred authentication method, e.g., the authenticated method as outlined in other embodiments. This might be signaled by means of a message field that might indicate the protocol version. A single bit might be enough. If it is a new UE, then the home network and UE might use, e.g., a solution as in other embodiments, e.g., (e.g., Embodiment 1.2).

To address this, in a second alternative, legacy and new UEs might transmit always identical initial message 110, i.e., without indication of the protocol version. In this case, the serving network might check (as it currently does), i.e.:
HXRES*=SHA256(R, xRES*)

Note that the security capabilities check is already implicitly included in xRES* so that nothing needs to be changed in a legacy service network. The home network might first check:
RES*=Challenge(K, R, SNname, UE security_capabilities),
   and if this check fails, then check whether
RES*=Challenge(K, R, SNname)

This procedure in which the protocol version is not included has the advantage that an attacker does not know which UEs are legacy and which UEs are new so that the attacker cannot launch a targeted attack.

If above check fails, the home network may inform the (legacy) serving network of the failed authentication procedure.

### Embodiment 4

TS 33.501 Clause 6.7.2 describes a possible implementation of messages 115 and 116 in reference to FIG. 1. These messages protect the Registration Request against a man-in-the-middle attack where the attacker modifies the IEs containing the UE security capabilities provided by the UE in the Registration Request. However, if the MitM sets IEs containing security capabilities to include null integrity/confidentiality, messages 115 and 116 as per TS 33.501 Clause 6.7.2, i.e., NAS security mode command and NAS security mode complete, may not apply integrity/confidentiality protection.

Thus, in a further embodiment in reference to FIG. 1, messages 115 and/or 116 are integrity protected and/or confidentiality protected even if the network (e.g., 102) has chosen null integrity and/or null confidentiality configurations. These messages are protected with a key derived from the previous authentication procedure (messages 113 and 114).

### Embodiment 5

In a variant of the attack described above, the Man-in-the-Middle attacker controlling a malicious gNB and a malicious UE might intercept the registration message (e.g., Registration Request) sent from a victim UE to the legitimate network (e.g., AMF), and change it to indicate that the registration is intended for emergency services (i.e., edit the Registration type field to correspond to an Emergency Registration) and, optionally, only include null ciphering and null integrity algorithms in the security capabilities (i.e., NEA0 and NIA0) or set the null integrity algorithms to the highest priority. The modified Registration Request is sent by the attacker to the legitimate network, which, according to TS 33.501 Clause 10.2.2.2, may allow or reject an emergency registration request based on its configured policy. The serving network may also allow or reject unauthenticated UEs to establish bearers for unauthenticated IMS emergency sessions, and AMF may attempt to authenticate the UE after receiving the emergency registration request.

If the serving network's policy allows for unauthenticated IMS emergency services, and AMF attempts to authenticate the UE, the MitM may forward the NAS_authentication_request to the victim UE which performs the necessary checks, derives secret keys (e.g., K_AUSF), then computes RES and sends it in a NAS_authentication_response to AMF. The MitM attacker may intercept the NAS_authentication_response and change it to an AUTHENTICATION FAILURE to trick/force AMF into using NULL security algorithms. According to TS 33.501 Clause 10.2.2.2, if the serving network policy allows unauthenticated IMS Emergency Sessions, AMF may send the NAS SMC with NULL security algorithms to the UE, regardless of the algorithms supported by UE and announced previously (e.g., in its security capabilities), in the following cases:
AMF cannot identify the subscriber or cannot obtain the authentication vector (when SUPI is provided).
Unsuccessful verification of the UE.
AMF receives the Emergency Registration request and an AUTHENTICATION FAILURE message with error code as defined in 24.501 clauses 5.4.1.2.4.5 or 5.4.1.3.7.

The MitM attacker may leverage the last case to trigger NULL security algorithms to be selected by AMF. Following the choice of NULL ciphering/integrity algorithms, the NAS SMC messages, as described in TS 33.501 clause 6.7.2, may be sent unprotected to the victim UE, and indicate that NULL integrity and ciphering algorithms are selected. According to TS 33.501 clause 10.2.1.3, note 1 and note 2, AMF can assume that UE is prepared and will accept that NULL integrity and ciphering algorithms are selected in the SMC procedure. Hence, the MitM may trick the victim UE and AMF into proceeding with null ciphering and integrity algorithms, thus allowing the MitM to carry out a SUPI catching attack and/or an IP spoofing attack.

Another scenario where a similar MitM attack might work relates to 5G Prose, where a Remote UE might try to connect to the network through a UE-to-Network (U2N). In Emergency Service over U2N relay case, if the network policy allows for unauthenticated Emergency Services and the UE (e.g., USIM-less) cannot be successfully authenticated and authorized to use ProSe U2N relay service, the UP traffic may be transmitted via PC5 link without security protection or with limited integrity protection. For instance, a process building on procedures described in TS 33.503 is as follows: after UE-to-Network (U2N) relay discovery, the remote UE sends a DCR message to the U2N relay including an Emergency RSC and optionally PRUK ID, SUCI, or PEI. If the CN receives PRUK ID/SUCI in the message forwarded by the U2N relay, then the U2N relay may perform the UP or CP security procedure as in TS 33.503. If only PEI and emergency RSC are received, the U2N relay may skip this step if regulation/operator policy allows it. If the security procedure in the previous step is done, the U2N relay performs the Direct Security Mode Command as in TS 33.503. Otherwise, it sends the Direct Security Mode Command with Null ciphering and integrity protection. If the authentication fails and PEI was not sent by Remote UE in the DCR message, the U2N relay may send a Remote Identity Request to retrieve the PEI. As such, a MitM attacker posing as a (malicious) U2N relay may intercept a victim UE's messages, e.g., Direct Communication Request (DCR), and may change it to add, e.g., Emergency RSC and/or include (fake) identity, e.g., PEI; if an identifier is not included, a Remote Identity request may be sent to the victim Remote UE to retrieve it at a later stage. The U2N relay may be forced to skip UP or CP based security procedure (e.g., the MitM forces it to fail), and thus may perform Direct Security Mode Command procedure with Null ciphering and integrity protection. Upon receiving the Direct Security Mode Command message with Null security algorithms, the victim Remote UE may treat UP integrity protection as not activated for the connection and include the UP integrity protection policy as NOT NEEDED in the Direct Security Mode Complete; otherwise, the MitM attacker may intercept and change the Direct Security Mode Complete message to include the same indication (i.e., UP integrity not needed). Finally, U2N relay may send a Direct Communication Accept message to the victim Remote UE through the MitM-controlled U2N to finish the PC5 connection establishment procedures for the emergency services. At this stage, a SUPI catching attack may be carried out by the MiTM attacker.

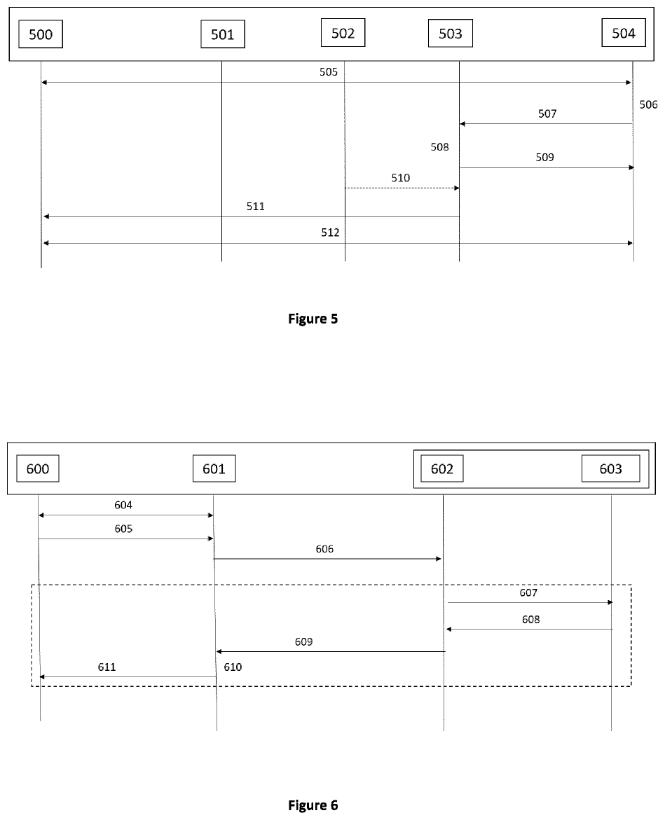

In another variant of the 5G ProSe MitM attack scenario, a process building on procedures described in TS 33.503 and TS 33.536 may be described as follows: after UE-to-Network (U2N) relay discovery, the remote UE sends a DCR message to the U2N relay which may include one or more of an Emergency RSC, PRUK ID, SUCI, or PEI, the Remote UE's security capabilities, and/or signaling security policy. The U2N relay may forward said parameters to the CN. If the CN receives PRUK ID or SUCI in the message forwarded by the U2N relay, then the U2N relay may perform the UP or CP security procedure as in TS 33.503. If only PEI and emergency RSC are received, the U2N relay may skip this step if regulation/operator policy allows it, and If UE's security capabilities and signaling security policy are also included in the DCR, U2N may perform Direct Authentication and Key Establishment procedures based on TS 33.536. In such case, a MitM attacker posing as a (malicious) U2N relay may intercept a victim UE's messages, e.g., Direct Communication Request (DCR); if the UE's signaling security policy is set to “NOT NEEDED” or “PREFERRED”, the MitM attacker may change the DCR message to add, e.g., Emergency RSC and optionally include (fake) identity, e.g., PEI, and set the signaling security policy to “NOT NEEDED” if it is not. If the U2N relay signaling security policy is set to “NOT NEEDED” or “PREFERRED”, it may be forced to choose NULL ciphering and integrity security algorithms as Chosen_algs in the Direct Security Mode Command message. The legitimate U2N sends the Direct Security Mode Command message back to the Remote UE including NULL security algorithms, Remote UE's security capabilities and signaling security policy. The MitM attacker may intercept the Direct Security Mode Command message and change the signaling security policy back to “PREFERRED”, if it has previously changed it to “NOT NEEDED” in the DCR message. This guarantees that when the victim Remote UE verifies the returned security capabilities and signaling security policy, as mandated in clause 5.3.3.1.4.3, step 4 in FIG. 5.3.3.1.4.3.-1, it does not expose the MitM attack. As such, upon receiving the Direct Security Mode Command message that the MitM attacker may have changed, the victim Remote UE may accept the NULL security algorithms and send a Direct Security Mode Complete message unprotected. Finally, U2N relay may send a Direct Communication Accept message to the victim Remote UE through the MitM controlled U2N to finish the PC5 connection establishment procedures for the emergency services.

Following the establishment of the PC5 connection between the victim Remote UE and the U2N relay with the MitM attacker in-between, this latter can carry out attacks (e.g., SUPI catching attack).

In an embodiment aimed at mitigating the attack variant taking advantage of the registration type field indicating the type (e.g., Emergency) in the Registration Request. The registration type may be used by AMF, upon receiving the Registration Request, (or forwarded by AMF to the home network) to be included in the NAS_authentication_request. Similar to the inclusion of UE_security_capabilities in above embodiments, the registration type may be securely sent back to UE for verification, thus exposing any potential changes a MitM might have performed on the registration type. When UE computes XMAC with the registration type it used in the Registration Request and verifies it against the MAC received in the NAS_authentication_request, verification will fail if the registration type has been changed (e.g., by a MiTM attacker) and thus UE will deem the authentication unsuccessful. Failure in the authentication procedure from the (victim) UE's side entails that although the network might send a NAS SMC message with NULL security algorithms, UE would not be expecting such NAS SMC message and thus might reject or ignore it.

An advantage of the solution proposed above might be the prevention of all attacks relying on triggering and exploiting the IMS Emergency Services scenarios through forging Emergency Requests. Furthermore, the solution may be combined with solutions proposed in other embodiments to guarantee that any changes to the registration type and/or the UE's security capabilities would lead to an authentication failure on the UE's side and thus halt the attack.

In a further embodiment, the UE may be configured to reject NAS SMC messages indicating NULL ciphering and integrity algorithms unless the UE has requested Emergency Services. UE may be configured e.g., through a policy which may be managed by the network (e.g., HPLMN) and provisioned to the UE e.g., if the network supports unauthenticated IMS Emergency Services.

In another embodiment, the network (e.g., HPLMN) may include as part of the NAS_authentication_request an indicator (e.g., 1-bit indicator) informing the UE of its supports of unauthenticated IMS Emergency Services. UE might rely on this indicator to reject NAS SMC messages indicating NULL ciphering and integrity algorithms in case it has not requested Emergency Services.

In another embodiment addressing the potential MitM attack in the 5G Prose Scenario, the remote UE may be configured (e.g., through a provisioned policy or indicator) to discard any (e.g., Direct Security Mode Command messages) with Null ciphering and integrity protection unless the Remote UE is indeed requesting Emergency Services. The policy or indicator may be provisioned to the Remote UE e.g., when it is in coverage, and being provisioned with discovery security material for open or restricted discovery, e.g., as per step 0b in TS 33.503, clause 6.3.3.2.1, FIG. 6.3.3.2.2-1. Alternatively, it can be provisioned with the policy or rule through the ProSe User Key Response as per step 1b in the same figure. In both cases, a NF such as the PCF, or the PKMF of Remote UE may manage and/or determine whether Remote UE may accept or deny NULL ciphering and integrity protection.

In another related embodiment, the policy configured/implemented in the remote UE may determine that a remote UE may not disclose its PEI if the U2N relay requests to retrieve it if the remote UE has not requested Emergency Services, in particular, if the request is not protected (and therefore, cannot be verified by the remote UE).

In another embodiment aimed at mitigating the MitM attack in the 5G ProSe scenario, U2N relay may include (or replay) Emergency RSC in the unprotected Direct Security Mode Command message in case the received Direct Communication Request indicates that the Remote UE is asking for Emergency Services (i.e., an Emergency RSC is included in DCR message). As such, the remote UE may be configured (e.g., through a security policy) to reject unprotected Direct Security Mode Command messages that do not contain Emergency RSC and also unprotected Direct Security Mode Command messages that do contain Emergency RSC while the Remote UE has not requested for Emergency Services.

In another scenario related to a MitM attack in the 5G ProSe scenario, U2N relay may be forced to send an unprotected Direct Security Mode Command. In this scenario, if a remote UE receives an unprotected Direct Security Mode command, according to Sol #27 in TR 33.740, the remote UE might accept said message. However, this should only happen if the Remote UE had requested emergency services, e.g., if the remote UE had sent an Emergency RSC in the initial DCR message. If the remote UE does not behave in this way, this would interfere, e.g., with the PC5 security establishment for 5G ProSe UE-to-Network relay communication over User Plane as defined in Clause 6.3.3.2.2 in TS 33.503.

Thus, in an embodiment addressing this scenario, a remote UE is configured with a policy (that might be hardcoded in source code or configured on the UE) that determines that a remote UE should only accept an unprotected Direct Security Mode command and/or accept the usage of NULL integrity algorithms if the remote UE had previously requested emergency services (e.g., by sending a DCR message including emergency RSC). Said policy might have been configured by a network operator by means of a network function (e.g., PCF) in the core network of a telecommunication system (e.g., 5GS).

Thus, in an embodiment addressing this scenario, a remote UE is configured with a policy (that might be hardcoded in source code or configured on the UE) that determines that a remote UE should only accept the usage of NULL integrity algorithms if the remote UE receives such configuration in a protected Direct Security Mode command and the verification is successful. Said policy might have been configured by a network operator by means of a network function (e.g., PCF) in the core network of a telecommunication system (e.g., 5GS).

Thus, it is proposed an apparatus and method for secure communication in a UE to Network relay scenario that may be implemented in a User Equipment whereby the apparatus:
Stores a hardcoded/preconfigured policy determining the apparatus behavior when a Direct Security Mode Command is received; and
rejects/accepts a received Direct Security Mode Command that is unprotected and/or includes NULL ciphering and integrity algorithms based on the policy and whether the apparatus had previously sent a DCR message including an emergency RSC.

In case of Emergency Services over U2N relay, if a UE is USIM-less or cannot be successfully authenticated and authorized to use ProSe U2N relay service (e.g., if a MitM interferes with the authentication process), the UP traffic may be transmitted without protection or with limited integrity protection (or requested to be transmitted without/with limited protection) e.g., a MAC-I may be generated with input parameters including, a 32-bit COUNT, 5-bit bearer identity, the 1-bit direction of the transmission, and a known 128-bit integrity KEY, e.g., set to all zeroes, to provide limited protection e.g., for data loss due to an unintentional unstable radio situation. As the MitM attacker might forge such MAC-I, the policy configured in the UE might also determine that the UE may not use such a configuration, and thus reject messages with limited protection if the UE has not requested Emergency Services.

### Embodiment 6

In solutions for emergency access over a UE to Network relay, e.g., Solution #27 in TR 33.740, the DCR message might include parameters such as the Permanent Equipment Identifier (PEI). Even for emergency access, it is beneficial if the PEI is also protected (encrypted/integrity protected). Protection might be done in a similar way as in Clause 6.3.5 in TS 33.503 where the PEI is protected next to the RSC or PRUK ID.

### Embodiment 7

In a potential attack, an attacker may be able to compromise the privacy of the Subscriber Concealed Identifier (SUCI) by correlating an IMSI (e.g., captured from a 4G attach request using a 4G IMSI-Catcher) and a SUCI (e.g., captured from a 5G Registration request or NAS authentication response). The attack might work under certain conditions, which are specified below, and it may be described as follows:
Step 1: Upon a UE's attempt to connect to a legitimate 4G network (e.g., through an Attach Request), an attacker may intercept the UE's IMSI (e.g., using a 4G IMSI-Catcher)
Step 2: The legitimate network may respond to the UE with an Authentication request, which includes a valid AUTN and RAND values, and is captured by the attacker.
Step 3: The attacker uses a fake 5G-SA network (e.g., using a fake gNB) to which the victim UE attempts to connect.
Step 4: Upon receiving the Registration Request from the victim UE, if the SUCI is not included, the attacker may send (e.g., through the fake gNB) a NAS Identity Request, to which the victim UE responds with a NAS Identity Response containing its concealed SUPI (i.e., SUCI).
Step 5: The attacker re-uses RAND and AUTN captured from the legitimate 4G Authentication Request captured in step 2 in a crafted 5G NAS authentication Request.
   Based on the UE's response to the authentication request, it may be possible to know whether the SUCI corresponds to the IMSI captured in Step 1 (e.g., based on SUCI-catcher attack).
   Such an attack may allow the attacker to identify, locate, and/or track a UE for which an IMSI is already know.
   The attack may work under the following assumptions and/or conditions:
The UE's IMSI is already known to the attacker
The attack must occur within a short time window i.e., capturing a legitimate 4G authentication request and replaying it as a 5G Authentication Request must occur such that the Sequence Number (SQN) in AUTN is fresh and is not rejected by the victim UE.
   It is the subject of the following embodiments to address the potential attack described above.

In an embodiment, the UE may include a freshness parameter/challenge (e.g., a nonce or time-based counter e.g., UTC value) to the Registration Request, which is included by the network in the NAS Authentication Request (e.g., similarly to UE_security_capabilities in other embodiments)

In an alternative embodiment, the 5G home network may add a parameter/indication (e.g., “5G”) to the parameters used to derive MAC where the parameter/indication is representative of the handshake that the UE intends to perform. For instance, instead of computing the MAC as
MAC=f_1(K, SQN∥RAND∥AMF)
   the home network may compute it as
MAC=f_1(K, SQN∥RAND∥AMF∥“5G”)

Other parameters or indication than “5G” could be used, to be representative of the handshake the UE intends to perform.

In another embodiment that might be combined with other embodiments, since the attack relies on the freshness of the intercepted (4G) authentication request and is time-critical (i.e., must guarantee the freshness check of SQN in USIM is successful), the UE may be configured with a stricter limit L (described in clause C.2.2 in TS 33.102) on the difference between SEQ_MS and a received sequence number component SQN, when the UE transitions from 4G to a 5G SA network.

### Embodiment 8

In some situations, non-3GPP-compliant devices may connect to the radio access network. These devices do not support all mandatory features defined in 3GPP, RAN. This is a problem because non-complaint devices may interact with complaint devices, affecting the overall performance of the RAN, e.g., if non-complaint devices do not fully adhere to timings of frequency ranges.

Following embodiments aim at addressing this problem:

In an embodiment, the device type is included in the UE capabilities and is verified as in other embodiments in this application.

In an embodiment, the device type is specified by means of a chipset ID or MUD file as per RFC 8520.

In an embodiment, the device type may be included in the UE capabilities. The UE capabilities may be reported to the AMF. As in other embodiments, the AMF may retrieve from the AUSF/UDM the UE capabilities (that may, e.g., include the device type). The UE may be allowed to join the (H/V) PLMN and/RAN if
the reported (by UE) and retrieved (from AUSF/UDM) UE capabilities (e.g., including device type) match, and/or the UE capabilities (device type) are 3GPP-complaint.

In another embodiment, the compliance status of a device may be verified and/or checked against a compliance ledger that is owned, operated, and maintained by 3GPP bodies and members. The ledger may include records of one or more of:
UE types containing e.g., device name, id, manufacturer id, chipset id, firmware version, firmware digest, certificate, status, UE (generic) capabilities, etc.
Manufacturers/vendors containing e.g., id, legal entity name, brand name, URL, certificate, etc
Trusted certificate authorities containing e.g., id, certification body name, root certificate, status, etc

The compliance ledger may be a blockchain, or a transparency tree as in RFC9162, or just a central trusted repository.

The compliance ledger may allow for permissioned write access, such that only manufacturers and/or vendors that are authorized can write into it. Hence, once a vendor releases a new device, an entry including all information about the device is written into the compliance ledger.

When a new device type is added, initially, the device status may be set to None. The status may be updated to compliant or non-compliant based on the reported results of conformance tests conducted by trusted, independent test labs, or operational networks. Future, continuous assessments/tests of the device compliance, either by trusted test labs and/or the network may lead to a compliance status update (e.g., from compliant to non-compliant) of the device. A compliance status update may include the conditions under which the device type is non-compliant for public verification.

Manufacturers/Vendors may be issued certificates by Trusted Certificate Authorities and may use them to issue certificates for UEs. The certificate chain of trust may be verified upon UE's access registration, e.g., during the initial registration procedure and/or the initial authentication procedure. For instance, the base station (or a NF in the V/HPLMN) may send a challenge, e.g., including a nonce, in e.g., RRC Connection Setup to UE. UE may sign the challenge, e.g., nonce, then include its id, manufacturer's id, nonce, and signature in the reply message, e.g., the RRC Setup Complete/Registration Request to be verified, e.g., by the base station and/or AMF. Using the UE and its manufacturer's id, their certificates may be retrieved from the compliance ledger and used to verify the UE's signature and the chain of trust, thus confirming the UE's provenance authenticity. The UE's compliance may be indicated by the compliance status associated with the UE's id in the compliance ledger.

In a related embodiment, the challenge may include requesting for additional parameters, e.g., the fingerprint of (a part) of the firmware. A trusted entity in the device (under test) may be in charge of computing such fingerprint and signature to make sure that the device is attested properly (e.g., the device is not relying on a third party to obtain the result).

In a related embodiment, the compliance check may be performed first, and in case the UE ('s/belongs to a device type whose)'s compliance status in the compliance ledger indicates that it is non-compliant, the network may decide to drop the connection. In case the UE (belongs to a device type that) is compliant, the network may further check the UE's signature and chain of trust to establish the UE's provenance authenticity.

In a related embodiment, the UE may not sign anything as response to the challenge from the gNB (in general, testing device). The reason is that the signature might lead to a potential privacy risk if the same private/public key pairs are used for a long period of time. Instead, the UE might just return, e.g., a function (e.g., cryptographic hash) of the challenge (e.g., a nonce) and the device features (e.g., firmware), e.g, HMAC(nonce, Hash (Firmware (pages_x_y))). In this regard, the testing device might have sent a challenge “(nonce, pages_x_y)” requesting the device to return the HMAC( ) of the hash of its Firmware in memory pages x_y using the received nonce as the HMAC key.

In a related embodiment, the signature may only be exchanged once a secure channel has been established, e.g., after primary authentication.

In a related embodiment, a UE may:
First, expose/communicate its device type so that the network can decide whether to enable/disable access based on the device type, e.g., based on local policy, informartion in a ledger, etc;
Second, establish a secure channel with the network;
Third, execute a device attestation phase with the network so that the network can verify that the UE is of the device type announced in the first step.

In a related embodiment, if a device (UE) is subject to verification/attestation, then the parameters assigned to the device for the verification/attestation (e.g., a public/private key pair)) may be rotated/changed/updated to avoid privacy concerns.

In a related embodiment, a device (UE) may only be verified/attested once the UE and gNB share a confidential channel to securely exchange parameters such as a challenge or the challenge response.

In a related embodiment, a device (e.g., UE) and an access device (e.g., gNB) may employ a key exchange protocol (e.g., Diffie-Hellman) to agree on a shared key, that is subsequently used as e.g., HMAC key, or to derive other keys (e.g., for encryption or MICs). For instance, an access device (e.g., gNB) may broadcast randomly generated challenges (e.g., nonces), in addition to its id, as part of SIB messages; a device (e.g., UE) may decode the content of the SIB message and use the access device's id to identify the public key associated with it, e.g., If the UE has locally-stored records from the ledger containing the information related to the access device (e.g., gNB), it can use the gNB's public key along and its private key to derive a shared symmetric key K. K may then be used to derive (e.g., by means of a key derivation function) other keys (e.g., HMAC key, MIC key, encryption key) that UE may use to protect and/or sign the challenge response. UE may also include its id in the response in order for gNB to identify UE's public key from the ledger and use it similarly (i.e., along with its private key to derive the shared symmetric key K) and derive the necessary keys (e.g., HMAC, and/or MIC, and/or encryption keys) to verify the UE's response validity, and subsequently its provenance, and compliance.

In a related embodiment, the network may start by checking the UE's signature and chain of trust first. In case one of the checks fail, the network may respond with an error message e.g., Faulty signature, and a new challenge (e.g., nonce) to be used in a subsequent UE's attempt. The network may define a limit on the number of attempts allowed e.g., three attempts, that UE can use to establish its provenance authenticity. If all attempts fail, the network may drop the connection and set a cool-down period to prevent the UE from retrying to establish a connection again. The network may not rely solely on the UE's reported information e.g., ID, and manufacturer's ID to prevent the UE from trying to establish a connection, as these IDs are public and can be used by any UE to e.g., lunch a DOS attack. In case the UE's signature and chain of trust are verified, the network may check the compliance status of the UE, and if compliant carries on primary authentication, if not, the connection may be dropped.

In a related embodiment, the attestation procedure may be part of an authentication procedure, e.g., the primary authentication procedure between UE and home network.

In a related embodiment, the UE's provenance authenticity and compliance check may be performed at an earlier stage (e.g., initial/random access procedure) provided that the messages exchanged between the UE and the base station support data bigger in size. In such scenario, the base station may broadcast nonces as part of SIB1. When the UE selects an SSB, extracts MIB and SIB1 data, it may sign the nonce and include its id, manufacturer's id, and signature in the random-access procedure message 1. gNB may fetch information related to the UE, its manufacturer, and then perform the necessary checks to establish its provenance authenticity and compliance, as described in above embodiments. Based on the outcome of these checks and connection attempts, gNB may send a failure message with a new nonce, drop the connection, or responds with an acknowledgment in the random-access response (i.e., random access procedure message 2). Once the RRC connection setup is complete, gNB indicates to AMF that provenance and compliance checks were performed successfully.

In a related embodiment that may be used independently, an access device may broadcast (in a SIB, e.g., SIB1) and/or communicate (e.g., in an RRC message or NAS) the fact that the network requires one or more of:
Determining the UE type/ID,
Performing UE attestation,
   To allow the UE to access the network and/or certain functionality in the network, e.g., a UE may only be allowed to use certain services (e.g., mobile base stations, or RIS, or smart repeaters, etc) if the UE is verified to be capable of properly handling them.

In a related embodiment, a UE may need to communicate device type/ID and/or undergo device attestation if required by the network.

In a related embodiment, the HPLMN performs above actions (e.g., requiring device type ID and/or performing device attestation), e.g., as part of primary authentication.

In a related embodiment, the HPLMN may communicate the results of above actions (e.g., requiring device type ID and/or performing device attestation) to the VPLMN.

In a related embodiment, the VPLMN performs above actions (e.g., requiring device type ID and/or performing device attestation), e.g., as part of primary authentication.

In general, or in particular embodiments where it is mentioned, a certificate chain of trust verification and/or verification may refer to and/or include, but is not limited to, the process of verifying the validity period of an entity's (e.g., base station) certificate (e.g., Certificate_A), and the signature of the authority (e.g., Operator) that issued and signed Certificate_A, then repeat the process (i.e., verify the validity period of the authority's (e.g., Operator) certificate (e.g., Certificate_B), and the signature of the higher authority (e.g., Trusted certificate authority) that issued and signed Certificate_B) recursively until a Trusted certificate authority is reached, thus establishing the authenticity and trustworthiness of the entity.

In another embodiment, verification may also refer to and/or include one or many of the following:
Compliance check: whereby the compliance status corresponding to the id of a device (e.g., UE) is checked against the records on the ledger.
   firmware version check: whereby a device (e.g., UE) may check on the ledger whether any updates to the firmware corresponding to the device model are available.

In accordance with the above embodiment, it is proposed a method by which an entity, e.g., an access device (e.g., base station) or NF, belonging to network (e.g., serving or home network) may check and verify one or more of the authenticity, provenance, and compliance of a User Equipment (UE), that may be attempting to access the network, based on the records of a ledger, wherein, the method may be implemented on a verifier (e.g., base station) and comprise verifying the security information (e.g., signatures, digests, certificates, chain of trust) and performing checks (e.g., compliance status check, firmware update check) on a user equipment (UE) based on data records stored in a ledger, whereby, the verification may be performed by the verifier (e.g., base station) itself, or with the assistance of a NF (e.g., AMF) in the network.

This method may rely on different processes to obtain the security and/or identifying information, e.g., a process may be as in other embodiments:
An access device (e.g., base station) transmitting randomly generated challenges (e.g., nonces and specific firmware pages) as part of the SIB messages
A User Equipment signing the challenge and/or computing a function (e.g., cryptographic hash) of the firmware pages with the nonce as key (e.g., HMAC(nonce, Hash(Firmware (pages)))), and adding parameters (e.g., id, chipset id, firmware version) required to perform necessary checks and verifications to a random-access procedure message (e.g., message 1) or to the registration request.

An access device (e.g., base station) or a NF (e.g., AMF) receiving the message containing the security and identifying information from the UE, and performing the checks and verifications as described in above embodiments. Embodiment 9:

If message 110 is exchanged in a protected (integrity protected) manner, then the attack is not feasible since a MitM located between UE 100 and base station 101 cannot modify the message. However, message 110 cannot be integrity protected since UE 100 and CN 104 do not share integrity key at this stage.

This can be solved by using a public-key owned by the core network 104, e.g., a public key owned by the home network and used to encrypt the SUPI, to encrypt a symmetric key K that is then transmitted in a secure manner to the core network 104, e.g., in message 110 and used to integrity protect message 110 or certain fields in message 110 such as the UE security capabilities, in particular, by attaching a message integrity code (MIC) computed as
MIC(K, message_fields_requiring_integrity_protection).

When the core network receives message 110, the core network first decrypts key K using the private key corresponding to the encryption public key and then checks whether the received MIC matches a MIC computed locally using the decrypted key and the received fields in the received message 110.

Note that the public-key is linked to the private-key owned by the home (serving) network, then home (serving) network might inform the serving (home) network about the failed verification.

Note that a MitM might still “replace” the encrypted key by a different key K′ of its wish, and then include a MIC computed with K′ and modified message fields if SUPI and K, e.g., are not encrypted together. To avoid this situation, the key K can be placed next to a field that requires verification or is used in a subsequent authentication procedure, e.g., the SUPI, and both the key K and such a field are to be encrypted and/or integrity protected together. Then, when the SUPI is decrypted/verified, also the key K is decrypted/verified. If an attacker interferes and tries to replace the combined encryption of SUPI and K, then the attacker will fail since the attacker does not know the SUPI. Ideally, this public-key encryption procedure provides strong guarantees against chosen ciphertext attack (CCA).

Note that it is also beneficial if the key is encrypted next to a parameter that prevents replay attacks such as, e.g., a nonce or a time-based counter (e.g., UTC value). Otherwise, it might be feasible for an attacker to replay a previous message in which, e.g., some message fields are used that are beneficial for the attacker, e.g., a weak choice of UE security_capabilities.

Note that this embodiment may require the exchange of the UE security_capabilities received by the AMF in the Initial UE Message NAS-PDU: Registration Request in the Nausf_UEAuthenticate_authenticate Request sent from the AMF to the AUSF and including the SUCI so that the AUSF can verify the integrity check if the UDM returns the integrity key to the AUSF.

Additionally or alternatively, it might require sending said UE security_capabilities from the AUSF to the UDM in the Nudm_UEAuthenticate_Get Request message so that the UDM can perform above integrity verification.

Additionally or alternatively, it might require sending said key K to the AMF that has received the UE security capabilities so that the AMF performs said integrity verification.

Note that this embodiment might require the UE to determine a key K and compute a MIC over the UE security_capabilities field exchanged between UE and AMF, e.g., in the Initial UE Message NAS-PDU: Registration Request. The AMF may need to cache this information till the key K is received from the AUSF at a later stage, e.g., in the Nausf_UEAuthenticate_authenticate Response, and the AMF can verify the received UE security_capabilities based on the received MIC and key.

A specific message flow of a variant of this embodiment is as follows:
1. The UE computes a random key K.
2. The UE uses K to compute a MIC based on its chosen UE security capabilities.
3. The UE sends the UE security capabilities and MIC in an initial message, e.g., the NAS Registration Request, to the AMF through the gNB.
4. The UE sends the encryption of the concatenation of SUPI and K (in the following SUCIK) in the NAS identity response to the AMF where the encryption is done as in TS 33.501, Annex C.3.
5. The AMF forwards the SUCIK to the AUSF in the Nausf_UEAuthenticate_authenticate Request.
6. The AUSF interacts with the UDM to retrieve the SUPI and K from the SUCIK.
7. The AUSF returns the SUPI and K to the AMF in the Nausf_UEAuthenticate_authenticate Response.
8. The AMF verifies the UE security capabilities based on the received K and MIC.

Note that some fields might be sent earlier or later, e.g., the MIC might also be sent to the AMF in Step 4. In this embodiment variant, if an attacker modifies the SUCIK, then the SUCIK's MAC-tag value verification will fail. If an attacker changes the SUCIK, then the MIC verification will fail. If an attacker modifies the UE security_capabilities, the MIC verification will fail.

Note that instead of having to generate a random key K, encrypt the generated random key K, and transmit the encrypted key K, the UE might also use other fields that are already transmitted encrypted as the cryptographic key used in MIC computation. Note that this is only a feasible approach if those fields are long enough and difficult to predict (e.g., randomized), otherwise it would be feasible to guess those from the transmitted MIC. Note that SUCI protects (encrypts) the MSIN of the SUPI. The MSIN is 10 digits long, and thus, it might be too short. Note that this approach might also be combined with above approach involving the generation/encryption/exchange of a key K with the advantage that the encrypted key K that needs to be transmitted might be somewhat shorter.

In general, the above embodiment provides an apparatus for securing the communication with a second device, wherein the apparatus is configured to perform the following steps
(a) using a first public-key linked bounded to a private-key owned by the second device to encrypt a randomly generated symmetric-key, and
(b) sending to the second device a message and the encrypted symmetric-key. In particular, the apparatus might be used to integrity protect the information exchanged in a first message with a second device and able to compute a message integrity code over certain information (that requires protection in the first message) and send said information and message integrity code to the second device. In particular, in the apparatus, the information can be the security capabilities. In particular, in the apparatus, the message might be the attach or registration request. In particular, a first device might comprise the apparatus. In particular, the apparatus might encrypt/integrity protect the symmetric key together with a secret identifier (e.g., SUPI) that once decrypted/integrity verified is used by the receiver to retrieve a root secret (e.g., K_AUSF) used to perform a subsequent authentication procedure. In particular, the apparatus might encrypt/integrity protect the symmetric key together with a parameter capable of preventing replay attacks. In particular, the apparatus might use an encryption algorithm that is secure against chosen ciphertext attacks.

### Embodiment 10

If message 110 is exchanged in a protected (confidentiality protected), then the attack is not feasible since the attacker might not know how to modify the information in message 110 in a meaningful manner. This can be achieved by using a public-key owned by the core network 104, e.g., a public key owned by the home network and used to encrypt the SUPI as described in TS 33.501 in Clause 6.12.2 and Appendix C, to encrypt the information (e.g., the UE security parameters) in message 110 that is to be transmitted in a secure manner to the core network 104. When the core network receives message 110, the core network uses the private key corresponding to the encryption public key to decrypt the encrypted fields the received message 110.

We note that this approach—compared with the approach in above embodiments, e.g., Embodiment 3—might be easier to circumvent by the attacker. The reason is that the encrypted messages might be malleable and thus an attacker might know how to flip certain bits (where the security capabilities of the UE are exchanged) based on the expected security capabilities of the UE.

### Embodiment 11

Above embodiments, e.g., Embodiments 9 and 10, describe the integrity/confidentiality protection of the parameters prone to modification (e.g., UE security capabilities) by means of a symmetric key encrypted with the public-key of the home network. An alternative is to generate a shared secret (e.g., Diffie-Hellman based as described in other embodiments (e.g, Embodiment 12) and use that key, or a key derived from it, to integrity/confidentiality protect those parameters, e.g., next to the SUPI. These encrypted and/or integrity protected are then sent by the UE to the core network for decryption and integrity verification allowing for the secure retrieval of those parameters.

A specific but exemplary message flow of this embodiment can then be as follows:
1. The UE concatenates SUPI and parameters (e.g., UE security capabilities) requiring protection into message M.
2. The UE protects message M, e.g., as in in TS 33.501, Annex C.3. This protected message is denoted PM.
3. The UE sends PM, e.g., in the NAS identity response to the AMF.
4. The AMF forwards the PM to the AUSF, e.g., in the Nausf_UEAuthenticate_authenticate Request.
5. The AUSF interacts with the UDM to retrieve the SUPI and parameters from the PM.
6. The AUSF returns the SUPI and parameters to the AMF, e.g., in the Nausf_UEAuthenticate_authenticate Response.
7. The AMF uses/verifies parameters (e.g., the UE security capabilities).

If an attacker modifies the PM, then the protected parameters and SUPI cannot be decrypted/integrity verified, and thus, the attack fails. An attacker cannot replace the PM to contain wrong parameters since the attacker does not know the SUPI of the UE. If an attacker tries to do it, the attacker will use a wrong SUPI and the primary authentication will fail.

In general, the above embodiment provides an apparatus for securing the communication with a second device, wherein the apparatus is configured to perform the following steps
(a) using a first public-key linked bounded to a private-key owned by the second device to derive a first symmetric-key,
(b) creating a message containing a UE identifier and other parameters requiring secure exchange and/or verification,
(c) computing a protected message by using the first symmetric-key or keys derived from it to encrypt and/or integrity protect the message,
(d) sending the protected message to the second device.

In particular, the apparatus might be used to integrity protect the parameters or information exchanged in a first message with a second device. In particular, in the apparatus, the information can be the security capabilities. In particular, in the apparatus, the first message might be the attach or registration request. In particular, a first device might comprise the apparatus. In particular, the apparatus might encrypt/integrity protect the parameters together with a secret identifier (e.g., SUPI) that once decrypted/integrity verified is used by the receiver to retrieve or derive a root secret (e.g., K_AUSF) used to perform a subsequent authentication procedure. In particular, the apparatus might encrypt/integrity protect the parameters together with a parameter capable of preventing replay attacks. In particular, the apparatus might use an encryption algorithm that is secure against chosen ciphertext attacks.

### Embodiment 12

The attack scenario described in FIG. 3, a Man in the Middle, e.g., composed by a fake base station and a fake UE, is located between UE and gNB. In an embodiment related to Embodiments 9 or 10, a UE might randomly generate a key K and encrypt it with the long-term public key of the home network. The home network might then decrypt it, and share it, or a key derived from it with the radio access network (RAN), e.g., a base station handling the access of the UE. This shared key between UE and gNB might be established earlier than KgNB, and thus, offer earlier protection between UE and gNB as shown in FIG. 6, e.g., protection against MitM.

Alternatively, the key K might also be based on a DH (Diffie-Hellman) key generated by an ephemeral key pair (prK_UE, puK_UE) generated by the UE and the long-term key pair of the home network (prK_HN, puK_HN). For instance, the key K might be (derived from) prK_UE*puK_HN=prK_HN*puK_UE.

In FIG. 6, the UE 600 sets up a connection with a base station 601 in Step 604. Then it sends an initial message 605 towards the core network that is forwarded in message 606 reaching an entity handling the registration and mobility of UEs, e.g., the 5G AMF 602. Messages 605 and 606 include the key K generated by the UE 600 and encrypted with the public key of the core network. In particular, a function 603 might store the private key used to decrypt said key K upon reception in message 607. The function 603 might send this key K, or another key K′ encrypted with K or another key K′ derived from K to the network function 602 in step 608 that would securely share it with the base station 601 in step 609. The base station can extract the key, e.g., K. UE and base station can then protect messages 611, e.g., as indicated in Embodiment 16.

Whether a base station 601 supports the usage of K might be broadcasted in the system information distributed by the base station.

Whether a UE might require the establishment of a key might be based on a policy deployed on the UE by the home network.

In general, the above embodiment provides an apparatus for securing the communication with a second device (e.g., a base station), wherein the apparatus is configured to perform the following steps:
(a) using a first public-key linked bounded to a private-key owned by a third device (e.g., a core network or a subentity of the Core Network) to encrypt a (randomly generated) symmetric-key, and
(b) sending to the third device a first message and the encrypted symmetric-key, and
(c) using the generated key or a second key derived from the key or a second key decrypted by means of the key to securely communicate with a second device. In particular, the apparatus might be used to integrity protect the information exchanged in a first message with a third device and able to compute a message integrity code over certain information (that requires protection in the first message) and send said information and message integrity code to the third device through the second device. In particular, in the apparatus, the information can be the security capabilities. In particular, in the apparatus, the message might be an attach or registration request. In particular, a first device (e.g., UE) might comprise the apparatus. In particular, the above embodiment provides a method for securing the communication between a first device (UE) and a second device (e.g., base station) in which the first device uses a first public-key linked bounded to a private-key owned by the third device (e.g., core network) to encrypt a randomly generated symmetric-key, and the first device sends to the third device a first message including the encrypted symmetric-key, and the third device sends a second key, wherein the second key might be the received key or a key derived from the received key or a key encrypted by means of the received key, to the second device, and the first and second device use the second key to securely communicate.

### Embodiment 13

In a different embodiment, the authentication and key agreement might be modified so that UE and gNB can derive the 5G's K_gNB as described in TS 33.501 in Clause 6.2.2.1 earlier than currently feasible in 5G.

In general and in reference to FIG. 1, the core network (103) might obtain a shared key SK derived from a master secret MS shared between UE (100) and the home core network already upon reception of the initial message 111. This MS might be stored in the USIM. This shared key SK might be derived as currently done, e.g., generating the whole key hierarchy (e.g., K_AUSF, K_SEAF, K_AMF, K_gNB) or it might be directly generated from the master secret MS using as input, e.g., nonces generated by UE (100) and CN (103) or a time value, e.g., UTC time or the name of the serving network, or some parameters associated to the gNB, or it might be derived from K_gNB as a temporary secret only used in the initial exchange of messages. The core network 103 can then securely send the derived key SK, e.g., an early generated K_gNB or a different key derived from MS, to the RAN (e.g., the gNB). The core network can further send in message 112/113 parameters that are required to derive this SK by the UE (100). If the SK depends, e.g., on the existing key hierarchy, the UE (100) might first be required to process the incoming message 113 and perform all authentication/freshness checks before the SK can be used. This might also apply if the SK is derived in a different way. If the SK is derived in a different way additional checks might also be applicable, e.g., whether a nonce sent by the UE in message 110 is used for the key derivation or whether a time parameter used for the key derivation and signaled by the core network (103) is fresh, e.g., matches the current time of the UE. It is to be noted that CN entities/functions, e.g., AUSF, SEAF or AMF, might not be aware of the fact that the UE has already generated all the keys while the CN entities have not received the corresponding keys yet since the current authentication procedure has not been useful.

### Embodiment 14

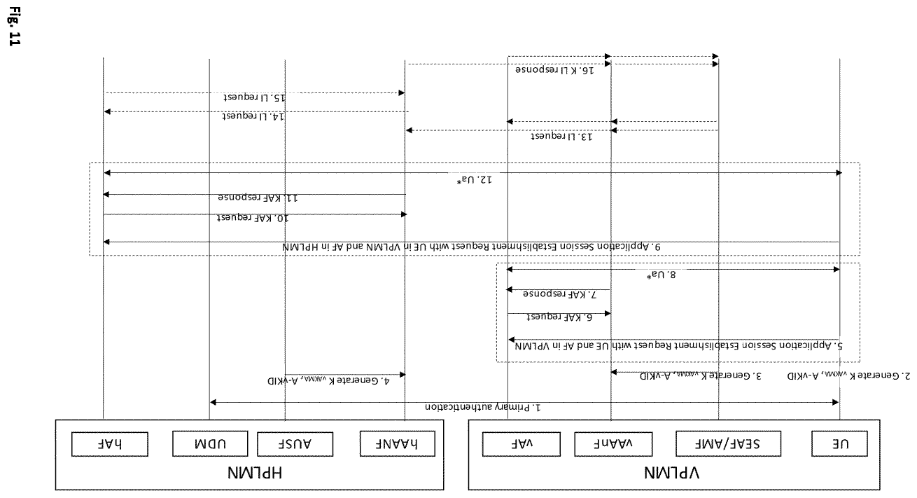

In a related embodiment related to the derivation of a key K based on Diffie-Hellman (DH), FIG. 10 illustrates the procedure to derive such a key. One or more of following steps may be involved:
Step-1: UE generates an Ephemeral public key pair.
Step-2: Based on Diffie-Hellman Key Exchange protocol, UE computes an Ephemeral shared key based on the HN's public key it has stored, and its ephemeral private key.
Step-3: UE derives an ephemeral symmetric key (Symkey) and an ephemeral MAC key from the ephemeral shared key which serve for the ciphering and integrity protection of SUPI. At this stage, UE can derive another key Kₛ=f(ESK, EPK), where ESK and EPK denote the ephemeral shared key and UE's ephemeral public key.
Step-4: Using Symkey UE encrypts MSIN, then it uses MAC key to compute a Message Authentication Code (MAC) to ensure SUCI's integrity.
Step-5: UE transmits SUCI, which contains its ephemeral public key, ciphertext and a MAC to the Serving Network (SN).
Step-6: SN sends the received SUCI along with the Serving Network Name (SNN) to the Home Network (HN). HN extracts UE's ephemeral public key from SUCI, and uses its private key to perform steps 2 and 3 to derive Symkey, MAC key and Kₛ=f(ESK, EPK).
Step-7: HN verifies SUCI's integrity through the MAC value, then de-conceals SUCI with Sym key to retrieve SUPI.
Step-8: Upon verifying whether UE is allowed on the network, HN generates a Home Environment authentication vector (HE AV), derives a Serving Environment Authentication Vector (SE AV) which it then sends along with Kₛ to SN.
Step-9: The NAS_authentication_request is sent to the UE. At this stage, Kₛ or a key derived from it, may be used to protect the authentication request message, e.g., at application, PDCP, RRC, MAC, or physical layers.

### Embodiment 15

According to TS 23.502, when UE is performing an Initial Registration, it shall indicate its identity in the Registration Request message to a PLMN. The identity of a UE corresponds to 5G-GUTI, if available, otherwise the UE shall include its SUCI in the Registration Request as defined in TS 33.501.

TS 33.501 6.12.4 specifies when the subscriber identification mechanism (identity request) may be invoked. Namely, when UE cannot be identified by the temporary identifier 5G-GUTI, i.e. when AMF is able to retrieve SUPI based on 5G-GUTI, the subscriber identification mechanism is skipped.

As the DH (Diffie-Hellman) generated key proposed in above embodiments, e.g., Embodiment 12, is based on the ephemeral key pair (prK_UE, puk_UE) and the long-term key pair of the home network (prK_HN, puk_HN), the ephemeral public key puk_UE needs to be sent to the home network to generate the DH-based key. If SUCI is included in the Registration Request message, puK_UE is retrieved by the home network and the DH-based key is derived. If, however, UE communicates 5G-GUTI in the Registration Request message, and AMF manages to retrieve SUPI corresponding to the 5G-GUTI received from UE, then SUPI is forwarded with the serving network name to the home network, and the ephemeral public key puk_UE required to derive the DH-based key is not communicated.

To guarantee that the ephemeral public key puk_UE is always transmitted to the home network, UE may generate an ephemeral public key pair after the RRC Connection Setup, and the Registration Request message might be modified to also include puk_UE in addition to 5G-GUTI. Alternatively, SUCI can be included such that, puk_UE is extracted and sent with SUPI and serving network name (SNN), if AMF retrieves SUPI using 5G-GUTI. Otherwise, AMF forwards SUCI and SNN to the home network, and puk_UE is extracted then by the subscriber identifier de-concealing function (SIDF) in the UDM.

In an additional or alternative embodiment that may be used independently, the authentication procedure (e.g., primary authentication) may consist of the following steps:
A first time during which the authentication procedure is executed, the UE uses an encrypted identifier (e.g., SUCI) and the UE may use a public key to protect any additional sensitive fields, e.g., security capabilities,
Upon successful completion of the authentication procedure, a UE is provisioned by the home network with a temporary identifier (a pseudonym) and a temporary secret, e.g., a symmetric key,
A following time, if the authentication procedure needs to be executed, the UE may use said pseudonym and said temporary secret wherein the pseudonym may be used, e.g., by the AMF (e.g., in the VPLMN) to identify the UE, and the temporary secret may be used to protect the sensitive fields.

In an embodiment variant, the UE may use said pseudonym and said temporary secret if, e.g.:
The UE can retrieve it from a security context,
The UE is (pre-)configured with a policy by the network.

The main difference in this embodiment consists in the assignment of a temporary secret. This secret can be used in subsequent authentication procedures without relying on/using the public key, thus, leading to improved performance. This secret may be used to, e.g.:
Securely send the location of the UE, e.g., to the HPLMN to determine whether the user gives user consent to share the location with the VPLMN,
Securely protect the security capabilities,
   . . .

In an embodiment variant, the temporary secret may be for securing the communication between UE and the HPLMN and/or between UE and the VPLMN, or both.

In an embodiment variant, the temporary secret/key may be used to derive multiple secrets/keys, e.g., by means of a key derivation function, e.g., for the HPLMN, or for the VPLMN; e.g., for encryption and for integrity protection.

In an embodiment variant, if a temporary secret is to be used for securing the communication between the UE and the VPLMN, the HPLMN shares the temporary secret with the VPLMN, e.g., together with the assigned GUTI.

In an embodiment variant, if a sensitive field needs protection from the UE to the HPLMN, then the secret is not shared with the VPLMN.

In an embodiment variant, if the pseudonym/temporary secret are used in a following time, e.g., when the authentication needs to be executed again, the VPLMN/HPLMN may reassign a new pseudonym/temporary secret. For instance,
If the UE sends some data to the HPLMN, the HPLMN may assign a new pseudonym/temporary secret and inform the VPLMN.
If the UE sends some data to the VPLMN, the VPLMN may provide the HPLMN confirmation of such data sharing, and the VPLMN may assign a new pseudonym/temporary secret, that might have been determined by the HPLMN.
If the HPLMN/VPLMN need to send some data to the UE, the HPLMN/VPLMN may assign a new pseudonym/temporary secret.

In an embodiment variant, the temporary secret is used with a given encryption algorithm (e.g. NEA) or integrity algorithm (e.g., NIA) that may be negotiated/indicated/configured when the temporary secret is configured and/or when the temporary secret is used.

In an embodiment variant, the message protected with the temporary secret includes metadata (e.g., input fields (e.g., a counter) in NEA or NIA algorithms) used to protect the message by means of the corresponding encryption/integrity algorithm.

In an embodiment variant, if a temporary secret is reused multiple times, in order to prevent UE/CN from having to keep state (e.g., value of a counter), the temporary secret is used as a root secret used to derive one or more keys, e.g., encryption key and/or integrity key, e.g., by means of a key derivation function and, other fields, e.g., a nonce or a UTC-based counter. The derived key is then used for the protection of the message and the fields used in the key derivation function are included in the exchanged message.

### Embodiment 16

A way of protecting the communication, e.g., at an earlier stage, is by applying the established key, e.g., as described in FIG. 6 related to Embodiment 12 or 13, at PDCP level. In particular, the established key can be used to derive control plane keys that protect the integrity and/or confidentiality of the messages exchanged between UE and base station, e.g., message 611 in FIG. 6.

An alternative manner is to use the established key K to protect the communication link at a lower layer, e.g., MAC or Physical layer. To this end, K can be used to derive one or multiple keys for lower layers, e.g., by applying a KDF. Additional input parameters to the key derivation function might include the layer, the communication direction (e.g., uplink), a time counter (e.g., UTC based or based on a communication counter such as the SFN), etc. For instance, for the MAC layer, specific MAC CEs in message 611 and later might be protected, this might involve multiple functionalities/variants.

First, it might require indicating which MAC Ces are protected by, e.g.,
(1) including a mask in the/each message, e.g., if a message includes four MAC CEs, then the mask might consist of 4 bits, where a bit set to 1 indicates that a MAC CE is protected, and/or
(2) exchanging a policy, e.g., from the UE to the base station or from the (home) core network to the (serving) base station indicating the protection requirements so that a mask does not need to be exchanged in each message, and/or
(3) preconfiguring a policy, e.g., in the USIM, that indicates which MAC CEs are (to be) protected.

Second, it might require agreeing on an algorithm for protection by, e.g.,
(1) defining a single algorithm in a standard specification where the algorithm refers to the encryption scheme and/or integrity protection scheme, and/or
(2) including the preferences in messages 605 and 606 where the preferences might be integrity protected, and the preferences might be indicated in messages 608 and 609.

Third, it might require storing a policy in the UE so that the UE, e.g., rejects an incoming message from the base station if it is not protected as expected or the message is processed in a specific way. The rejection or processing may also depend on the message type.

Fourth, it might require storing a policy in the base station that rejects an incoming message from the UE if it is not protected as expected.

Fifth, it might require generating a message integrity code over the protected MAC CEs. This can be done, e.g., by (1) using an integrity algorithm, e.g., a NIA, and appending a MIC to the message, or (2) using a key derivation function having as input the message fields that require protection and a counter (e.g., a counter identifying the message or the SFN) or a UTC time-based counter

Sixth, it might require generating an encryption stream that can be used to encrypt the chosen MAC CE fields can be done by using a KDF having as in put the derived key, a counter for freshness, and a counter to generate a keystream of arbitrary length. The output of the KDF is used to xor the chosen MAC CEs.

Seventh, it may require placing protected MAC CE fields next to each other to easy the processing of the message (e.g., encryption and decryption).

Eight, it may apply a lightweight authentication and encryption scheme as ASCON or ASCON based on the protection of MAC CEs.

Ninth, ASCON takes as input a key, a nonce, and an initialization vector. The initialization vector may depend on a counter, e.g., SFN. The nonce may depend on non-encrypted fields.

Tenth, ASCON returns a TAG. A subset of the bits of the TAG, e.g., least significant bits, may be used as MIC if integrity protection is required.

Eleventh, the generated key, e.g., during the authentication and key establishment phase in FIG. 1 (e.g., primary authentication in 5G), may be a long key, e.g., 256 bit long key. Such a longer key may be required to ensure long term security in the advent of quantum computers. However, the protection algorithm used for the MAC CE fields might only take as input a shorter key, e.g., a 128 bit key, because of performance reasons. Thus, the key hierarchy may be such that a short key is derived from a long key. This embodiment variant may also be applicable independently to other security procedures, e.g., at PDCP layer, in a cellular network.

Twelfth, if the long key derived or obtained in the initial authentication and key establishment phase and from that long key a shorter key is to be derived/obtained, e.g., by means of a key derivation function, then multiple (e.g., 2) short keys might be obtained with a single call to the key derivation function, e.g., if the key derivation function returns an output of the same length as the long key, and the long key has twice the length of the short key. These multiple short keys may be used:
(1) in subsequent usages (e.g., the 128 LSBs at time t0, the following 128 bits at time t1, . . . ), and/or
(2) for different usages (e.g., the 128 LSBs is used as the key to protect uplink communication and the 128 MSBs is used as the key for downlink communication), and/or
(3) for different purposes (e.g., the 128 LSBs is used as encryption key and the 128 MSBs is used as integrity key) and/or
(4) for different communication planes (e.g., the 128 LSBs is used in the control plane and the 128 MSBs is used in the user plane) and/or
(5) for different purposes in an encryption/integrity algorithm (e.g., ASCON) (e.g., the 128 LSBs is used as the key and the 128 MSBs is used as the NONCE).
   The advantage of above procedures is that less calls to the KDF are required, improving performance.
   This embodiment variant may be also applicable independently to other security procedures, e.g., at PDCP layer, in a cellular network.

This embodiment, e.g., protection of MAC CE fields, might be applicable using other keys. For instance, MAC CE fields might be protected using a key derived from 5G's KgNB.

Example applications requiring the protection of MAC CE fields might include, e.g.,
(1) the protection of control messages at L1 or L2 used to control a smart repeater, e.g., beam forming of a smart repeater,
(2) the protection of messages exchanged under the RRC layer (since those are not protected in 5G R17) and used, e.g., to release a UE connected to an IAB node or a mobile base station once the IAB node (or mobile base station) determine a radio link failure with the parent node,
(3) “SCell Activation/Deactivation MAC CEs” can be used to de-activate the communications over SCells, so a UE will not be able to receive data over the affected SCells,
(4) erroneous “TCI State Indication for UE-specific PDCCH MAC CE” and/or “TCI States Activation/Deactivation for UE-specific PDSCH MAC CE” can be used to ask the UE to adjust the Rx beam towards to a direction not favorable to receive the signal from gNB,
(5) fake “Aperiodic CSI Trigger State Subselection MAC CE” can be used to select codepoints not intended to be used by a base station creating misalignment between gNB and UE in terms of CSI feedback.

In general, the above embodiment provides an enhanced apparatus for securing the communication with a second device, wherein the apparatus is configured to use a key or the second key or a key established/derived from a root key associated to the access device (e.g., KgNB) to securely exchange at least a message with the second device. In particular, the message might be a Layer two (L2) message. In particular, the message might be a MAC CE (field). In particular, the apparatus might rely on a policy configured by the third device to determine which messages require which type of protection. In particular, the apparatus might include a mask in the exchange message indicating which fields are protected. In particular, a first device (e.g., a UE) might comprise these apparatus(es). The above embodiment also provides a method for securing the communication between a first and a second device, wherein the method uses the key or the second key or a key established/derived from KgNB to securely exchange at least a message between the first and the second device, wherein the message might be a MAC CE field and wherein the first and second device might have been configured with a policy by a third device that determines which messages require which protection.

Cellular networks rely on multiple types of encryption and integrity algorithms. For instance, NEA algorithms (Clause D.2 in TS 33.501), NIA algorithms (Clause D.3 in TS 33.501) or algorithms to conceal the subscription permanent identifier (Clause C in TS 33.501). These algorithms are configured to achieve a security of 128 bits. However, with the advent of quantum computers, it is foreseeable that new algorithms are introduced to provide 256 bit security (classical level). For instance, ETSI SAGE has developed new 256-bit algorithms security ever occur. For this reason, the SAGE group develops new 256-bit algorithms—including radio interface encryption and integrity algorithms (for both user plane and control plane traffic) as well as authentication and key agreement (AKA) algorithms—to provide long-term resistance to possible future quantum computing attacks in 5G systems. These same 256-bit algorithms could also be potentially retrofitted to previous-generation mobile systems if required. In TDoc S3-230642, ETSI SAGE informed SA3 that the specification of Snow 5G, AES-256 and ZUC-256 does not require further assessment from SAGE. Even if new algorithms are introduced, it is unlikely that existing algorithms are directly deprecated. More resource constrained devices might only support algorithms with a 128 bit key, either existing ones, or new ones such as ASCON, due to performance. Even high-end devices might prefer algorithms relying on a 128 bit key due to performance reasons, in particular, for high data rates.

Support for 256-bit security algorithms may require a change (e.g., adding paddings and/or changing the max length value of some parameters) in the lengths of input and/or output parameters to make use of such algorithms. Where needed, if keys of a variable length are supported (e.g., to maintain backward compatibility with legacy systems), KDFs could output variable length keys which may be split e.g., into two 128-bit keys, or truncated e.g., only the first or last 128 bits, or starting at a random index that may be determined e.g., by one communicating party and communicated to the other or be mutually agreed.

In an embodiment that may be used independently, a KDF maybe based on SHA-3 as in FIPS 202 or a SHA-3 derived function as in NIST SP 800-155. For instance, the KDF may rely on SHA-3 SHAKE(M,d) functionality that allows outputting a variable number of d bits given input M. For instance, the KDF used relies on SHA-3 cSHAKE(M,d, N, S) functionality that allows, given input M, outputting a variable number of d bits, with a personalization string S, and a function-name bit string N. For instance, the KDF used may rely on SHA3 KMAC(K, X, L, S) where K is the input key, X is an input string, L is the required number of bits, and S is a personalization string. For instance, the KDF may use an XOF functionality to derive further keys given an input. For instance, a SHA-3 KMACXOF256(K, X, L, S) may be used in which a 256 bit key K is used with a given personalization string S. This has the advantage that if multiple keys are required, then further keys can be obtained by calling again the same function. This has the advantage that keys of different lengths can be easily generated.

In an embodiment that may be used independently, a message integrity code (MIC) used in the telecommunication system, e.g., in a MIC used at PDCP layer or in MAC CEs protocol may be based on SHA-3 as in FIPS 202 or a SHA-3 derived function as in NIST SP 800-155. In particular, it may be based on SHA3 KMAC(K, X, L, S) where X may correspond to the message that requires the computation of a MIC, K to the key used to compute the MIC, S to the personalization string, and L to the preferred output length.

In an embodiment, the introduction of 256 ciphering algorithms may require the usage of a new generic key derivation function different than the one in Annex B.2 in TS 33.220 where the KDF may take as input a key (similar to TS 33.220), a string S (similar to TS 33.220), and the desired output length L, i.e., KDF(key, S, length). This may be implemented as LSB(HMAC-SHA-256(key,s), b) where LSB(a,b) returns the b least significant bits of a. This may be implemented as cSHAKE(key, length,””,S).

In a related embodiment, the KDF may also include as input parameter to indicate the usage, I.e.: KDF(key, S, Usage, length) and that may allow using the same key for different purposes. This may be implemented as cSHAKE(key, length, Usage, S).

In an embodiment, if different key lengths are supported, communicating parties (e.g., User Equipments, access devices, network functions, application functions, etc) may need to negotiate which key lengths are supported and/or to be used. These may be provisioned or configured e.g., through a policy that dictates which keys, input parameters length and/or output key lengths and/or KDFs are to be used for which purpose/function.

In an embodiment, the application or communication layer or device may indicate the required key length to the communicating party. For instance:
an AF when requesting the AAnF for a K_AF key, the AF may include the required key length for K_AF in the key request. This is required because different protocols, e.g., TLS, OSCORE, etc may rely on ciphersuites using 128 or 256 bit keys and the telecommunication system has to be able to return keys of different lengths, e.g, 128 bit or 256 bit keys.
When a UE establishes a secure communication link with the core network (NAS security), access device (AS security), the device and/or core network (home network and/or visiting network) and/or access device indicate the required/feasible security level, e.g., for AS security in PDCP layer or NAS security. For instance, when the PDCP layer requires user plane integrity or confidentiality protection, the PDCP layer may be configured with a given required security level (e.g., 128 or 256 bit) and choose security algorithms correspondingly.

In an embodiment that may be used independently, the network (e,g., AMF or access device) and/or UE may be configured to use a high security level (e.g., 256 bit security) but a network entity (e.g., AMF or access device) and/or UEs may not be capable of handling it, e.g., because the network is overloaded. In this case, the network entity (e.g., AMF or access device) and/or UEs may indicate/signal this exceptional status, e.g., in a SIB (e.g., SIB1) and/or in an RRC message and/or NAS message. This exceptional status may allow the network/UEs to use 128 bit security (ciphering) algorithms instead of 256 bit security (ciphering) algorithms.

In an embodiment variant, 256-bit security algorithms and keys may always be preferred unless the communicating parties are subject to conditions (e.g., backward compatibility) requiring down grading to 128-bit security algorithms and/or keys.

A UE may be configured with a given policy by the HPLMN or may have certain preferences regarding the usage of either 256 or 128 bit algorithms. However, when roaming, the UE might be located or have access through a VPLMN that may have different preferences or capabilities. Thus, it is required for the UE to determine which VPLMN to join, the VPLMN and HPLMN need to agree on the security requirements and/or the HPLMN may need to configure the UE with a temporary policy for as long as the UE is located in said VPLMN. To address these requirements:

In an embodiment variant, the network may indicate (e.g., in a SIB or RRC or NAS message or initial authentication procedure (e.g., primary authentication)) the preferred and or supported security algorithms, in particular, (e.g., 256 bit or 128 bit) so that a UE may use this information to select a network suitable for its communication needs. When a UE receives said indication, the UE may check whether the indication fits its current policy, and choose/reject said connection. For instance, if a UE observes three access devices (gNBs) where an access device supports 256 bit security only and the other device supports 128 bit security and the other device supports both 128 and 256 bit security, the UE may prefer (based on the policy) to select one of them, e.g., the last one. This policy may be configured by the HPLMN and may be stored in the UDM.

In an embodiment variant, the UE may indicate (e.g., in the RRC Establishment Request, or the registration request e.g., in security capabilities) the preferred and or supported security algorithms, in particular, (e.g., 256 bit or 128 bit) so that a UE may use this information to select a network suitable for its communication needs and/or the access device or network entity (e.g., AMF) may evaluate and determine whether it can serve the UE.

In an embodiment variant, the UE/HPLMN may indicate to the VPLMN the required/offered security level (e.g., 128 or 256 bit security) and/or the VPLMN may indicate to the HPLMN/UE that the VPLMN (e.g., a given access device) is (not) capable of providing a given security level. For instance, an access device may not support 128 bit ciphering algorithms (this security level is deprecated) while the UE requires the usage of 128 bit ciphering algorithms. Or the other way around. These indications may trigger the temporary reconfiguration of the UE or access device to provide service wherein said temporary reconfiguration may be logged.

In an embodiment variant, the supported security algorithms are indicated by a single bit index, e.g.: 0 indicates 128 bit algorithms supported and 1 indicates 256 bit algorithms are supported.

In an embodiment variant, the preferred security algorithms are indicated by a single bit index, e.g.: 0 indicates 128-bit algorithms supported and 1 indicates 256 bit algorithms are supported.

In an embodiment variant, the preferred security algorithms may be indicated by a 2-bit index, e.g.: 00 indicates support for 128-bit algorithms, 01 indicates supports for 256 bit algorithms, 10 indicates support for both 128-bit and 256-bit algorithms, while 11 is reserved for future use.

In an embodiment variant, the preferred algorithms are indicated by the ordering of the indicated supported algorithms. For instance, if the security algorithms are named as NEA0, NEA1, NEA2, NEA3 (as in TS 33.503) and NEA4, NEA5, NEA6 corresponding to, e.g., Snow 5G, AES-256 and ZUC-256, the UE may indicate to the network its preferences by communicating a list including the supported/preferred algorithms where the ordering indicates the preference, e.g., NEA5, NEA4, NEA6, NEA2, NEA1. This would indicate that the UE supports those five algorithms and the most preferred one is NEA5 (first one in the list) and the least preferred one is NEA1 (the last one in the list)

In Annex A.7 in TS 33.503, it is described how the message-specific confidentiality protection is provided for discovery between ProSe UEs. In this specific example, a 256-bit key is used to derive a key from which the 128 least significant bits are used as input to a 128-bit ciphering algorithm as in TS 33.501 (Annex D). If 256-bit ciphering algorithms are introduced, then this truncation (using the 128 least significant bits as key) may not be required. In some cases, it may happen that two entities decide to use a 256-bit algorithm but the KDF output used to feed the 256 bit algorithm is not well aligned, and the KDF output is still truncated to 128 bit keys. Thus, the security level would be lower than expected. To address these shortcomings:

In a further embodiment, whether a 256-bit key is truncated or not (in general, whether a subset of the bits is selected or not) is determined by the choice/usage of a 256-bit algorithm (not truncated) or a 128-bit algorithm (truncated). For instance, Annex A.7 in TS 33.503 should state that the input parameters to the ciphering algorithms are as described in Annex D in TS 33.501 [3] where KEY is KDF(DUCK, UTC-based counter, MIC, security level), e.g., LeastSignificantBits (KDF(DUCK, UTC-based counter, MIC), security level), and security level refers to the security level of the selected ciphering algorithm (128 or 256) and determines the returned key length. This embodiment can be combined with other embodiments and shows the benefits of having a new generalized key derivation function that takes as input the desired key length/output size.

In an additional or alternative embodiment, the key derivation function outputs keys of desired size, the key derivation function takes as input the desired key length, e.g., 128 or 256 bits, and uses it as input in the KDF itself.

In an additional or alternative related embodiment, the key derivation function may also indicate the desired security strength and the desired output size. This can allow having a single KDF definition that allows determining security strength (e.g., 128 or 256) and including the output size, KDF(key, security_level, output_key_size). This may be implemented, e.g, by using the underlying building block of SHA-3 (FIPS 202), namely Keccak, for instance: KDF(key, security_level, output_key_size)=KECCAK[2*security_level](key|suffix, output_key_size) where “|” indicates concatenation with a suffix (e.g., for domain separation).

The advantage (compared with the current KDF definition in TS 33.220) of introducing a new generic key derivation with a more transparent way of defining the output key length and/or security strength and/or purpose, etc is that it facilitates the usage of multiple ciphering algorithms of different key sizes and reduces the risk of misconfigurations.

In an additional or alternative embodiment, based on the outcome of the communicating 46parties (e.g., End Ues and UE-to-UE Relay) negotiation of which algorithms (e.g., 256-bit or 128-bit) are to be used, the level of security and/or function output size may be implicitly determined.

### Embodiment 17

Above embodiments can be adapted to facilitate improved security in Non-Terrestrial Networks (NTN). In particular, a use case of interest is related to an NTN UE deployed to a geographical border since different countries might demand different regulations. Since a UE connects to the NTN via a satellite link, it is difficult for the satellite to determine the specific location of the UE, and the UE might need to disclose its location, or a rough location. This location information can be used by the 5G system (5GS) to improve the operation, e.g., to allocate the right AMF to the UE. A specific approach to achieve this capability is to exchange the (rough) location of the UE in message 110 as in FIG. 1. However, this message is not protected, and thus, the disclosure of the UE location represents a privacy risk.

Above embodiments, e.g., embodiment 10, can be adapted so that an NTN UE encrypts its (rough) location when disclosed before NAS (or AS) security, e.g., in Message 110 as in FIG. 1, is established ensuring an optimized operation of the 5GS without the introduction of privacy risks. The protection of the (rough) UE location information can be done in a similar way as in Annex C in TS 33.501. The processing can be done as indicated in C 3.2.

In an embodiment in reference to, e.g., the 5g standalone access registration, a NTN gNB might not be able to select an AMF upon RRCSetupComplete since the gNB does not know where the UE is located and the UE has disclosed its (rough) location in a protected message, e.g., within the RRCSetupComplete. Thus, the NAS-PDU Registration Request may include a protected field including the UE location information. This is the field received from the UE including its protected (rough) UE location information. If this field is included in the NAS-PDU Registration Request, then the initial request might be routed to a (default) AMF that will request to a (default) AUSF that will require the UDM to decrypt the UE location information field that will be transferred to the (default) AMF. The (default) AMF will then trigger, e.g., a Namf_Communication_UEContext_Response towards a suitable AMF which is chosen based on the received UE location information. Additionally, the (default) AMF might inform the (NTN) gNB about the new AMF. Alternatively, the (default) AMF might share the received UE location information with the NTN gNB that will perform AMF selection as usual. The (default) AMF is an AMF towards which (all) NTN NAS-PDU Registration Request are routed when, e.g., the NAS-PDU Registration Request includes a protected field including the UE location information.

In an alternative embodiment and in reference to, e.g., the 5g standalone access registration, the NAS identity response will include a protected field including the UE location information. In this case, this response might be handled by a (default) AMF and a (default) AUSF where the (default) AUSF is an AUSF towards which (all) NTN NAS identity response are routed when, e.g., the NAS identity response includes a protected field including the UE location information. The (default) AUSF will then request the UDM to retrieve the encrypted UE location information (and potentially the SUPI). Given the decrypted UE location information, the (default) AUSF might forward the information to the (default) AMF that might select a suitable AMF and trigger a Namf_Communication_UEContext_Response towards the suitable AMF. Additionally, the (default) AMF might inform the (NTN) gNB about the new AMF.

In an additional embodiment that can be combined with the above embodiments or used independently, the network and the RAN may require (checking) the user consent for disclosing the UE location information. The user consent preference can have multiple conditions, e.g., if a specific RAN or AMF is allowed to obtain UE's location information or not, the specific area in which the consent can be/is granted, the time window during which the consent can be/is granted, etc. The exchange of the protected UE location information might serve as an implicit user consent preference verification, and upon its reception by the UDM, the UDM might check, e.g., in the UDR (Unified Data Register), the user consent preferences regarding NTN access. The UDM might then use this user consent preferences to adjust its response towards the rest of entities, e.g., AMF or RAN. In particular, the UDM might:
Disclose a UE location with a lower accuracy,
Deny the disclosure of the UE location if, e.g., AMF or RAN are not allowed,
Check whether the UE location can be disclosed at the current time.
   This approach allows the UE to disclose its rough location in a secure manner even if the UE is not aware whether the user allows disclosing this information. The received message by the UDM is then checked against the user consent policy to adjust the response.

Thus, in accordance with this embodiment, it is proposed a method which can be implemented in a User Equipment, the method being for requesting access to a network resource, comprising sending in a protected manner a user location with a coarse accuracy, for a data manager to check if a user of the User Equipment consented to disclose information. In another aspect of the invention, a data manager receiving in a protected manner a user location with a coarse accuracy, and checks whether the user agreed to disclose information. This check may include checking under which conditions this agreement is given. In another aspect of the invention, if the user consent is positive, the data manager provides a third entity, e.g., RAN or AMF, with the location of the User Equipment.

In a related embodiment which can be combined with previous embodiments, the sharing of user location information might be performed upon primary authentication establishment, e.g., NAS and/or AS security is established. This might also be done before primary authentication has been performed. The user location might be exchanged in a protected manner ensuring that it is end-to-end protected till the home network, e.g., using a key derived from K_AUSF. This ensures that a NF in the path that is not allowed to access the data according to the user consent preferences does not access it.

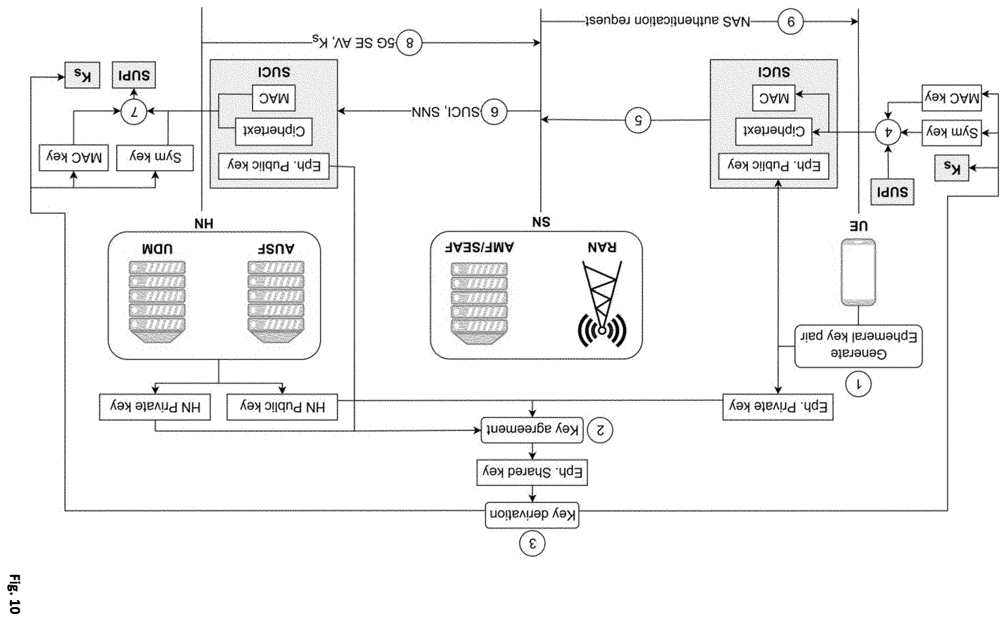

FIG. 9 describes such an embodiment in which entities 900 (UE), 901 (gNB/RAN), 902 (AMF), 903 (AUSF), 904 (UDM) interact to retrieve the user location in a privacy aware manner and compliant with the user consent preferences where not all steps might be required always. Step 905 represent primary authentication. This step may include the encrypted (rough) location information encrypted end-to-end between, e.g., 900 and 903 (or 904), e.g., protected with a key shared between those entities, e.g., the public key of the home network. Steps 906, and 907 represent NAS security establishment and AS security establishment. In Step 908, entity 901 may request the (rough/specific) location of the user. In Step 908, entity 900 may provide its (rough) location. Since user consent has not been verified, it may provide the (rough) location encrypted end-to-end between 900 and 903 (or 904), e.g., protected with a key shared between those entities, e.g., KAUSF. Entities 903 and/or 904 retrieve the (rough) location upon reception of message 909 (or 905). Entities 903 and 904 might interact in Steps 910 and 911 to check user consent for distributing said location information to nodes 901/902. In particular, in Step 910 a request can be sent to check for consent and entity 904 might check said consent (entity 904 is the point of enforcement) returning the result in Step 911. Alternatively, in Step 910 a request can be sent including the encrypted (rough) location to check for consent and entity 904 might decrypt and check said consent (entity 904 is the point of enforcement) returning the result in Step 911. Alternatively, in Step 910 a request can be sent to retrieve the user consent policy and entity 904 might return said policy so that entity 903 can evaluate it (entity 903 is the point of enforcement). If nodes 901/902 are authorized, the location information is shared in Step 912. Entity 903 may also configure nodes 901/902 with a policy determining when nodes 901/902 are allowed to request/retrieve/receive/process location information from node 900. This policy may include, e.g., the time window, during which requesting/retrieving/receiving/processing location information is allowed. In this embodiment, the location sharing might be done in Step 905 or in Step 909, or in both. It might also be that in Step 905 or Step 909 location sharing is done with a very low accuracy to facilitate RAN to make a first decision, e.g., on AMF choice while sending a higher accuracy location to the core network in a secure way.

In a related embodiment, the UDM might send a Nudm_SDM_Get response to the AMF containing the user consent preference on UE location information for NTN access so that the AMF stores the user consent preference in the UE context, or replaces its stored user consent preference with the one received from the UDM. Additionally, the AMF might send an N2 message (e.g. Initial Context Setup Request) to the NG-RAN, which includes user consent result or user consent preference for NTN access in addition to the Registration Accept. Additionally, after receiving the N2 message, the NG-RAN might store the user consent result or user consent preference in its UE context. Based on the received user consent result/preference, the NG-RAN might determine how to enforce the user consent with proper configuration on the UE. Additionally, the NG-RAN might send the RRCReconfiguration message (including Registration Accept and location configuration info) to the UE. If the user consent is granted for location reporting, the NG-RAN sends the configuration for the UE to report its location (e.g. via includeCommonLocationInfo in the reportConfig); if the user consent is not granted for location reporting, the NG-RAN does not send such configuration.

Additionally, a user might have not granted consent to disclose its UE location to certain NG-RAN or AMFs but the NG-RAN or AMFs might be able to modify above messages and in certain cases, a malicious NG-RAN or AMF (e.g., in the VPLMN) might enforce different user consent preferences in order to obtain the UE location. Thus, additionally, the (user consent) configuration sent to the UE to report its location (or other data such as Personally Identifiable Information) might also include an end-to-end integrity check. For instance, a MIC or a digital signature. In the case of a MIC, it might be a MIC computed with a key derived from a key shared between UE and the home network, e.g., a key derived upon the primary authentication, e.g., K_ausf or a key derived from a key in 5G.

In a related embodiment variant related to FIG. 12 entities 1200 (UE), 1201 (gNB/RAN), 1202 (AMF), 1203 (AUSF), 1204 (UDM/UDR) interact to retrieve the user location (or other Personally Identifiable Information) in a privacy aware manner and compliant with the user consent preferences. Not all steps below or exchanged data fields might be required always:
In Step 1205, the UE sends its (optionally) encrypted (coarse) location to the RAN. This message may include the GUTI and/or the SUCI.
In Step 1206, the RAN forwards this (optionally) encrypted (coarse) location including its GUTI and/or SUCI to the AMF.
In Step 1207, the AMF forwards this (optionally) encrypted (coarse) location to the AUSF.
In Step 1208, the AUSF forwards it to the UDM that can proceed to decrypt it (if encrypted) and retrieve a user consent policy related to the NTN services. The UDM may also retrieve the SUPI. The UDM can take a decision regarding user consent of sharing location information based on, e.g., at least one of the SUPI, the retrieved policy, the serving network, or the (optionally) decrypted location.
In Step 1209, the UDM returns to the AUSF the user consent decision and/or user consent preferences and/or the location (if decrypted) and/or a token verifiable by the UE on the user consent decision.
In Step 1210, the AUSF provides said user consent decision and/or user consent preferences and/or the location (if decrypted) and/or token to the AMF. Depending on the location, the AMF might (proactively) trigger a NG handover to change to an appropriate AMF and de-register the UE in contrast with Clause 16.14.6 in TS 38.300 in which, e.g., such NG handover, is triggered by the gNB/RAN (1201).
In Step 1211, the AMF provides said user consent decision and/or token to the gNB/RAN (1201).
In Step 1212, the gNB/RAN (1201) provides said token to the UE (1200) as well as a request to retrieve the user location. The UE can verify the user consent decision by means of the token, and if positive, the UE can execute the request and start providing its location, e.g., once AS security is established.

In a related embodiment variant of independent interest, the AMF actions in Step 1210 might be used independently or in combination with other solutions, e.g., Solution #1 in TR 33.886. For instance, if the AMF receives user consent preferences that indicate that a given AMF located in a given country is not preferred to be used, then the AMF is required to de-register the UE. Similarly, the AMF might trigger a NG handover towards an appropriate AMF.

In a related embodiment variant, the location and SUPI may need to be encrypted next to each other as in above Embodiment 9.

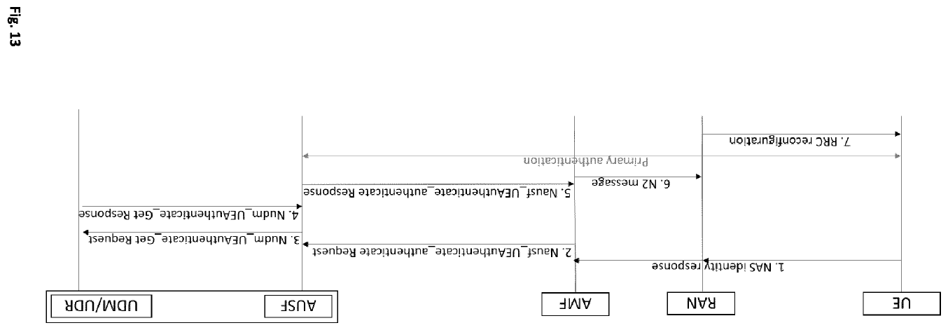

In a related embodiment variant shown in FIG. 13, messages 1205 and 1206 correspond to the NAS identity response and message 1207 is the Nausf_UEAuthenticate_authenticate Request and message 1208 is the Nudm_UEAuthenticate_Get Request. In this case, the authentication procedure only starts if the HPLMN UDM determines that the UE is authorized to communicate using said serving network and when the user consent preferences allow sharing the user location with that network for the given current UE location. It is to be noted that a UE might determine whether the NAS identity response should include only the SUCI or the encryption of SUPI and (coarse) location since the UE can know the type of RAN it is accessing, e.g., by observing the SIB1. In a first alternative, this user consent preferences and UE location reporting configuration might be exchanged and confirmed to the UE by means of the primary authentication message flow as in above embodiments, e.g., Embodiments 1 or 2. In the case of Embodiment 2, message 1209 is Nudm_UEAuthenticate_Get Response, message 1210 is the Nausf_UEAuthenticate_authenticate Response, message 1211 is an N2 message, and message 1212 is Authentication Request. Following the concept of Embodiment 1.2 and the general description of FIG. 12, the token exchanged between AUSF, and UE is the MAC in Embodiment 1.2 computed including the new UE location reporting configuration. Said configuration is also included in the Nausf_UEAuthenticate_authenticate Response message (from AUSF to AMF) and in the Authentication Request (from AMF to UE) so that the UE can apply it and verify it. In a second alternative, if the UDM/UDR performs this check, then it is feasible to distribute keys derived from K_ausf to the AMF and RAN (e.g., K_AMF or K_gNB) that allow protecting a RRC message, e.g., a RRCReconfiguration message (e.g., Message 1212), used to securely inform the UE about a new UE location reporting configuration. This is only done once the primary authentication has been successful when at the point of time of starting the primary authentication the UE location was already know to the entity evaluating the user consent preferences. It is to be noted that this is an advantage compared with alternatives such as Solution #1 in TR 33.896. In this solution, the AMF retrieves the UE consent policies, but this AMF might be in the serving network and since the SUPI is available in Step 5, then it means that the primary authentication has been performed and the AMF already has suitable keys to derive K_gNB and thus, to send a RRCReconfiguration message. However, in this solution this decision is taken without access to the UE location, while the UDM/UDR might benefit of knowing it. Furthermore, the right AMF can only be selected after AS establishment once the UE starts reporting the location.

In this related embodiment variant in FIG. 13, in Step 1 the UE sends a NAS identity response containing the encryption of SUPI and (coarse) location. In Step 2, the AMF sends Nausf_UEAuthenticate_authenticate Request to the AUSF to retrieve (i.e., decrypt) SUPI and location. In Step 3, the AUSF relies on the UDM/UDR to (i) retrieve (i.e., decrypt) the SUPI and UE location, (ii) access the NTN user consent preferences, and (iii) evaluate whether the user has given his consent to disclose its location to the RAN/serving network based on user consent policies, RAN/serving network, location. In Step 4, if consent is granted, the UDM/UDR sends to the AUSF the SUPI, location, and user consent preferences to the AUSF. In Step 5, the AUSF starts primary authentication and simultaneously provides said location and user consent preferences to the AMF. The AMF may trigger an AMF relocation procedure if required. In Step 6, the AMF sends a message to RAN providing the user consent preferences and location. And in Step 7, the RAN may request the UE to periodically provide its location once it has been configured with K_gNB and the RAN can securely send an RRCReconfiguration message. It is to be noted that this solution is also applicable in a mobility case, in contrast with, e.g., Solution 1 in TR 33.896.

### Embodiment 18

Above embodiments (e.g., Embodiment 17) are also applicable to related use cases in which user consent is required to use Personally Identifiable Information, e.g., used for Network Optimization.

For instance, in 3GPP Release-18, a study for the Artificial Intelligence (A1)/Machine Learning (ML) framework for NG-RAN was performed whose results were documented in TR 37.817. Three main use cases, namely A1/ML-based Network Energy Saving, Load Balancing and Mobility Optimization, are included whose goals is the optimization of the network. The three use cases require the collection of UE's location (e.g., at a cell level or coordinates granularity), so that user location tracking is a privacy issue that may require user consent, depending on local regulations.

Technical solutions in above embodiments, e.g., Embodiment 17, are applicable to enforce user consent for obtaining and using personally identifiable information used for network optimization.

For instance, in accordance with an embodiment, it is proposed an apparatus and method which can be implemented in a User Equipment, the apparatus being for checking with a data manager if a user of the User Equipment consented to disclose information, e.g., with some network entities, and the data manager providing a protected reply about the user consent preferences to the User Equipment (so that network entities cannot modify it).

In accordance with an option of this apparatus, the network entities may be in the VPLMN (e.g., RAN or AMF in the VPLMN) and the data manager may be in the HPLMN (e.g., UDM or AUSF).

In accordance with an option of this apparatus, the reply is protected with a MIC computed with a symmetric key, e.g., derived or based on K_AUSF.

In accordance with an option of this apparatus, the reply is protected with a digital signature.

### Embodiment 19

Above embodiments (e.g., 17 and 18) describe cases in which UE might need to disclose its location, or rough location (e.g., for AMF selection, or network optimization) and the privacy preserving measures taken to protect the disclosed information where user consent (UC) requests are handled solely by HPLMN.

In reference to 5G standalone access registration, VPLMN (e.g., AMF) might need access to the precise location of a UE (e.g., to forward UE towards a more suitable AMF). Thus, in an embodiment, a message such as the NAS-PDU Registration Request may include a protected field including UE location information, provided that UE is already configured (e.g., in UE local UC preferences) to disclose its location during the Registration Request. VPLMN (e.g., AMF) may request HPLMN (e.g., AUSF and UDM) to decrypt the UE location information field and transfer it to VPLMN.

Alternatively or additionally, in accordance with, e.g., embodiments 14 and 15, a secret key (e.g., K_UC) may be derived from UE and HN's shared ephemeral key to encrypt the UE location information field within the registration request. Upon receiving the Registration Request, VPLMN (e.g., AMF) may forward SUCI (if included in the registration request) or UE's ephemeral public key (if 5G-GUTI is included instead) for HPLMN to derive a user consent key, K_UC, and send it back to VPLMN (e.g., SEAF), which can then decrypt UE's information location field. A different user consent key might be derived for each user consent purpose. In both scenarios, the requests made to HPLMN either to decrypt the UE's location information field or derive K_UC may serve as a proof that VPLMN has obtained and recorded user consent.

In an alternative embodiment and in reference, e.g., to the 5G standalone access registration, UE might communicate only its user consent preferences in the Registration Request to VPLMN. UE's user consent (UC) preferences may be subject to similar protective measures as UE's security capabilities covered in previous embodiments. Furthermore, these preferences are provided to VPLMN (e.g., AMF) to cover the different conditions concerning requests made by other network entities (e.g., RAN/gNB, a network function (NF) in the VPLMN, or AF) to acquire UE's sensitive information (e.g., precise location). UE's UC preferences can have multiple conditions, e.g., if a specific RAN or AF or NF is allowed to obtain UE's information (e.g., location information) or not for a given purpose, the specific area in which consent can be/is granted, the time window during which the consent can be/is granted, the purpose for which the UC can/is to be granted, etc. After having communicated its preferences in a message, e.g., the Registration Request, UE might (depending on its preferences) include its UC related information (e.g., location information) in a protected field of the NAS identity response, which may be protected (e.g., encrypted), e.g., using the same secret key protecting SUPI. Alternatively, it may be protected (e.g., encrypted) using another key derived from the ephemeral shared key (e.g., K_UC). Similar to the previous embodiment, VPLMN (e.g., AMF) shall request HPLMN to verify/decrypt the UE user consent information (e.g., location information data) and send it back, or derive K_UC and send it to VPLMN (e.g., AMF) to verify/decrypt the user consent information (e.g., UE location information) field. In both scenarios, the requests made to HPLMN may serve as proof that VPLMN has obtained and recorded user consent and/or preferences.

In an additional embodiment that can be combined with the above embodiments or used independently, when UE provides its UC preferences at an earlier stage (e.g., Registration Request), VPLMN is required to verify said UE preferences and/or check against these UC preferences before disclosing and/or processing and/or requesting any sensitive information gathered from the UE, e.g., when interacting or communicating with RAN or other network entities (e.g., NFs or AFs). For instance, when UE's location information is requested by an AF, VPLMN (e.g., AMF) may:
Disclose a UE's location with a low/high accuracy.
Deny the disclosure or the UE's location if, e.g., AF is not allowed or the purpose for which the request was made does not match UE's UC preferences.
Check whether UE's location can be disclosed at current time.

As previously mentioned, such an approach allows the UE to disclose its (rough) location in a secure manner even if the UE is not aware whether the user allows disclosing this information. The request received by VPLMN (e.g., AMF) from other entities (e.g., RAN or AF) is checked against the UC policy to adjust the response. This approach has the advantage that user consent verification remains in the domain of the VPLMN.

In a related embodiment, before UE provides its UC preferences to any network entity, the user may be prompted before, during, or after the authentication procedure with a user consent page, where preferences are selected and saved locally on the UE and communicated to the network. The location (e.g., URL) of the user consent page or the page itself might be communicated to the UE by means of the system information or in the initial access procedure. The user might opt in for requesting the user consent page to adapt his user consent preferences compared with the default user consent preferences of the network. The user might select this by means of a configuration in the UE. The user might also opt for accepting the default user consent preferences of the network. The UE might communicate his UC preferences (consent or no consent) as a bitmask for each of the selected CE options. If the UE does not communicate his UC preferences, the network might consider that the default network UC preferences are accepted.

In a related embodiment that may be used independently or combined with other embodiments, the network (e.g., VPLMN) might provide the UE with a request to accept/adjust UC preferences signed with a private key associated to the network (e.g., a private key owned by the network) so that it can serve as proof of the UC choice towards a second network (e.g., HPLMN) or entity.

These UC preferences may be considered the default and/or selected preferences which are provided by UE in e.g., Registration Request or upon request. For information requests falling outside the scope of the UC policy or for UC requests made by HPLMN during identification/authentication, VPLMN (e.g., AMF) and/or HPLMN might send an UC Update Request to UE redirecting it to a consent page where the user may select one or more of the following options, and where the selected options might be protected as described in other embodiments:
provide UC and update the UC policy to address similar future requests.
provide UC only for this particular request, for the particular network entity making the request, and/or for a limited time.
Withhold UC and update the UC policy to address similar future requests.
Withhold UC only for this particular request.

This approach allows the UE to control and verify the conditions governing the UC policy e.g., which information is disclosed, to which network entities, and for how long.

In an additional embodiment that can be combined with the embodiments above, VPLMN (e.g., AMF) might be configured to periodically check for updates in UE's UC preferences (e.g., upon re-authentication); AMF might send an UC Update Request to UE in the NAS identity request, which UE responds to by including the (updated) UC policy in a protected field in the NAS identity response. Alternatively, UE might be configured to provide its (updated) UC preferences in e.g., the Registration Request. In such case, VPLMN (e.g., AMF) is to check if it has a UC policy recorded and associated with the UE, if it does, it updates it accordingly, otherwise, it records the UE's UC preferences. The UC preferences may be associated to a UE by means of its SUPI/GUTI/SUCI or other identities (e.g., RAN identities). The network (e.g., VPLMN, e.g., AMF) can send an acknowledgement that it has stored/updated the UE's UC preferences instead of a UC Update Request in e.g., the NAS identity request. If the network (e.g., VPLMN, e.g., AMF) has a mapping between 5G-GUTI and SUPI or if the Registration Request contains SUCI (i.e., NAS identity request is not sent), then VPLMN (e.g., AMF) may send its acknowledgment to UE with e.g., the NAS authentication request. In both scenarios (i.e., (updated) UC preferences provided by UE or upon network's request), the network records the UC preferences and/or other UC related information (e.g., location) if provided, and how they were acquired (i.e., by UE or upon request).

In a related embodiment, VPLMN (e.g., AMF) might be required to report to HPLMN (e.g., UDM) any UC policies or updates it receives from UE, or any requests made to obtain these UC preferences (updates) and/or user consent related information (e.g., location). If the UE sends it UC preferences (in e.g., the Registration Request), VPLMN (e.g., AMF) might forward these UC preferences to HPLMN (e.g., UDM) with SNN and SUPI/SUCI for e.g., decryption, which can record the UE's UC preferences and the VPLMN which received them. Similarly, if UE shares its UC preferences and/or UC information (e.g., location, regardless of the accuracy), e.g., protected in a NAS identity response field, VPLMN might forward UE's protected response to HPLMN, which can then decrypt/verify it and send it back to VPLMN (e.g., AMF) or send a key to VPLMN (e.g., SEAF) which can then decrypt/verify UE's UC preferences/information and provide it to the relevant entities (e.g., RAN, AMF, NF, AF, . . . ). Regardless of the means, and the nature of the information communicated (i.e., UC policy or location), VPLMN might be required to provide that information to HPLMN. Furthermore, HPLMN (e.g., UDM) can request from VPLMN (e.g., AMF) to provide it with the recorded UC policies and the respective UE identifiers they are linked to, for the purpose of verifying that VPLMN is applying UC as expected.

In accordance with this embodiment, it is proposed a method which can be implemented in a UE, the method being for requesting access to a network source, comprising sending in a protected manner user consent preferences and/or UE's user consent information (e.g., location), for a data manager to check whether the user of a UE consented to disclose its information e.g., to other network entities.

In another aspect of the invention and method, a data manager receiving in a protected manner UE's UC preferences, checks whether the user consented to disclose information. This check may include checking for the conditions under which consent is granted. In another aspect, if UC is granted, the data manager discloses to a third party (e.g., RAN or AF) UE's sensitive information (e.g., location).

In accordance with this method, a network entity in the VPLMN (e.g., AMF) may keep a record of the means (i.e., how), and the network entity (e.g., AF) which requested UE information (e.g, location).

In accordance with this method, the network entity in the VPLMN (e.g., AMF) recording user consent might provide HPLMN (e.g., UDM) with proof that it has recorded user consent. Providing such proof to HPLMN may be triggered by receiving the user consent response/decision which it then forwarded to HPLMN, or upon HPLMN request.

In accordance with this method, if HPLMN requires user consent (e.g., during identification/authentication) to disclose information (e.g., location and/or Personally Identifiable Information) or for UC request made to VPLMN which fall outside the scope of the UC policy it has in store, HPLMN/VPLMN might send a UC request to UE which redirects it to a consent page where the user of the UE selects its preferences to handle that request and potentially future similar requests.

In accordance with this method, UE might push updates to VPLMN (or the VPLMN might ask for changes) regarding any changes in its UC preferences. VPLMN might be required to provide HPLMN with proof that its UC policy have been updated. Accordingly, HPLMN should be able to verify that VPLMN is applying user consent as expected (e.g., by requesting VPLMN to provide its user consent records i.e., UE identifiers and the UC policies related to them).

### Embodiment 20

In above embodiments, the UE 100 might include a field in message 110 indicating which fields are encrypted or integrity protected or how the subsequent authentication procedure is to be performed, e.g., which checks should be computed.

This field might be a preconfigured value, e.g., determined in a standard or based on a UE version (e.g., a specific release in the telecommunications standard), or it might be based on a security policy configured in the UE.

If the field refers to the integrity/confidentiality protection of certain fields, the field might refer to a mask indicating which fields are integrity or confidentiality protected.

Whether a message is integrity protected might be implicitly determined when a MIC is present in, e.g., message 110.

### Embodiment 21

3GPP Release 18 includes a new study item on home network triggered primary authentication in which the home network might trigger the authentication procedure. A reason for triggering this authentication might be to check whether the UE has established a security link with the proper security levels (e.g., without being affected by a MitM).

In this case, in an embodiment, the home network might send a message 113 based on the current known information (e.g., identity or security capabilities) of the UE it wants to authenticate/verify. This can require deriving, e.g., new challenges xRES* and HXRES* as indicated above.

In a further embodiment, this message might include a field indicating that it is a home network triggered authentication request so that the UE knows it has to include some information, e.g., its desired security capabilities and/or current security capabilities, when computing the response RES* or a parameter used to compute such a response.

Upon reception of this message, the UE might reply with a message 114 including RES* computed as described in other embodiments, e.g., Embodiment 1.

In a further embodiment, if the home network is not aware of all UE parameters and/or wishes to verify certain UE parameters, the home network might include an indication in message 113 about the parameters that need to be transmitted again, e.g., security capabilities.

Message 113 might include a MIC computed with a key shared between UE and home network and a timer, e.g., a UTC based counter with the goal of allowing the UE to verify that the re-authentication request comes from its home network and it is a fresh request. The message might include the least significant bits of the UTC time so that the UE can obtain the exact UTC based counter used in the computation of the MIC.

Alternatively, a new message might be defined that is sent from the home network towards the UE including some of the elements above and requesting the UE to start again the authentication procedure starting with the exchange of message 110.

In a further embodiment, if the home network might want/need to verify the compliancy of a device/UE, the home network may trigger the primary authentication wherein the device is requested to return at least one of:
Device type, e.g., chipset ID.
Software version,
3GPP capabilities,
Fingerprint (e.g., hash/MAC/HMAC) of part of the firmware,
   Wherein some of the above actions may be done by a trusted module (e.g., USIM) in the device.
   For instance, the above information may be returned by the USIM next to a MIC computed with a shared secret shared between UE and home network wherein the shared secret is stored in the USIM so that the device/UE cannot modify it.
   For instance, if the home network requires a fingerprint of part of the firmware of the device, the USIM might receive said request from the home network, and request the device the fingerprint of its firmware. The USIM may return said fingerprint or an enhanced fingerprint computed as a function of the previous fingerprint and some additional metadata, e.g., the HMAC of the previous fingerprint and some metadata. Said metadata may include the timing required to obtain the fingerprint.

### Embodiment 22

When the home network triggers the reauthentication procedure, e.g., to verify the security parameters or, e.g., to generate security keys K_AUSF or K_SEAF in the case of mobility from 4G to 5G, the reauthentication procedure might fail even if the UE has (already) an active connection. If this happens, the updated unauthenticated status of the UE needs to be handled.

This can involve one or more of the following embodiment variants:
Rerunning the authentication procedure, e.g., a maximum number of times or e.g., with a different authentication method, e.g., 5G AKA when EAP-AKA′ previously failed or the other way around.
Linking authentication confirmation to Nudm_UECM_Registration procedure from AMF like in TS 33.501 Clause 6.1.4.1a. In particular, the AUSF might request the storage in the UDM a failed (or successful) authentication status upon home triggered authentication. The fact that it is home triggered authentication might be recorded. It might also be recorded the reason for triggering the home triggered authentication, e.g., K_AKMA renewal or 4G to 5G mobility, etc. In the event of a failed authentication when the UE is connected, the UDM shall trigger the removal of any authorizations to the AMF/SEAF (similar to Step 4 in Clause 6.1.4.1a in TS 33.501. In this event, the UDM might also remove any authorizations to the AAnF, and thus, AFs communicating with the UE via AKMA.

### Embodiment 23

When the home network triggers the reauthentication procedure, in some cases (e.g., in the case of mobility from 4G to 5G) the home network might not be aware of the 5G identity that might be required to retrieve security parameters from the UDM to trigger the authentication procedure.

Thus, in a further embodiment related to, e.g., Embodiment 1, a new message might be defined that is sent from the home network towards the UE requesting the UE to start again the authentication procedure starting with the exchange of message 110. This includes requesting again the exchange of the UE security capabilities, 5G identifier (e.g., 5G SUCI), or other fields in other embodiments such as:
User consent preferences,
(rough) location,
Parameters required for device compliancy,
. . .

In an embodiment variant, the home network (or UE) may determine the primary authentication fails if one or more of the fields do not fit a given policy that may have been configured on the device and/or home network. This may trigger the release of the UE/network.

Alternatively, the decision of requesting a new authentication procedure might be taken at the AMF. This decision might also be based on a policy. For instance, when an AMF becomes in charge of a UE moving from the 5G network, then a policy might determine whether the AMF has to trigger the reauthentication procedure assisting the home network of the UE. In this case, the AMF might create a request for the UE to re-do the authentication procedure starting with the exchange of message 110. This request sent by the AMF might be a NAS secure message such as the UE Configuration Update or De-registration procedure.

### Embodiment 24

Currently the AKMA key cannot be updated without rerunning the authentication and key agreement phase 106. The AKMA key might need to be updated without doing this.

Thus, in an embodiment, this can be done by generating at the AuSF a new AKMA key that depends on, e.g., the VPLMN identity and/or a counter and/or a nonce and/or the (UTC) time. This can be done by extending the definition of the AKMA key derivation function in A.2 in TS 33.535 by including in the input string S to the KDF also some of these parameters (and associated length). For instance:
FC=0xXX;
P0=“AKMA”;
L0=length of “AKMA”; (i.e. 0x00 0x04)
P1=UE ID;
L1=length of UE ID.
P2=VPLMN
L2=length of VPLMN
P3=UTC time
L3=length of UTC time

In an embodiment variant, the new added parameters in above example are the VPLMN and UTC time. VPLMN might be a different identifier identifying a serving network. The UTC time might also be a nonce or a counter to ensure that different AKMA keys are generated. As in TS 33.535, the input key KEY might be the master key derived from the primary authentication, i.e., KAUSF in 5G, and UE ID refers to a unique UE identifier such as the SUPI in 5G.

Note that in a further embodiment, upon Kakma update, Kaf might also need to be updated as currently done in TS 33.535 or using an embodiment in this invention.

This embodiment is illustrated in FIG. 4 where UE 400 performs primary authentication and derives Kakma and Kaf in Step 405 being AMF/SEAF 401, AuSF 402, AaNF 403 and AF 404 involved. In Step 406, the Kaf expires, and AF 404 might send a request 407 to the (serving) AaNF 403 that forwards it in step 408 to the (home) AuSF that might proceed to generate a new Kakma for the AaNF in Step 409 and might send it in Step 410 to the AuSF. The AaNF might then derive a new Kaf in step 411 that is shared with the Kaf in step 412. The AaNF might inform the (home) network and UE in Step 413 and in step 414 UE and AF can interact again in a secure way. In particular, in Step 413, the serving network (AaNF) might inform first the home network of the key AF update, the home network subsequently procees to inform the UE of the key AKMA and AF key update. Upon successful verification/reception of message 413, the UE updates Kakma and Kaf. Message 413 migth include the required parameters for the UE to update these keys. Message 413 might be a NAS secure message or a message sent by the AuSF.

### Embodiment 25

Currently the AF key cannot be updated without rerunning the authentication and key agreement phase 106. The AF key might need to be updated. This can be done by generating at the AaNF a new AF key that depends on, e.g., the AF identity and/or a counter and/or a nonce and/or the (UTC) time based on the current AKMA key. This can be done by extending the definition of the AKMA key derivation function in A.2 in TS 33.535 by including in the input string S to the KDF also these parameters (and associated length). For instance:
FC=0xXX;
P0=AF_ID;
L0=length of AF_ID
P1=UE ID;
L1=length of UE ID.
P2=VPLMN
L2=length of VPLMN
P3=UTC time
L3=length of UTC time

As in TS 33.535, the input key might be a key used for deriving the AF keys such as Kakma and AF_ID might refer to an AF identifier that might include—as in TS 33.535—the AF, the security protocol used over the Ua* interface. Additionally, it might include VPLMN the AF uses to access the device and/or a unique counter/nonce/UTC time.

This embodiment is illustrated in FIG. 5 where UE 500 performs primary authentication and derives Kakma and Kaf in Step 505 being AMF/SEAF 501, AuSF 502, AaNF 503 and AF 504 involved. In Step 506, the Kaf expires, and AF 504 might send a request 507 to the (serving) AaNF 503 that might proceed to generate a new Kaf in Step 508 and sends it in Step 509 to the AF. The AuSF might (regularly) update the Kakma in Step 510, e.g., based on a counter used in the KDF, and regularly share it with the AaNF. A given Kakma might thus be limited in time, and this time limitation might apply/propagate to Kaf derived from it. This has the advantage that the home network remains in control. When Kaf is updated, the AaNF might inform the (home) network and UE in Step 511 and in step 512 UE and AF can interact again in a secure way. In particular, in Step 511, the serving network (AaNF) might inform first the home network of the key AF update, the home network subsequently procees to inform the UE of the key AF update. Upon successful verification/reception of message 511, the UE updates Kaf. Message 511 migth include the required parameters for the UE to update Kaf. Message 511 might be a NAS secure message or a message sent by the AuSF.

### Embodiment 26

In a related embodiment that can be combined with other embodiments or used independently, the UE is served by a serving PLMN (SPLMN) and the UE is trying to access an AF in the home PLMN (HPLMN). In this case, the SPLMN might host a SAAnF that might receive a K_AKMA derived from K_AUSF at the AUSF.

In an embodiment variant, in some scenarios (e.g., when it might be required to intercept the communication for Lawful Interception purposes), the HPLMN (e.g., the HAAnF) might be required to send K_AF to the SPLMN upon generation.

In a further embodiment variant, the SPLMN might signal this L1 requirement to the HPLMN.

In a further embodiment variant, the SPLMN (e.g., AMF) might use then the received K_AF to access the exchanged traffic between UE and AF.

In accordance with above embodiment, it is proposed a method by which VPLMN/SPLMN gains access to the exchanged traffic between a user equipment (served by SPLMN/VPLMN) trying to access an AF in the HPLMN, wherein the method comprises VPLMN optionally signaling Lawful Interception requirements to HPLMN, and this HPLMN providing key material (e.g., K_AF and other parameters) to VPLMN, and then VPLMN (e.g., SEAF) using the provided key material to decrypt the intercepted traffic exchanged between UE and AF.

In accordance with above embodiment, it is proposed a method by which the HPLMN provides key material to a network function in the VPLMN in charge of collecting the AKMA keying material for lawful interception purposes.

### Embodiment 27

In a related embodiment that can be combined with other embodiments or used indeppendently, the UE is served by a VPLMN and the UE is trying to access an AF in the VPLMN and the (H/V) PLMN has L1 requirements on the UE communication.

In this case, the VPLMN might be required to intercept the communication for Lawful Interception purposes. This is feasible since the VPLMN knows all root keys used for the communication between UE and AF.

In an option, upon interception, the VPLMN might be requested to forward the decrypted traffic to the HPLMN.

In another option, the VPLMN is requested to reroute the intercepted encrypted traffic towards the HPLMN as well as deliver to the HPLMN the K_AKMA or K_AF used to protect the traffic or parameters (e.g., counter) used to derive them.

In accordance with above embodiments, it is proposed a method by which HPLMN is given access to the traffic exchanged between a UE served by VPLMN and trying to access an AF in the VPLMN, wherein the method comprises HPLMN signaling L1 requirements to VPLMN, then VPLMN forwards the traffic decrypted to HPLMN, or alternatively, VPLMN forwards the key materials (e.g., K_AKMA, K_AF and other parameters) in addition to the encrypted traffic to HPLMN.

In accordance with the above methods, it is proposed another method which may be combined with the other methods and by which, key materials (e.g., K_AKMA, K_AF) may be provided based on a pull/push mechanism and the PLMN's L1 requirements.

### Embodiment 28

In some scenarios, the home network (e.g., UDM) may be able to trigger a primary authentication procedure at any time based on a local (operator) policy or a request from a NF (e.g., AUSF, AAnF), and it can be described by means of the following steps. Note that some steps may be executed in a different order, some steps may be optional, and some steps may be executed multiple times:
Step 1: The UDM may be pre-configured with a local policy determining when to trigger a primary authentication procedure; or
Step 2: A NF (e.g., AAnF) may send a request (e.g., Nudm_HNAuthentication_Authenticate_request) to the UDM, that may include at least one of SUPI, GPSI, and/or another UE identifier, to trigger a primary authentication procedure for the target UE e.g., to refresh K_AKMA, or rekeying of other procedures such as UPU, SoR.
Step 3: Based on the received request and/or its local policy, if UDM can trigger the primary authentication, UDM identifies the serving AMF/SEAF of the target UE, otherwise, the UDM sends a Nudm_HNAuthentication_Authenticate_Response message with a failure cause.
Step 4: If the target UE's serving AMF/SEAF are identified, UDM sends a request (e.g., Namf_HNAuthentication_Authenticate Request) message containing UE's identfier (e.g., SUPI) to the AMF/SEAF
Step 5: Based on UDM's request, if the serving AMF/SEAF can start a primary authentication, it sends a response (e.g., Namf_HN_Authentication_Authenticate_Response) message to the UDM with a succesfull indication, otherwise, the Namf_HNAuthentication_Authenticate_Response contains a failure cause
Step 6: If the serving AMF/SEAF sends a succesfull indication to UDM, it may start a primary authentication procedure with the target UE.
Step 7: Based on the outcome of the primary authentication, UDM may send a response (e.g., Nudm_HNAuthentication_Authenticate_Response) message containing a Result indication to the NF which requested a Home Network Triggered Primary Authentication (HONTRA). If the primary authentication was succesful, the Result indicates that UE has been authenticated succesfully, otherwise, the result indicates a failure cause e.g., UDM or AMF/SEAF cannot trigger HONTRA or UE failed the authentication.

Embodiments in this application, e.g., as follows, may apply to above scenario, e.g., to ensure Lawful Interception.

In a further embodiment, when the home network triggers the re-authentication procedure (e.g., to refresh AKMA keys or due to UE mobility, e.g., into an area served by (another) VPLMN), if the VPLMN signals/has signaled L1 requirements, HPLMN (e.g., AUSF) may derive and share parameters (e.g., cryptographic keys, e.g., the AKMA keys described in other emboodiments as well as other keys, e.g., dependent on the new K_AUSF) available in the HPLMN with the VPLMN (e.g., AMF/SEAF/UPF or a LI NF) in advance.

In a further embodiment, sharing of those keys may be done with a NF or functional block in charge of lawful interception where this NF or functional bock may be in the VPLMN or in the HPLMN.

In a further embodiment, sharing might be done, e.g., through the NAS_authentication_request before the authentication procedure is concluded.

In a further embodiment, the decision of early sharing of said keys may be determined by, e.g., a policy configured by the network operator.

In a further embodiment, early sharing of keys might require a message sent from the HPLMN to the VPLMN indicating that a home-triggered re-authentication procedure is being executed and that the previously shared keys are still valid. This message may also be between the NF triggering the primary authentication (e.g., UDM) and the NF or functional block in charge of lawful interception.

In a further embodiment, the NF triggering the primary authentication (e.g., UDM) sends a message to the NF or functional block in charge of lawful interception including the new keying material/information derived or to be derived during primary authentication.

In a further embodiment, the NF or functional block in charge of lawful interception sends a message to the NF triggering the primary authentication (e.g., UDM) confirming the reception of the keying materials/information. For instance, this may happen anywhere before Step 6 above, e.g., just before Step 6.

In a further embodiment, the NF or functional block in charge of lawful interception sends a message to the NF triggering the primary authentication (e.g., UDM) indicating a rejection of the start of the HONTRA procedure, e.g., because it is not ready to start HONTRA.

In a further embodiment, upon reception of said message, the PLMN (e.g., NF in charge of L1) may perform close monitoring to decide when the old keys may not be valid any longer and start using the newly received keying materials. This has the advantage of not requiring explicit signalling between the NF or functional block in charge of lawful interception sends a message to the NF triggering the primary authentication (e.g., UDM).

In a further embodiment, the sharing of the keys may be performed before the primary authentication has been retriggered, and primary authentication is only triggered once a confirmation is received from the corresponding entity stating that keying materials have been received or it is ready for the HONTRA procedure.

In a further embodiment, the exchanged keying materials/information may include at least one new root key (e.g., new K_AUSF), new validity time, new keys derived from the root key (e.g., K_AKMA), expected time to perform the HONTRA procedure, or the cause of the HONTRA procedure.

Additionally or alternatively, (e.g., HPLMN UDM) may not send a Nudm_HNAuthentication_Authenticate_Response message with a Result indication to the NF (e.g., AAnF) which requested HONTRA, as long as it has not received a verification confirmation (e.g., acknowledgment of receipt for keying materials e.g., keys for UPU, SoR, AKMA, and/or other keys derived from K_AUSF) from, e.g., VPLMN (e.g., NF in charge of L1). This has the advantage of VPLMN (e.g., NF in charge of L1) knowing when to start using the newly received keying materials without having to closely monitor the traffic.

Early sharing of keys is enabled by the home network re-authentication procedure and has the advantage of thus ensuring that, e.g., cryptographic keys, e.g., the AKMA keys described in other embodiments as well as other keys derived from the new K_AUSF, are made available for L1 purposes as early as possible.

When UE attempts to establish, e.g., an AKMA session with one or more AFs, regardless of where the AF(s) is/are, the keying materials (e.g., cryptographic keys, e.g., the AKMA keys described in other embodiments and/or other keys derived from the new K_AUSF) and parameters used in their derivation can also be communicated to a NF (e.g., SEAF/AMF/LI NF) in (V/H) PLMN, as soon as they are derived by the AAnF, and are only shared with e.g., AF(s) upon receiving an acknowledgment from VPLMN (e.g., LI NF).

In accordance with the above embodiments, it is proposed a method for lawful interception that may be implemented in a network function of a telecommunication system whereby a first network function (e.g., UDM) in a first network (e.g., HPLMN) may only be allowed to trigger a Home Network Triggered Primary Authentication (HONTRA) if it receives an acknowledgement from a second network function (e.g., Lawful Interception NF), which may be located in the first or second network, that it has received keying materials (e.g., new K_AUSF and/or keys derived from it) and/or is ready to start with the HONTRA procedure.

### Embodiment 29

In a related embodiment that can be combined with other embodiments, when the AAnF is in the serving network, K_AKMA is not derived from K_AUSF but from K_SEAF (defined in Appendix A.6 in TS 33.501) so that the derivation of a new K_AKMA does not involve the root key managed by the home network but a root key managed by the serving network and provided by the home network upon derivation from the root key. K_SEAF might also be used as input in the generation of K_AKMA for the serving network when K_AKMA is computed as in Clause 6.1/Annex A.2 in TS 33.535, i.e., K_SEAF is used instead of K_AUSF.

In a related embodiment variant, since K_SEAF may be deleted as soon as K_AMF is derived as per TS 33.501 Clause 6.2.2.1, K_AKMA might be derived as in above embodiments, e.g., embodiment 24, or as in TS 33.535 the first time.

In a related embodiment variant, if K_AKMA needs to be renewed without rerunning the primeray authentication, new K_AKMA might be derived by applying a key derivation function on the previous K_AKMA. The previous K_AKMA should be deleted as soon as the new K_AKMA is generated.

In a related embodiment variant, if K_SEAF is not renewed, a new K_AKMA for the serving network might be derived from K_SEAF and counter.

In general, above embodiments provide an apparatus for deriving/refreshing a first key (e.g., Kaf) by applying a key derivation function on a second key (e.g., K_AKMA) and an application identifier and/or a variable value (e.g., Nonce, counter, UTC time) and/or serving network identifier and/or AP identifier. In particular, the second key might be derived by applying a key derivation function on a third key (e.g., K_AUSF/K_SEAF) and/or a variable value (e.g., Nonce, counter, UTC time) and/or serving network identifier. In particular, the apparatus might trigger the key derivation of (optionally) the second key and the first key upon reception of a message, e.g., from the core network, where said message might be NAS protected or might be protected with the current third key. In particular, the second key might be refreshed/renewed in a regular manner. Furthermore, the third key may be derived upon a sucessful authentication procedure with a home network. Furthermore, the third key may be a key distributed to the serving network upon a sucessful authentication procedure with the home network where the third key (e.g., K_SEAF) is derived from a fourth key (e.g., K_AUSF). Furthermore, the fourth key might be derived upon a sucessful authentication procedure between UE and home network. The above embodiments provide a device implementing these apparatuses.

In general, above embodiments provide a method for deriving/refreshing a first key (e.g., Kaf) by applying a key derivation function on a second key and an application identifier and/or a variable value (e.g., Nonce, counter, UTC time) and/or serving network identifier where the second key might be derived by applying a key derivation function on a third key and/or a variable value (e.g., Nonce, counter, UTC time) and/or serving network identifier where the third key is shared between a first and a second device, and the first device triggers the key derivation of the first and optionally second keys upon reception and verification of a first message. Furthermore, the method allows deriving the third key from a fourth key generated upon a sucessful authentication procedure between a UE and a home network and sharing the third key with a serving network serving the UE.

### Embodiment 30

Based on TR 33737-020, AKMA roaming needs to be addressed when UE is in the VPLMN (also denoted as SPLMN) and accessing an AF (internal or external) in HPLMN or VPLMN.

As described in above embodiments, the K_AKMA might be generated in such a way to depend on the PLMN identifier or on the SEAF. This has a key advantage to achieve the requirement in TR 33737-020, namely that AFs in HPLMN and VPLMN might have different K_AKMA keys.

In a related embodiment that can be combined with other embodiments:

For the case in which the AF is in the VPLMN and K_AKMA depends on the PLMN identifier, the AUSF might derive K_AKMA and share it with, e.g., the AKMA function in the VPLMN. The AKMA function in the VPLMN may then derive a K_AF for an AF in the VPLMN.

For the case in which the AF is in the HPLMN, the AKMA network function in the HPLMN may receive K_AKMA from the AUSF. The AKMA network function may then derive K_AF for the AF.

To support Legal Interception purposes, K_AKMA may be shared with AMF/SEAF or a NF of the VPLMN that may be in charge of performing legal interception. K_AKMA sharing might be done as a push action once K_AKMA is generated or as a pull action when the VPLMN requires L1.

If K_AKMA depends on K_SEAF, then the HPLMN (AUSF) may not need to share K_AKMA with the AKMA network function in the VPLMN, but the AMF/SEAF may perform the derivation of K_AKMA from K_SEAF (or K_AMF) and K_AKMA may then be configured in the AKMA network function of the VPLMN. If the AF is in the VPLMN, the AKMA network function may then derive K_AF and provide the AF in the VPLMN with it. If the AF is in the HPLMN, the AF might also retrieve or receive K_AF from the AKMA network function in the VPLMN. Alternatively, the AKMA network function in the HPLMN may determine/retrieve K_AKMA, e.g., from K_AUSF and K_SEAF, and may derive from it K_AF.

It is to be noted that K_AKMA used to derive K_AF for an AF located in the VPLMN and K_AKMA used to derive K_AF for an AF located in the HPLMN may be different. It might be that the K_AKMA used depends on the UE location. If the UE is located in the HPLMN, then a K_AKMA/K_AF is used that directly depends on K_AUSF. If the UE is located in the VPLMN, then a K_AKMA/K_AF is used that depends on the K_SEAF.

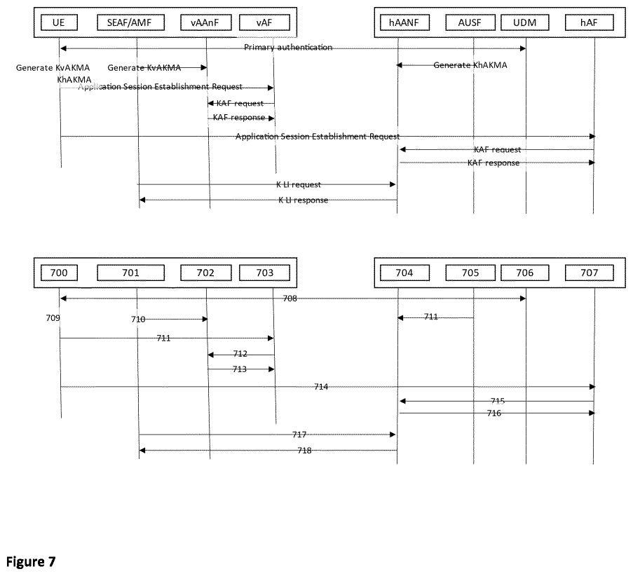

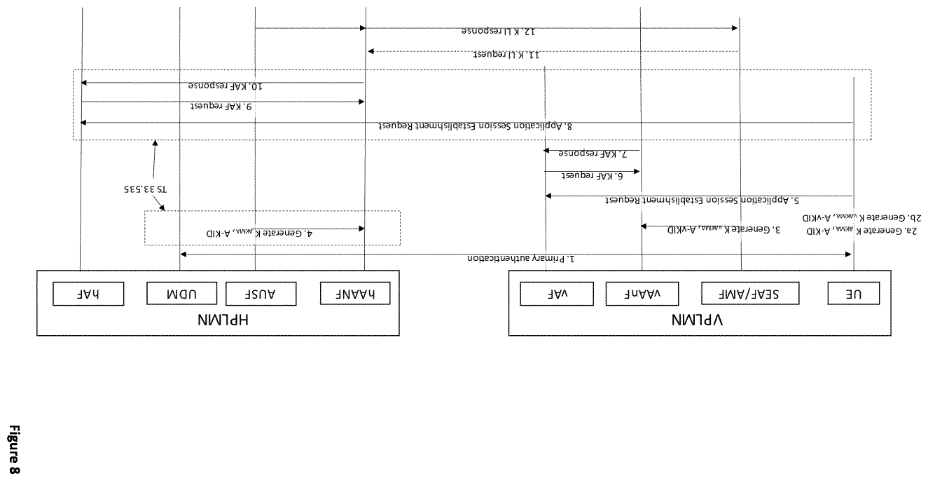

This is illustrated in FIG. 7 where the message flow and interactions between network functions is shown. FIG. 7 top shows an instantation of network functions and messages in FIG. 7 botton. Entities 700, 701, 702, 703 may be located in a visiting (or serving) network. Entities 704, 705, 706, 707 may be located in the home network. Entity 703 (e.g., an AF in the serving network) might also be located outside of the visiting/serving network. Entity 707 (e.g., an AF in the home network) might also be located outside of the home network. In Step 708 a primary authentication process is carried out. In Step 711, a function 705 such as AUSF generates a home K_AKMA that is shared/pushed/deployed to function 704. This might be done after a request. In Step 710, a function 701 such as SEAF derives a serving K_AKMA and pushes/deployes it to 702, e.g., the serving AKMA. In Step 709, device 700 may generate the home K_AKMA and/or the serving K_AKMA as described above. In Steps 711/712/713 and 714/715/716, the UE sends a session establishment request to the respective AF in serving and home PLMNs triggering the corresponding requests and responses of K_AF. On request (717) or by default (718), the home PLMN, e.g., the home AKMA network function can push encryption keys to the serving PLMN, e.g., to the serving AKMA or the SEAF/AMF if the K_AF used by 707 (the AF in the home network) depends on the home_K_AKMA. If it depends on the serving K_AKMA, these steps are not required.

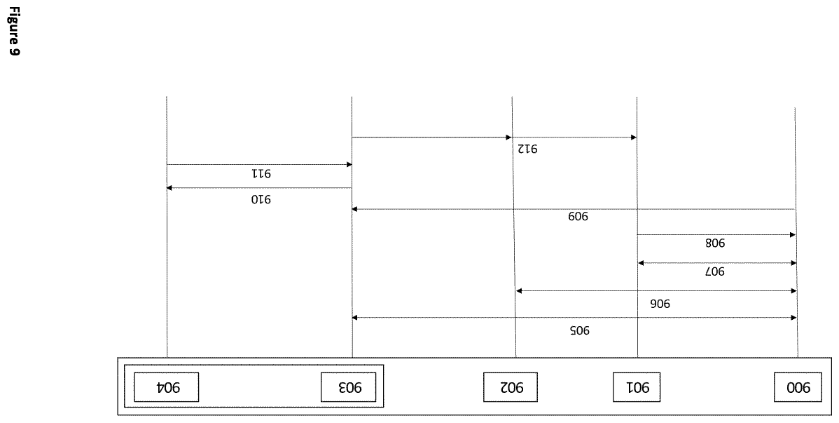

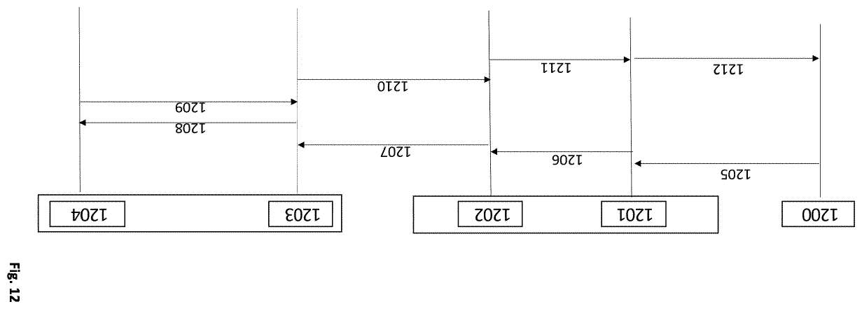

This is also illustrated in FIG. 8 where Steps 1, 2a, 4 are as defined in TS 33.501 clause 6.1.3 and TS 33.535 Clause 6.1. A UE might perfoorm Step 2b and/or Step 2a when located in the VPLMN. Step 2b is as defined in TS 33.535 Clause 6.1 with the exceptions that the UE roaming in the VPLMN computes: (1) K_vAKMA as in TS 33.535 Annex A.2 using K_SEAF instead of K_AUSF; (2) A-vKID is as A-KID in TS 33.535 Clause 6.1 with the exception that the realm part of the A-vKID shall include Serving Network Identifier and A-vTID is used; and (3) A-vTID is as the A-TID in TS 33.535 Clause 6.1 with the exception that it shall be derived as specified in Annex A.3 using K_SEAF instead of K_AUSF. Step 3 is as defined in TS 33.535 Clause 6.1 having the SEAF in the VPLMN to compute K_vAKMA with the same exceptions as in Step 2b. In Step 5 the UE requests an application session establishment request with A-vKID towards the vAF. In Step 6 the vAF shall discover the vAAnF and shall send the Naanf_AKMA_ApplicationKey_Get request with A-vKID and AF_ID to the vAAnF. In Step 7 the vAAnF shall respond with Naanf_AKMA_ApplicationKey_Get response containing Registered SN ID. The VPLMN has all secrets to support L1 when the AF is in or attached to the VPLMN. Steps 8, 9, 10 are as in TS 33.535. In Steps 11, 12 the VPLMN may request AKMA keys for L1 purposes (when the K_AF used by hAF depends on KAKMA) and the HPLMN provides them. Note that in Step 4, the HPLMN may also derive K_AF depending on KvAKMA instead of KAKMA. In this case, Steps 11, 12 are not required since these keys are known to the VPLMN. This is illustrated in FIG. 11 wherein only K_vAKMA is computed by the UE, and thus, the K_AKMA to use is determined only by the UE location and not by the AF location as above. In Steps 2, 3, and 4 in FIG. 11, only K_vAKMA and A_vKID are computed as above, i.e., dependent on K_SEAF. Steps 5-8 as well as Steps 9-12 are as in TS 33.535 but using K_vAKMA and A_vKID. In Steps 13 and 14, the AMF/SEAF in the VPLMN might optionally request other security information for L1 purposes to the vAF and/or hAF, e.g., Ua* protocol, security algorithms, etc. This request might be done to a local vAF or to the hAF. In Steps 15 and 16, the vAF and/or hAF deliver any additional information required for L1 purposes when available or requested.

It is to be noted that additionally or alternatively, identifiers such as A-TID, A_vTID or keys such as K_AKMA or KvAFMA might also be derived using as input other parameters in the KDF as in other embodiments such AF_ID, (V/H) PLMN, or a nonce etc. This is beneficial to limit privacy issues in the AKMA identifiers (namely A-TID) that otherwise only depends on the SUPI and KAUSF and that it might be (re) used by multiple/different applications.

### Embodiment 31

In an embodiment that might be combined with other embodiments, the A-KID identifier may be in NAI format as specified in clause 2.2 of IETF RFC 7542 [6], i.e. username@realm.

The username part may include the RID (Routing Indicator) and the A-TID (AKMA Temporary UE Identifier), and the realm part may include Home PLMN or VPLMN Identifier, depending on where the AF is located.

The serving PLMN might also be included in the username part.

This construction aims at fulfilling the requirements on the AKMA key identifier in the roaming case, namely that AKMA AF shall be able to identify the AAnF serving the UE from the A-KID.

In reference to FIG. 7, Steps 709, 710 and 711 might also involve the generation of the A-KID identifier.

### Embodiment 32

An eavesdropper (e.g., AF1) may be capable of learning that UE is attempting to establish a session with another AF (e.g., AF2), and obtain UE's identifier, e.g., GPSI, external identifier. To this end, the eavesdropper may intercept the Session Establishment Request (see e.g., Step 1 in FIGS. 6.2-1 in TS 33.535) intended for AF2, thus, divulging the identity of the AF which UE is trying to contact. The eavesdropper may extract the UE's A-KID from the Session Establishment request. The eavesdropper may combine it with its AF_ID in an AKMA AF Key Request sent to AAnF to eventually request and retrieve the UE identifier, e.g., GPSI, and a K_AF (different from K_AF established between UE and AF1). Thus, the way the 5G system authorises AKMA AF Key Requests might lead to potential AKMA privacy violations, namely the disclosure of the UE identifier and the identity of the AF UE tries to establish a session with.

In an embodiment variant intended to address this issue, the AKMA Session Establishment Request Message may include the AF_ID to identify which AF the request is intended for. This request is sent to the CN/PLMN/NF offering AKMA services. The request may be then unicast (or only shared) to the relevant target AF, which may then send an AF Key Request to AAnF using the received A-KID.

In a related embodiment variant, since the CN/PLMN/NF are aware of the target AF (because the UE shared that AF_ID), the CN/PLMN/NF (AAnF) have the capability of monitoring which AF is sending an AKMA AF Key Request and blocking/rejecting non-authorized requests.

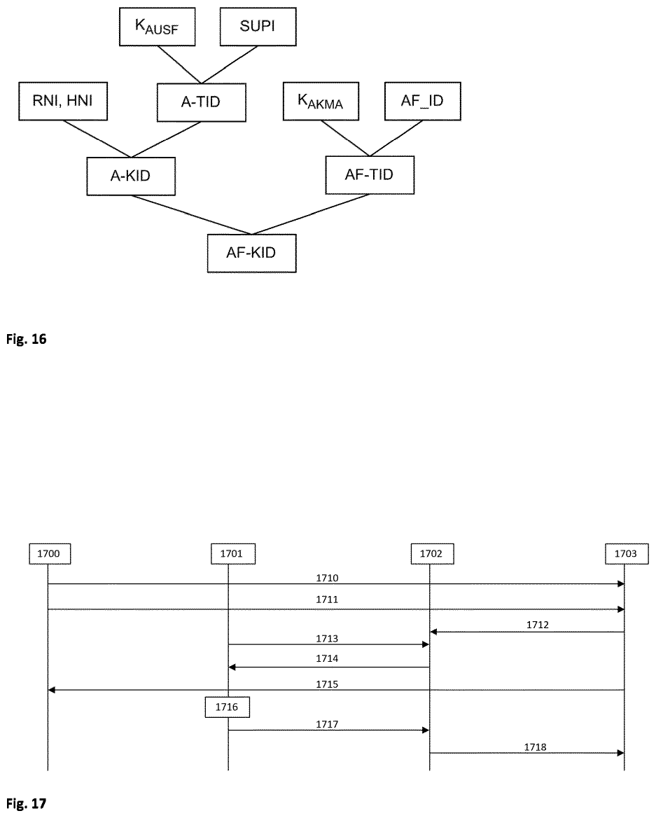

In a further embodiment variant, AF_ID may be combined with A-KID to generate an Application Function Key Identifier (AF-KID) as shown in FIG. 16 AF-KID is in the format username@realm such that username may include
RID (Routing Indicator) and
A-TID (AKMA Temporary ID) and/or
AF-TID (Application Function Temporary ID),
   while realm includes the network (e.g., Home network) identifier.
   If AF-TID is AF_ID, then this embodiment variant is similar to previous embodiment variants. AF-TID may be derived by using a key derivation function (as for the A-TID) with the following parameters:
The input key KEY may be K_AKMA or a key derived from it or a key as in other embodiments.
The parameters used to form the input S to the KDF may combine multiple parameters, e.g., “AF-TID” and/or AF_ID and/or Salt. If the three parameters are present, it may be, e.g., as follows:
   FC=To Be Defined Value;
   P0=“AF-TID”; (bitstring identifying the identifier)
   L0=length of “AF-TID”;
   P1=AF_ID;
   L1=Length of AF_ID.
   P2=Salt (random value used to randomize the output)
   L2=Length of salt.

The UE may send an AKMA Session Establishment Request Message with AF-KID to the relevant AF (or different AF-KIDs to different AFs). The CN may keep the salt if present for verification purposes. An advantage of including the salt is that the identifier is randomized, e.g., in every interaction, so that it is difficult to guess the identifier in different requests without having access to the salt. An alternative to a salt might be a counter, e.g., a time based counter. The AF may use the identifier (i.e., AF-KID) to identify the AAnF serving the UE. The AF may send an AKMA AF Key Request to the AAnF containing its AF_ID and/or AF-KID. Once AAnF receives the AKMA AF Key Request message, it may omit the AF-TID part from username leaving A-KID, which is then used to verify whether the subscriber is authorized to use AKMA services based on the presense of a K_AKMA linked to that A-KID. AAnF may use the K_AKMA (or other key used as input above) identified with the AF_ID received from AF and/or the salt to generate AF-TID. This may then be verified against the AF-TID received from AF as part of AF-KID. If the verifications are executed succesfully, AAnF proceeds to provide AF through e.g., Naaf_AKMA_ApplicationKey_Get_response with K_AF, K_AF expTime, and SUPI/GPSI. Otherwise, AAnF may send a Naaf_AKMA_ApplicationKey_Get with an error response.

In an alternative/additional embodiment variant, AF-TID may be sent separatelly from A-KID (e.g., in different messages or message fields) in the AKMA Session Establishment Request to AF. AF may use A-KID to identify the AAnF serving UE and send an AKMA AF Key Request containing A-KID, AF-TID, and AF_ID. AAnF may verify the presense of a K_AKMA linked to A-KID, and then may use it (or other key used as input above) with the received AF-ID and/or the salt to generate the AF-TID. AAnF then compares the AF-TID generated against the one received from AF. AAnF proceeds similarly to the previous embodiment depending on whether the verifications were succesful or not.

In an alternative/additional embodiment variant, a value such as a salt or time-based counter is used to randomize identifiers, e.g., as in the previous embodiment variant. Such a parameter (e.g., salt) may be sent and kept at the CN and may not be forwarded to the AF.

In a further embodiment variant, AF_ID is combined in A-KID itself and may also be derived from a salt as in above embodiment variants. This may be done by a NF such as the AUSF for each of the AF for which the user has a subscription or for each of the AF that are served. After the primary authentication, AUSF may derive AKMA keying materials (e.g., K_AKMA) and identifiers (e.g., list of A-KIDs), such that each A-KID identifies a specific AF in addition to K_AKMA, and send send them to AAnF. Then when an AF sends an AKMA AF Key Request to the AAnF, the AAnF can verify based on the A-KID (that depends on AF_ID) in the request whether the AF is authorized.

In a further related embodiment variant, the AAnF might receive the AKMA AF Key Request from an AF including the AF_ID and A-KID, and may send to the AUSF the received request, e.g., A-KID, AF_ID and/or salt so that the AUSF can verify that the received parameters (e.g., AF_ID, salt, . . . can be used to compute the received A-KID). The AUSF then sends a confirmation (e.g., verification result) to the AAnF. In a further related embodiment variant, the AAnF might receive the AKMA AF Key Request from an AF including the AF_ID and A-KID, the AAnF may send to the AUSF the received AF_ID, SUPI, and/or salt so that the AUSF can derive A-KID and send it back to AAnF. AAnF then verifies whether the A-KID in the AKMA AF Key Request from AF matches the A-KID received from AUSF, then send a response to AF accordingly.

### Embodiment 33

In an embodiment that might be combined with other embodiments, the VPLMN might not wish to allow the UE or AF as per FIG. 7 or FIG. 11 or TS 33.535 to start the Application Session (e.g., Ua* protocol), e.g., as requested in message 714. Thus, messages 717 and 718 (in which the VPLMN is configured with AKMA keys by the HPLMN) are executed before message 716 (in which an application key is shared with the AF, 707). The message flow would be message 715 (KAF request), message 718 (K LI response to configure keys), message 717 (K LI configuration confirmation), message 716 (KAF response).

It is advantageous if message 716 is not exchanged to configure KAF as long as the HPLMN has not received a confirmation from the VPLMN about the reception of AKMA keys. This is a configuration that might be stored as a policy in the HPLMN. This configuration might have been received by the VPLMN or might be stated in a Service Level Agreement.

Note that a further advantage of this message flow is that once message 717 is sent by the VPLMN, the VPLMN knows that a new AF is going to start a new Application Session (e.g., Ua*), thus, it can start monitoring the traffic. A change in the traffic patter shortly after the sending of message 717 allows the VPLMN (or NF, e.g., UPF, in the VPLMN in charge of LI) to determine the protocol flow corresponding to the new Application Session.

Furthermore, the Application Session (e.g., Ua*, e.g., TLS 1.2 or TLS 1.3 or DTLS) might involve the exchange of further keys that are required for legal interception (L1) purposes. Thus, a NF in the HPLMN, e.g., 704, e.g., hAANF, may provide a NF in the VPLMN, e.g., 701, i.e., vAANF or another entity storing such keying materials for L1, e.g., AMF or SEAF, with further keys as soon as those keys determined by the AF have been computed.

The order of messages (i.e., KAF request from AF to HPLMN, followed by messages K LI request, K LI response, and K LI configuration confirmation exchanged between VPLMN e.g., LI NF/AMF/SEAF and HPLMN e.g., AAnF, and finally KAF response) in the beginning of the embodiment guarantees that key materials (e.g., K_AF) are provided to VPLMN (e.g., LI NF/SEAF/AMF) which confirms that the key materials received match its LI configuration requirements, then it sends a confirmation to AAnF. Only after AAnF receives the confirmation from VPLMN, it provides AF with the key materials to establish the session with UE.

In accordance with this embodiment, it is proposed a method for lawful interception that may be implemented in a network function of a telecommunication system whereby a first entity (e.g., AAnF) in a first network (e.g., HPLMN) receives a key request (e.g., K_AF request), the first entity computes the requested keying materia (e.g, K_AF)I, and shares said keying material with a lawful interception entity (e.g., UPF, SEAF, AAnF), where the lawful interception entity might be in a second network (VPLMN) or in the first network, and only upon confirmation of the correct reception of the key, the first entity shares the keying material with the requesting entity.

### Embodiment 34

In an embodiment that might be combined with other embodiments, when UE sends an AKMA session establishment request to the AF, AF (e.g., AF in HPLMN or external AF) may send the AKMA AF Key request to HPLMN (e.g., AAnF) and include in it encryption parameters (e.g., encryption algorithms, encryption key and/or parameters to derive the encryption key) intended for use in the session to be established between AF and UE. This has the advantage of providing the network (HPLMN and/or VPLMN) with all required keying materials/parameters required for lawful interception.

In an alternative embodiment, the keying materials/parameters may be transmitted in a same first message in which K_AF is requested, or in a second separate message, prior/after/together to/with the first message.

In an alternative embodiment, AF might provide these encryption keying materials and/or parameters after HPLMN provides AF with K_AF following, e.g., the procedure described in other embodiments.

In a further embodiment that might be combined with other embodiments, with reference to FIG. 17, a NF (e.g, 1701) in VPLMN (e.g., SEAF) may be able to verify the keying materials/parameters that an AF (1703, e.g., as HPLMN AF or external AF) intend to use for encrypting the traffic in its session with UE (e.g. 1700), before HPLMN (1702) provides K AF to said AF.

For instance, consider the following message flow related to FIG. 17 in which such verification occurs and where steps/messages are performed at a given moment in an exemplary mode, i.e., steps may be performed more than once and/or in a different order and/or maybe optional. In this example, 800 might send a message, e.g., an AKMA Session Establishment Request, in message 1710 to 1703. Furthermore, 1700 may start a security association, e.g., the security association of an Ua*prootocol, e.g., it may start a handshake (e.g., TLS handshake) with a ClientHello in message 1711. 1703 might send an AKMA AF Key Request in message 1712. Message 1712 might include A-KID and encryption parameters (e.g., encryption algorithms, encryption/decryption keys, and other security parameters e.g., nonces) to 1702. 1701 might send a K LI Request to 1702 following messages 1710 and 1711. 1701 might also not be sent or it might have been sent earlier or it may be sent later. 1702 computes K_AF and it might store or send for storage some of the encryption parameters. 1702 replies with a message K LI response (message 1714) containing K_AF and/or the encryption parameters. 1703 might send a message of the security association (e.g, a message of the Ua* protocol, e.g., a TLS ServerHello response) in message 1715, which, e.g., 1701 (or 1702) can intercept and use to verify the encryption parameters, e.g., received in step 1716. The verification might be done, e.g., by checking that the private key AF provided in message 1712 corresponds to the public key intercepted in message 1715. Upon succesful verification, 1701 may send an acknowledgment e.g., K LI confirmation to 1702. If the verification is not sucessful, 1701 may send a failure message to indicate 1702 of the issue. 1702 may then send in message 1718 an AKMA AF Key Response containing K_AF to 1703. If 1702 intercepted 1715, then 1702 might then release it to 1700 so that the security association is further established.

In above scenario, the fact that message 1715 is intercepted, and maybe cached/stopped, has the advantage that the entity performing the interception has the capability to ensure that no-communication occurs as long as the message 1715 has not been released. Thus, it might be advantageous if certain messages exchanged over a telecommunication system between a UE and an AF, e.g., messages of Ua* protocols, have a certain field that indicates that they are critical to establish the security association. This might be, e.g., the ServerHello response.

Thus, in a further embodiment, the entity performing interception is configured with a policy determining the messages that require interception, where the policy might have been configured by a lawful enforcement authority overseeing lawful interception in the jurisdiction where the telecommunication system and UE are located. It is further advantageous if the entity performing the interception/caching is located in the VPLMN so that the VPLMN does not depend on the HPLMN.

In above embodiment, message 1715 is the message that is intercepted and maybe cached/stopped since in above embodiment message 1715 may represent the reply from 1703 for the establishment of Ua* security association. However, message 1711 might also be the one that is intercepted and maybe cached/stopped.

In above embodiment, message 1711 goes from 1700 to 1703 and message 1715 goes from 1703 to 1700. However, the security association messages 1711 and 1715 might also be exchanged the other way around, I.e., 1711 might go from from 1703 to 1700 and 1715 from 1700 to 1703.

In general, it is proposed a method for Lawful Interception that can be implemented in a Lawful interception entity, e.g., a NF in a telecommunication system, whereby:
An first entity (e.g., AF) sends a key request and security parameters to a second entity in a first network (e.g, AAnF),
The second entity determines the key and shares it and the security parameters with a third entity (e.g., a lawful interception entity in the first network or in a second network),
The third entity monitors/intercepts/caches a message sent by the first entity to a fourth entity (e.g., UE) and uses it to verify the validity of the received security parameters, In a related embodiment,
the third entity further sends the result of the validity verification to the second entity, and
the second entity shares the key upon successful validity verification.

In a related method, the message is only released by the third entity to the fourth entity if the verification is successful.

It is further proposed a method for Lawful interception that can be implemented in a UE whereby:
A fourth entiy sends a first message (e.g., an Application Session Establishment Request) to a first entity;
The fourth entity sends a second message (e.g., initial message of the security association in a Ua* protocol such as a ClientHello message in TLS) to the first entity;
The fourth entity receives a third message (e.g., an Application Session Establishment response).

### Embodiment 35

In some scenarios, AKMA may give support to multiple security protocols, e.g., TLS, DTLS, OSCORE, etc. Protocols such as OSCORE or COAP are used to protect, e.g., Constrained Application Protocol (CoAP). These security protocols have different purposes, e.g., TLS may be used by standard applications while OSCORE focuses on IoT devices. This increases the complexity of NFs, e.g., a LI NF in charge of L1 of AKMA related communications.

For instance, Constrained Application Protocol (CoAP) may be used between UE and an AF. the CoAP client (e.g., UE) may start communication via Ua* reference point and try to establish a DTLS tunnel with the AF. The CoAP client might indicate to the AF that AKMA-based authentication is supported and AF may select AKMA for deriving the keys (e.g., to compute MIC and/or encrypt traffic).

An aim is to address this increasing complexity by means of the following embodiments that may be combined with each other as appropiate.

In an embodiment, an entity performing LI (e.g., LI NF in VPLMN) may be configured with a policy determining the messages/protocols that require interception and in which context. For instance, the policy may not require handling OSCORE related keys as long as the communication flow of OSCORE/CoAP fits the communication pattern of a smart device, e.g., a smart meter, however OSCORE related keys should be handled when the communication pattern is different, e.g., when CoAP seems to be used for messaging.

In a related embodiment, the policy might have been configured by a lawful enforcement authority overseeing lawful interception in the jurisdiction where the telecommunication system and UE are located. It is advantageous if the entity performing the interception/caching is located in the VPLMN so that the VPLMN does not depend on the HPLMN.

In a further embodiment, the entity performing LI may inform a NF in charge of keys (e.g., the UDM or AUSF or AaNF, e.g., in the HPLMN) about the messages/protocols that require lawful interception as derived from the policy.

In a further embodiment, the entity performing LI may provide the NF in charge of keys (e.g., the UDM or AUSF or AaNF, e.g., in the HPLMN) with the policy.

These embodiments have the advantage that the HPLMN is not overloaded when handling keys of protocols (e.g., OSCORE) that may or may not be required for LI.

In a further embodiment, a NF in charge of keys (e.g., the UDM or AUSF or AaNF, e.g., in the HPLMN) may provide the entity performing LI with only those keys required according to the policy. This has the advantage that the HPLMN is not overloaded when handling keys that may or may not be required for LI.

In a further embodiment, if a given application communication protocol (e.g., CoAP) is used between UE and AF, HPLMN (e.g., AAnF) may not provide AF with keying materials (e.g., K_AF) associated to a security protocol (e.g., OSCORE or DTLS) used to protect the application communication protocol as long as it has not received an acknolwedgment from VPLMN (e.g., LI NF) requiring the delivery of keys for this security protocol.

In an embodiment, with reference to FIG. 17, a LI NF (e.g., 1701) in V/HPLMN may be able to derive the OSCORE security context that an AF (1703, e.g. HPLMN AF or external AF) and a UE (e.g. 1700) try to establish, in case the CoAP security protocol OSCORE is used as the Ua* protocol between 1700 and 1703 through HPLMN (e.g., 1702).

In a further embodiment considering the message flow in FIG. 17, where steps/messages are provided in an exampleray mode i.e., some steps may be performed more than once, and/or performed in a different order, or may be optional, and assuming OSCORE is used as the Ua* protocol, 1700 may start a security association (e.g., communicate its OSCORE parameters) through a CoAP Request (e.g., message 1711), which may include/replace the Application Session Establishment Request and may contain at least one of the following:
CoAP method (e.g., POST); and,
URI of the AKMA ressource on 1703 (e.g., <AF_IP_or_FQDN>/akma where AF_IP or FQDN indicate the IP address or the FQDN of the 1703's host); and,
Payload: CoAP security protocol identifier, A-KID, and the OSCORE specific parameters N1, AF-SID, and/or ?OSC-NIP, where:
   The CoAP security protocol identifier is set to the value “01” in case of OSCORE use;
   A-KID is the AKMA Key Identifier;
   N1 is a nonce generated by 1700;
   AF-SID is the OSCORE Sender Identifier generated by 1700 for 1703 (to enable short locally unique identifiers),
   ?OSC-NIP is an optional parameter denoting any additional OSCORE input 1700 might provide to 1703
      To obtain keying material (e.g., K_AF) 1703 may send an AKMA AF Key Request in message 1712 to a NF in 1702 (e.g., AAnF), which may include A-KID, in addition to the OSCORE parameters containing, e.g.:
A response Code e.g., “Created”; and
Payload: N2, and UE-SID, such that N2 is a nonce generated by 1703 and UE-SID is the OSCORE Sender Identifier for 1700 (e.g., UE) generated by 1703. It may also include the received OSCORE parameters, e.g., N1.
   Upon detecting the CoAP Request (i.e., message 1711), 1701 might optionally send a LI request message (e.g., message 1713) before, or after 1703 has sent message 1712 to 1702. In response to message 1713 and/or upon receiving message 1712 (e.g., in case 1701 did not send a LI request), 1702 sends message 1714 (e.g., LI response) containing the keying materials (e.g., K_AF, salt, and other parameters) which include 1703's OSCORE parameters. 1701 may use the keying materials (e.g., K_AF, salt, and/or other parameters), including the OSCORE parameters from 1700 (e.g., intercepted from message 1711), and the OSCORE parameters from 1703 (e.g., communicated in message 1714) to derive the OSCORE security context in step 1716. Then, and only then, 1701 may provide 1702 with an acknowledgment message (e.g., confirmation message 1717), which permits 1702 to provide 1703 with the keying materials (e.g., K_AF) in message 1718 (e.g., AKMA Key response) to derive the OSCORE security context.
   In response to message 1711 (e.g., CoAP request), 1703 may send message 1715 (e.g., CoAP response) containing 1703's OSCORE parameters (e.g., response code, N2, and UE-SID). 1701 may intercept message 1715 to verify that the OSCORE parameters it includes match with the OSCORE parameters it received in message 1714. Upon successful verification, 1701 may forward message 1715 to 1700 which may at that stage derive the OSCORE Security Context.

In a related embodiment, message 1715 (e.g., CoAP Response) may be sent to 1700 before the AKMA AF Key Request (e.g., message 1712) is made, in which case, 1701 may intercept and cache/stop message 1715 until it has derived the OSCORE's security context. In case any other parameters are required to derive said context, 1701 may indicate which parameters are needed in message 1713 (e.g., LI request), and once provided in message 1714 and verified in step 1716, 1701 may send an acknowledgment message (e.g., 1717) to 1702, which then, and only then, it may provide 1703 with the keying materials (e.g., K_AF).

In a further embodiment which may be combined with other embodiments, the entity performing interception may be configured with a policy determining the protocols and/or messages that require interception and/or caching, where the policy might have been configured by a lawful enforcement authority overseeing lawful interception in the jurisdiction where the telecommunication system and 1700 (e.g., UE) are located. It is further advantageous if the entity performing the interception/caching is located in 1701 (e.g, VPLMN) so that the VPLMN does not depend on the HPLMN.

In accordance with above embodiments, it is proposed an apparatus and method by which a NF (e.g., UDM,AUSF, or AAnF), in charge of keys and/or key derivation, in a first network (e.g., HPLMN) is configured (e.g., through a policy) by a lawful interception entity/NF located in the same network or in a second network (e.g., VPLMN), wherein the configuration/policy determines the context, protocols (TLS, DTLS, OSCORE, . . . ) and/or messages, e.g., AKMA specific, that require interception.

In accordance with above embodiments and above proposed apparatus/method, the NF (e.g., UDM, AUSF, or AAnF) may also be requested to provide keying material (e.g., K_AF and or other parameters) to a requesting entity (e.g., AF) communicating with a device (e.g., smart device/UE) in the second network (e.g., VPLMN), the NF (e.g., UDM, AUSF, or AAnF), may only do so (e.g., provide the requesting entity with keying material) upon receiving an acknowledgment/verification confirmation from the lawful interception entity.

### Embodiment 36

During an on-going Ua* session between the AF and UE, K_AF might expire and thus might need to be refreshed (e.g., by triggering a home-triggered primary authentication). In this situation, keying materials are updated and the ongoing Ua* session needs to proceed as usual and the lawful interception requirements must be met. To address this situation, the following embodiments that might be combined with other embodiments may apply:

In a first embodiment, the AF may request a new KAF from HPLMN (e.g., AAnF) wherein it may include any security parameters that may be used to derive security metarials, HPLMN may inform VPLMN (e.g., LI NF/SEAF) of the request received from AF, share the new KAF and security parameters with VPLMN (e.g., LI NF/SEAF), and wait for an LI configuration confirmation from it. Upon receiving the keying materials (e.g., KAF and security parameters) from HPLMN, the VPLMN (e.g., LI NF/SEAF) may check that the provided keying materials (e.g., KAF and security parameters) fulfill its LI configuration requirements, and if so, VPLMN may send a confirmation to HPLMN which then provides AF with the new K_AF.

In a further embodiment that might be combined with other embodiments, during an on-going Ua* sessions (e.g., TLS/DTLS session) between AF and a UE, K_AF might expire and/or AF might want to update or refresh the security keys/parameters used to encrypt the Ua* session. AF may be required to inform HPLMN (e.g., AAnF) and provide the new security parameters (e.g., encryption algorithms, encryption/decryption keys, and any other parameters e.g., nonces, counters) by means of a message e.g., a request for new K_AF. Providing the new K_AF and/or approval to use the new security keys for encryption depends on VPLMN's (e.g., LI NF/SEAF) acknowledgment i.e., HPLMN may need to provide the security parameters and/or the new K_AF to VPLMN which verifies them before it sends a confirmation to HPLMN. If VPLMN approves, HPLMN may provide the new K_AF and/or approval to renew the security keys to AF.

In a further embodiment that might be combined with other embodiments, AF may send a request to UE to renew the security parameters (e.g., encryption keys), e.g., during an on-going Ua* session. The request may be intercepted by VPLMN and used to verify that the security parameters AF sent in a request (e.g., a key refresh request) to HPLMN are sufficient to meet VPLMN's LI requirements (i.e., enable a LI NF in VPLMN to decrypt the traffic). If so, VPLMN may confirm the request to renew the security parameters and send the confirmation to HPLMN (e.g., AAnF), which forwards it to AF.

In a further embodiment that might be combined with other embodiments, AF may be required to assist VPLMN in the verification of its security parameters e.g., by providing further parameters (e.g., parameters used in key derivations) upon request. This might involve, e.g., the VPLMN sending a request to the AF (through the HPLMN).

In some embodiments, the description has been done as having a VPLMN and HPLMN. However, in some cases, there might be a single network (e.g., HPLMN). In this case, a first NF in the HPLMN (e.g., AAnF) might only send K_AF to the AF once a second NF in the network (in charge of lawful interception) has been configured with encryption keys/K_AF and a confirmation/acknowledgement has been provided to the first NF.

In some embodiments, the description has been done in terms of a lawful interception NF, however, this may also also be understood, without loss of generality, as a lawful interception entity that might be part of a NF or interact with the (core network of) a telecommunications system.

In general, it is proposed another method by which VPLMN can verify and allow the renewal of security parameters (e.g., encryption keys, K_AF) during an on-going Ua* session between AF and UE, wherein the AF sends a request to a NF (e.g., AAnF) in a first network (e.g., HPLMN) to request approval for the renewal/refreshing of security parameters (e.g., encryption keys, K_AF), the first network (e.g., HPLMN) forwards the request to a NF (e.g., LI NF/SEAF) in a second network (e.g., VPLMN), the second network verifies that the new security parameters fulfill its LI requirements (i.e., provide the means to decrypt the traffic), and sends a confirmation to the first network, and finally the first network sends the new K_AF and/or an approval to renew keys to AF.

### Embodiment 37

In an embodiment, AKMA is extended and/or configured to use an ETSI Middlebox Security Protocol (MSP). For instance, AKMA is configured to use as Ua* protocol ETSI TS 103 523-2 or TS 103 523-3. For instance, in the case of TS 103 523-3 V1.1.1, eTLS runs between an Application Proxy or AF (e.g., in the HPLMN or VPLMN) as described in other embodiments and UE. The middlebox is located in between, e.g., in the HPLMN or in the VPLMN.

If such ETSI Middlebox Security Protocol (MSP) is used, then the middlebox, e.g., a NF in the VPLMN such as SEAF or UPF, can be configured with AKMA keys and/or Middlebox Security Protocol keys (e.g., eTLS keys) by means of messages explained in other embodiments, e.g., Embodiment 33.

### Embodiment 38

In an embodiment that can be combined with other embodiments, a first network (e.g., the HPLMN) sends AKMA related parameters such as K_AKMA and/or the AKMA indication and/or Routing indicator, etc to a second network (e.g., the VPLMN) so that the second network can know whether the UE supports AKMA services and how to handle them.

For instance, when the first network provides K_SEAF (or K_AKMA) to the second network after primary authentication, an entity in the first network handling the long term credentials/policies/subscriptions of the UE (e.g., UDM of the HPLMN) will return the AKMA related parameters to a NF in the second network. This can be done by means of the UDM, but using the “Nudm_UEAuthentication_Get service operation” service (TS 33.501, Clause 14.2.2) that may return, e.g., (1) SUPI if SUCI was used as input; (2) depending on the authentication method, authentication data (e.g. AKA authentication vector) for the SUPI or (3) AKMA Indication and Routing indicator, if the subscriber has an AKMA subscription as per TS 33.535.

In a further embodiment that can be combined with other embodiments, the second network might determine by itself some AKMA parameters upon reception of an indication (e.g., a key used to derive AKMA keys such as K_AKMA or K_SEAF) that it is in charge of handling AKMA for a UE when the UE is in its scope. For instance, receiving K_AKMA from the HPLMN can serve as implicity AKMA indication. For instance, the second network might determine the routing indicator to use when providing AKMA services to the UE.

In a further embodiment that can be combined with other embodiments, the UE might provide the VPLMN one or more of the AKMA related parameters, e.g., once or if the VPLMN has indicated the support of AKMA services.

In a further embodiment that can be combined with other embodiments, the UE might receive from the VPLMN one or more of the AKMA related parameters, e.g., once or if the VPLMN has indicated the support of AKMA services.

In an embodiment, the HPLMN can provide the AKMA indication to the VPLMN (SEAF/AMF) as part of the subscription data.

In an embodiment, the routing indicator to use when the UE is in roaming is a default routing indicator so that it does not need to be communicated to the VPLMN and the UE can select it knowing that it is roaming. In this case, the AAnF NF consumer can select any AAnF instance within the VPLMN.

In an embodiment, the routing indicator to use when a UE from HPLMN is in roaming is a default routing indicator associated to the HPLMN so that it does not need to be communicated to the VPLMN and the UE can select it knowing that it is roaming. In other words, all UEs from the HPLMN will be using a same AAnF in the VPLMN associated to the HPLMN.

### Embodiment 39

In a further embodiment that might be used independently or combined with others, the VPLMN might provide AKMA services but the HPLMN might not provide AKMA services.

The derivation of the AKMA key at the VPLMN from a key such as K_SEAF is beneficial since it allows the implementation of AKMA services at the VLPMN even if the HPLMN does not implement such services.

Alternatively, a functionality might be available at the HPLMN to always derive K_AKMA (e.g., as in TS 33.535) even if the HPLMN itself does not provide AKMA services. This functionality might be, e.g., at the AUSF or UDM. K_AKMA might be provided to the VPLMN together with K_SEAF.

The HPLMN might also indicate the VPLMN whether the device is an AKMA capable device independently of whether the HPLMN supports AKMA services itself so that the VPLMN can offer AKMA services if it supports them.

The UE might also indicate the VPLMN if it is an AKMA capable device independently or whether the HPLMN supports AKMA services itself so that the VPLMN can offer AKMA services if it supports them.

The VPLMN might provide the UE with its AKMA configuration parameters, e.g., in a secure manner, e.g., by means of a NAS message or protected with a VPLMN AKMA specific key as in other embodiments.

The VPLMN might also provide the HPLMN with an indication on the support of AKMA services so that the HPLMN provides the VPLMN with required parameters only on demand.

In a particular example of this embodiment, the VPLMN, when offering AKMA services, and in accordance with TS 33.501 Clause W.4.1.3, might also enable UEs to authenticate to the MBSTF based on AKMA, e.g., to register to the MBS service and receive MBS traffic, while UEs in HPLMN might use GBA, if HPLMN does not offer AKMA services.

### Embodiment 40

An Authentication Proxy (AP) is an HTTP proxy that plays the role of a network authentication function for a UE. It performs the TLS security connection with the UE so that the application server (AS) does not need to be involved in it. The AP can assure the ASs that the request is coming from an authorized UE. An AP is meaningful since it can decrease, e.g., the consumption of authentication vectors. AP could be introduced in AKMA so that different Application Functions in AKMA which are in the same trust domain or edge node can rely on the AP to execute AKMA procedures. Thus, in above embodiments an AP might be located, e.g., between AF and some of the other network functions, e.g., AaNF or AuSF. The Kaf might then be handled at the AP on behalf of an Afs. A single user plane interface between UE and AP might be needed since a number of Afs (in a common security domain) would be behind a same AP. Furthermore, the key derivation functions used to derive Kaf or Kakma might include a parameter to identify a given AP. In particular, there might be a Kap that could be generated in a similar way as above on behalf of Afs in a same security domain behind a common AP. In particular, the Kap might be related to Afs in the serving PLMN or the home PLMN. In reference to FIG. 7, entity 703 might be an AP in the serving PLMN serving AF in the serving PLMN. In reference to FIG. 7, entity 707 might be an AP in the home PLMN serving AF in the home PLMN.

The AP may also play a role in Legal Interception (LI). This might be in particular, in the case that the AF is outside of the HPLMN and the UE is in a VPLMN. The reason is that for LI all required exchanged data need to (or may need to) be shared with VPLMN. Thus, an external AF requiring AKMA security may (need to) be executed over an AP in the HPLMN. This may be based on a policy. For instance, if an external AF denies exchaging the encryption keys, the (operator of) HPLMN might deploy and enforce a policy by which an AP should serve that AF in the HPLMN. Additionally or alternatively, in a first variant, the AP at the HPLMN may (have to) share AKMA/AF keys as well as other required parameters (e.g., diffie-hellman keys, cryptographic algorithms, protocol) with the VPLMN (e.g., AMF/SEAF of VPLMN) so that a suitable NF in the VPLMN (e.g., UPF) can perform decryption of data, if required. Additinally or alternatively, in another variant, the AP may share data (the decrypted data at the AP before being further exchanged with the AF), with the VPLMN. This is feasible since the AP acts as middlebox used for LI at the HPLMN and sharing the data with the VPLMN.

Additionally or alternatively, the AP might be integrated with the UPF.

It is to be noted that if K_AF depends on K_SEAF, then the VPLMN can directly derive K_AF without help of the HPLMN as described in above embodiments. However, the HPLMN still needs to support the VPLMN with LI obligations by providing any other parameters required for decryption at the VPLMN.

For LI, all information required for decryption may need/needs to be exchanged or the decrypted data itself. This might include K_AF as well as any other keying materials (e.g., diffie-hellman keys), chosen security algorithms, etc.

It is to be noted, that an AP has additional benefits for LI since less information (e.g., less encryptin keys) need to be shared and interception itself might be simplified.

It accordance with above embodiment, it is proposed a method by which VPLMN which has Lawful Interception requirements, obtains access to the traffic exchanged between an UE it serves, and an AF which falls outside HPLMN and is served by an Authentication Proxy (AP), wherein the method comprises AP providing a NF in VPLMN (e.g., SEAF) with the key materials (e.g., K_AKMA, K_AF and other parameters). A NF in VPLMN (e.g., UPF) then decrypts the intercepted traffic exchanged between UE and AF. Alternatively, AP may decrypt the traffic exchanged between UE and AF, and forward it to VPLMN.

### Embodiment 41

In 3GPP, a new component, the network-controlled repeater is being developed. In 3GPP networks, a repeater is a device used to provide fill-in coverage of areas not well-served by a base station. In function, it is a simple, bi-directional amplifier that transfers uplink and downlink signals between one antenna, oriented towards the base station, and another, oriented to an area of poor coverage. An illustrative application scenario is the use of a repeater to extend outdoor coverage to an indoor location (O2I). In this scenario, a UE inside the building is prevented from establishing a direct link with a base station because of the materials used in the building's construction. To enable better service for UEs inside the building, a repeater can be used to transfer signals from outside to inside and vice versa. A repeater is simply an amplifier and does not otherwise modify signals passing through it. It is said to be transparent to traffic being transferred through it. Compared to more complex concepts, like Integrated Access and Backhaul (IAB), a repeater offers a simple and cost-effective solution for straightforward cases. A drawback of current repeaters is that the amplifiers are always in operation, even when there is no traffic to repeat. This can result in excess noise in the coverage area of a repeater because any in-band signal or noise that reaches the input of the downlink is repeated whether it is a valid signal or not. The base station can also suffer from similar issues on the uplink. In principle, the overall performance of a repeater installation could be improved if aspects of its behavior could be controlled by the base station. As a simple example, the amplifiers could be switched off unless there is a signal to be transferred. Since the base station is in complete charge of the scheduling of both uplink and downlink transmissions, it could switch the amplifiers on only when they are needed. In release 18, 3GPP began development of the network-controlled repeater (NCR), which operates in just such a way. As well as the forwarding module (NCR-Fwd), the NCR also comprises a Mobile Termination (NCR-MT) module that controls the NCR behavior under instruction from the gNB. The conceptual model is shown in FIG. 5-1 in TR 38.867 v1.0.0. Data traffic is transferred over the backhaul (gNB-NCR) and access (NCR-UE) links. Meanwhile, a control link is established between the gNB and the NCR-MT module, over which the gNB sends instructions to the NCR-MT on the desired repeater behaviour. Besides control of the amplifiers, the ability to control the repeater allows additional features like beam formation at the access antenna. Such features can be used to obtain further improvements in performance.

The NCR-MT generally behaves similarly to a UE in terms of the control-plane protocols used but uses new signalling to control repeater operation. Other aspects where the NCR-MT may differ from a UE are the NCR identification and authentication steps required when an NCR is first installed onto the network. A number of proposals are outlined in TR 38.867 v1.0.0 and these are briefly summarised here.

Proposals 3 (IAB-like, Clause 8.1.3 in TR 38.867 v1.0.0) and 4 (RedCap-like, Clause 8.1.4 in TR 38.867 v1.0.0) are similar to each other and to the procedure used for a conventional UE. The initial step of the NCR-MT establishing access to the gNB and NCR-MT follows the normal steps used by a UE. In proposal 3, during this process, the NCR-MT indicates that it is an NCR instead of a UE. In the next step, the network-based Access and Mobility Function (AMF) is used to authorise the NCR-MT as an NCR and establish link security.

These proposals have the advantage of using well-established protocols as a basis, modifying as necessary to support the NCR. They may also require modifications to the core network (the AMF), making deployment less straightforward than legacy repeaters.

In proposal 1 (Clause 8.1.1 in TR 38.867 v1.0.0), the AMF is used to establish link security but authorises the NCR as a UE-no modifications are therefore required to the core network. Any extra checks of NCR validity are performed instead by the gNB when the NCR supplies it with appropriate credentials.

Proposal 2 (Clause 8.1.2 in TR 38.867 v1.0.0) goes further by replacing the AMF with an OAM (Operations and Maintenance) module that is part of the radio access network (RAN) instead of the core network. Since link security has not been established by the CN, it needs to be established by the OAM if NCR control traffic is not to be sent in the clear. The proposal description suggests, “The security of OAM traffic can be provided by application layer security mechanism, such as SSH/TLS between the NCR and OAM.”

The following disclosures propose authentication and identification methods that prevent e.g. the impersonation of the NCR by a simple UE or prevent MitM attacks. These disclosures may apply to Proposal 2 in which no link security is established by the core network. They may also have some relevance to other methods where a secure link can be established but further validation of the NCR must be performed without the help of the network. Proposal 1 shows one possible process. It should also be noted that the methods disclosed are not limited to scenarios where the device to be connected to the network is an NCR and may be applicable in other situations where authentication and verification need to be performed without CN assistance.

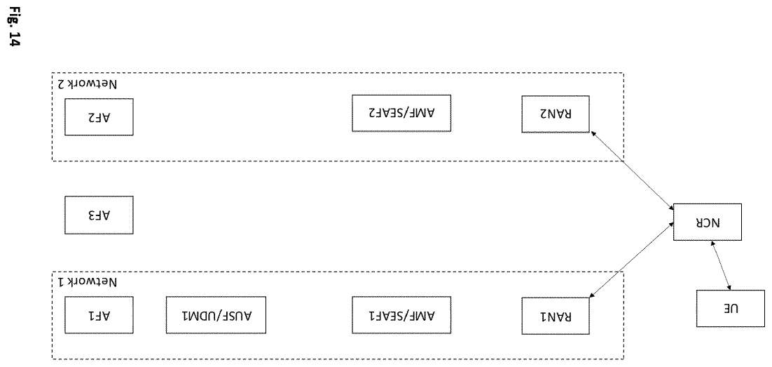

FIG. 14 describes a generic deployment in which the NCR is currently serving a single UE. The NCR might be owned by a first network (Network1). The NCR might connect through the RAN of the first or second network (Network2), namely RAN1 and RAN2. RAN might interact with the corresponding AMF/SEAF. A primary authentication of the NCR-MT is performed with the AUSF/UDM of Network1. A managing entity, e.g., an Application Function (AF) or OAM might manage the configurations of the NCR. This AF might be AF1 if located in Network1, AF2 if located in Network2, or AF3 if located somewhere else.

### Embodiment 42

In a first embodiment focusing on a simplified deployment of NCRs in which a single NCR connects to a single gNB, the NCR is owned and deployed by an operator in a fixed location to serve a specific gNB. For such an embodiment, security credentials could be preloaded at each side of the link, indexed at the gNB by an identifier shared by the NCR. These credentials could range from a complete set of security keys down to a shared secret from which all security keys can be derived. There are a variety of ways such credentials could be generated and shared. A simple example of a shared secret is the QR code or security PIN attached to a home Wi-Fi router. By entering this into a PC, phone or other device, both device and router have a shared secret that they can use to derive further security credentials in a secure manner using a protocol such as TLS.

### Embodiment 43

In further embodiments, the NCR becomes a network component with more flexible deployment opportunities. For example, in one class of embodiment, the NCR is owned and operated by an entity other than the network operator. For example, it could be owned by the owner of the building in the earlier example. In a further class of embodiment, the NCR is used to provide fill-in coverage for more than one network simultaneously—that is, it is shared by two or more networks. In such embodiments, it will not always be practicable to preload both sides with the necessary security information and an alternative method of securely establishing a shared secret is needed. A class of methods capable of doing this is based on public key encryption. These use asymmetric ciphers to exchange enough information to derive a shared secret. Since only the public keys are made available, any third party device without access to the corresponding private keys cannot derive the shared secret even if it manages to capture the whole exchange of messages between the first two parties. One well-known algorithm that uses this method is Diffie-Hellman key exchange.

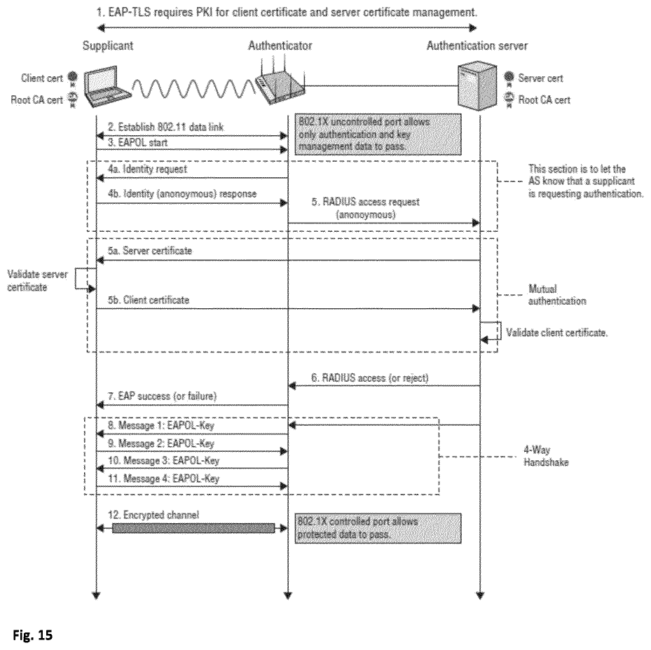

This embodiment relies on a security mechanism based on EAP-TLS (Extensible Authentication Protocol-Transport Layer Security). EAP-TLS is defined in RFC 5216 and forms the basis of WPA2 security used for Wi-Fi. A pictorial overview of the EAP-TLS process is shown in FIG. 15 (Reference: David D. Coleman, David A. Westcott, Bryan Harkins, “CWSP®: Certified Wireless Security Professional Study Guide CWSP-205: Certified Wireless Security Professional Study Guide CWSP-205”, Wiley, Second Edition, 16 Sep. 2016, DOI: 10.1002/9781119419341).

A device, the supplicant in EAP terminology, wanting access to a network, first establishes a data link with an authenticator and identifies itself to the authenticator. The authenticator informs an authentication server that the supplicant is requesting access and the authentication server then performs an exchange of certificates with the supplicant to provide mutual authentication. If this is successful, the authentication server informs the authenticator, and the authenticator then performs a 4-way handshake that securely establishes security keys on both sides of the link. Once this process completes successfully, supplicant and authenticator can establish a secure channel for data transport.

For the NCR scenario, the NCR performs the role of supplicant, the gNB the role of authenticator and the OAM the role of authentication server. This is a good fit because it allows the OAM to serve multiple gNBs comprising the radio access network, allowing the NCR some flexibility in deployment in scenarios where the OAM also has the role of informing the gNB of the NCR capabilities. To support operation across multiple RANs the OAM could be placed deeper in the network or alternatively, OAMs belonging to different RANs could be allowed to communicate with each and share information about NCRs. In FIG. 14, the RANs might communicate directly with one or more OAMs represented in FIG. 14 by AF1, AF2, and AF3.

Meanwhile, the gNB is in charge of the day-to-day operation of the NCR and can acquire the necessary configuration information from the OAM or from the NCR itself without needing to be preloaded with it.

Since EAP-TLS was developed for operation in WLANs, there may be some differences in detail between its implementation there and a similar mechanism adapted for operation in 5G. For example, the dialogue between gNB and OAM may use a protocol other than RADIUS. While EAP-TLS expects certificates based on X.509, other forms of certificate may be appropriate.

Other modifications may reflect differences in the perceived level of security required. For example, in WLAN environments, it is important that both sides can authenticate the other. In the case of the NCR, it is important that the RAN can authenticate the NCR but it may be considered not necessarily so important for the NCR to be able to authenticate the RAN because the rewards for gaining unauthorised access to an NCR are limited. In particular, user data is not decrypted by the NCR and so is not made available to a malicious user.

Some of these variations may also be reflected in other variations of EAP. Thus, although this description has been provided in the context of EAP-TLS, it should not be seen as limiting in this respect.

An authentication and authorization procedure, such as the above EAP-TLS procedure, might be in Step 7 in FIG. 8.1.2-1 in TR 38.867 v1.0.0. A successful authentication and authorization leads to message 8 in the same figure. This message might include a key K that has also been shared with the NCR (NCR-MT) based on the authentication and authorization procedure. Thus, subsequent control messages sent from the gNB to the NCR-MT can be secured. This key might be used to protect standard RRC messages enhanced with control fields specific to NCRs. Alternatively, this key might be used to protect specific L2 or even L1 messages, e.g., as shown in above embodiments.

The usage of such a key K in combination with RRC messages or L2 or L1 messages can used to protect the traffic in other embodiments.

### Embodiment 44

In a related embodiment, an NCR is securely configured with certain keying materials during manufacturing. The OAM might acquire certain NCRs from the manufacturer and the OAM might securely receive the preconfigured keying materials from the manufacturer. The preconfigured keying materials can be used in above (EAP-based) authentication and authorization procedure.

In a related embodiment, the keying material consists of at least one symmetric key.

In a related embodiment, the keying material is stored in the USIM for the NCR mobile terminal.

### Embodiment 45

In current solutions in TR 38.867 v1.0.0, the NCR-MT exposes its capabilities before any security context has been established. And thus, these security capabilities maybe modified. For instance, they expose an NCR indication info in the RRCSetupComplete message. Although some solutions such as Solution 1 include an NCR validation phase once AS security has been established (Steps 12 and 13 in FIG. 8.1.1-1 in TR 38.867 v1.0.0), other solutions do not. Thus, it would be beneficial if those parameters—that need to be exchanged an early stage, e.g., in the RRCSetupComplete—can be protected at that stage already, e.g., as done in above embodiments with the UE security capabilities.

### Embodiment 46

In Solution 1, the gNB can perform an additional NCR validation. This can be done by checking whether the NCR indication received in the RRCSetupComplete matches the information locally stored at the gNB. However, it is not described how this information might be configured. In a first alternative, the NCR might serve as a wireless repeater for a gNB working in non-standalone (NSA) mode. In this case, the UE part of the NCR, e.g., in Solution 1, might perform an authentication procedure with the LTE core network. Once the UE part of the NCR is authenticated, the LTE CN can verify the user subscription of the UE and inform the eNB of the result. If successful, the UE part of the NCR can arrange to hand over to an NCR-capable gNB and perform additional NCR validation. In this way, an NCR can be used on an NSA network without change to the LTE CN.

### Embodiment 47

Solutions such as Solution 3 and 4 state that the AMF and other CN entities do further authorization, and it states that the AMF then provides “NCR authorized” to the gNB. However, how this is done is not described. A further embodiment achieving this/describing how, e.g., in the context of Solution 3, is as follows: once the gNB sends the INITIAL UE MESSAGE including the NCR Indication Info to the AMF in message 9 in FIG. 8.1.3-1 in TR 38.867 v1.0.0, the AMF has to forward said information to the AUSF. The AUSF then will retrieve the SUPI of the NCR-MT and retrieve data associated to the SUPI (NCR-MT) regarding its capabilities. The AUSF can retrieve the data, e.g., from or interacting with UDM, UDR, or PCF, or other network function. If those capabilities do not match, then the AUSF may decide to stop the authentication process.

### Embodiment 48

In a related embodiment, the UE part of the NCR might perform the primary authentication procedure first, and if successful, the AMF might retrieve from the AUSF/UDR the user subscription capabilities of the associated UE, and check whether the UE is an NCR as claimed in the received NCR indication. If it is, then the AMF provides the “NCR authorized” indication to the gNB.

### Embodiment 49

Solutions such as Solution 3 and 4 state that the AMF and other CN entities do further authorization, to this end, in an additional embodiment is required that the gNB chooses an NCR-capable AMF.

### Embodiment 50

When authenticating with an NSA network, the UE part of the NCR, e.g., in Solution 3 or Solution 4, might perform an authentication procedure with the LTE core network. Once the UE part of the NCR is authenticated, the LTE CN can verify the user subscription of the UE and verify whether it is an NCR or not. If it is, the LTE CN will inform the gNB, e.g., through the eNB, and the gNB can store the capabilities of the UE part of the NCR. Once this is done, the UE part of the NCR may send a secure message, e.g., RRCSetupComplete, indicating its capabilities. The gNB may then validate these capabilities with the ones previously received. In this way, the LTE CN performs the necessary NCR authentication but day-by-day operation of the NCR becomes the responsibility of the 5G gNB.

### Embodiment 51

Another further embodiment addressing the need in other embodiments consists in protecting the initial NCR Indication Info as described in above embodiments, e.g., by means of the primary authentication procedure or protecting it with the public-key of the home network.

### Embodiment 52

An external AF might be in charge of at least a partial management of the NCR. For instance, if the NCR is deployed in a private building, the building owner might wish to determine when the NCR(s) in the buidling are active, which areas require further coverage, etc. This external AF might manage settings in the NCRs by using AKMA as in TS 33.535 wherein the AF can make use of AKMA derived keys to setup a secure channel protected with an Ua* protocol to configure certain parameters in the NCR. This is also applicable in situations in which the NCR-MT is roaming as described in above embodiments.

### Embodiment 53

Another further embodiment applicable to above solutions consist in configuring the UE, i.e., NCR-MT, with an authorization token, e.g., a set of properties associated to the UE, e.g., the fact that a UE is an NCR-MT. This configuration might be done in the NCR-MT before deployment or it might be securely sent to the NCR-MT once the NCR-MT has successfully completed an authentication and authorization step as in Embodiment 5c. The next time that the the NCR-MT attempts to join another gNB, the NCR-MT might share such a token with the gNB so that the gNB or a network function in the CN can verify its authorization.

### Embodiment 54

In another further embodiment, once an NCR has been authenticated and authorized, e.g., as described in above embodiments, the NCR might send or receive its configurations and capabilities. Configurations might refer to configurations as in Clause 7.2 in TR 38.867 and may include one or more configurations of PHY channels to carry the L1/L2 signaling including the configurations for receiving PDCCH and PDSCH, for transmitting PUCCH, if needed, or for transmitting PUSCH, if needed, as well as, the configurations of L1/L2 signaling including the configurations for DCI, UCI, if needed, and for MAC CE, if needed. The capabilities might include parameters as in the following table. One or more of those parameters may be exchanged and stored:

Physical attributes

Location

Latitude
Longitude
Antenna height above ground

Location source

GPS/5G network/manual entry during
installation

Mobility status

Fixed/mobile
Current velocity

RF capabilities

Repeater operating band(s)

Active bandwidth parts

Control link operating band

Active bandwidth part

Antenna capabilities: Access link

Fixed/adaptive
Fixed/default beam settings

Antenna capabilities: Backhaul/control link

Fixed/adaptive
Fixed/default beam settings

Amplifier capabilities

Power up/down times
Latency
Gain settings
Default gain

Logs

Usage statistics

Total amplifier ON time per hour/day/week
ON/OFF event statistics
Antenna beam statistics

Location statistics

Movement tracking

Operator statistics

Usage per operator

Fault indications

Amplifier fault
Antenna fault
Operational fault

Feedback in uplink/downlink channel

### Embodiment 54

The above management solutions may coexist, and in this case, it may be required to move/roam/export/import the NCR data from a management system to another management system. For instance, in Solution 2 the OAM may store information about the deployed NCRs, their capabilities/configurations, cryptographic keys, authorization status, etc. When one or more NCRs need to be migrated to a different solution, e.g., Solution 3, then the data needs to be exchanged and stored in the corresponding entity, e.g., a network function in the core network as it maybe the AMF, UDM, UDR, etc. This data maybe exchanged over the NEF.

### Embodiment 55

Once an NCR is authenticated and authorized, the gNB needs to be configured with one or multiple of above NCR capabilities. This can be used by the gNB to determine how to connect to NCR and optimize the control or forward links.

In an embodiment, if gNB and NCR-MT share one or multiple keys, the gNB might request specific parameters, e.g., by means of an RRC message, or the NCR-MT might securely and proactively send those parameters to the gNB, e.g., also in an RRC message.

In a further embodiment, if the NCR-MT and gNB do not share a common secret, then the gNB might request the managing entity (e.g., an AF or the AMF) said NCR capabilities. The managing entity might also securely and proactively send those parameters to the gNB. For instance, in the context of above embodiments, the managing entity (AF) may receive said NCR capabilities from the NCR during the authentication/authorization process. The managing entity (AF) might also retrieve them from, e.g., a database, once the NCR is authenticated. Upon authentication and authorization, the managing entity may share one or more of those NCR capabilities with the gNB.

### Embodiment 56

Above embodiments, e.g., related to NCRs, may also be applicable to mobile base station relays (MBSR) or vehicle mounted relays whose service requirements have been studied in TR 22.839 and are specified in TS 22.261. An MBSR refers to a mobile base station (e.g., a mobile IAB node) mounted on, e.g., a vehicle such as a bus, drone, or satellite. An MBSR may move around and provide enhanced connectivity when/where required. The MBSR can be owned by a third party or can roam to a network the MBSR is not a subscriber of. This is different from the existing IAB architecture where the IAB node is assumed to be owned and operated by the same PLMN the IAB Node has a subscription with.

### Embodiment 57

In a scenario, the UE part of the MBSR (equivalent to the IAB-MT in IAB) might register in the network e.g., HPLMN as usual (e.g., by means of primary authentication) over a gNB managed by the VPLMN. The VPLMN might be seeking the services of the MBSR. A problem arising from this situation is how to allow the VPLMN to make use of the MBSR. This relates to the authorization by the HPLMN or MBSR owner allowing the VLPLMN to use said MBSR.

In an embodiment, the UE part of the MBSR might indicate in the UE capabilities (e.g., exchanged in an RRC message or in a registration message) the fact that it is an MBSR so that the network (e.g., VPLMN) is aware of this fact.

In an embodiment, the gNB or a NF in the network (e.g., VPLMN) might learn the fact that the UE part that is registering is part of an MBSR. This might also require the gNB to send a message to the CN or to the VPLMN OAM informing about this fact and/or sending a message to the entity in charge of the MBSR (e.g., HPLMN, or a third party, or the OAM in the HPLMN) requesting the usage of the MBSR.

In an embodiment, a network (e.g., VPLMN) may need additional resources and may send a request to an MBSR owner with its requirements (e.g., location where additional connectivity is required, type of services, etc). The network may send a request to a NF (e.g., AMF) and/or RAN indicating that new MBSR units may join/register the network.

In an embodiment, the AMF in the network (e.g., VPLMN) may use a message (e.g., a NAS message) to provide the MBSR with credentials used to connect to the network (e.g., VPLMN) OAM so that the MBSR can retrieve configuration parameters for the network (e.g., VPLMN), e.g., which PCI is allocated, beam configurations, etc.

In an embodiment, the AMF (or other NF) in the network (e.g., VPLMN) may use a NAS message to provide the MBSR with MBSR configuration parameters for the network (e.g., VPLMN), e.g., which PCI is allocated to the MBSR, MBSR beam configurations, etc. The AMF might get this information from the VPLMN OAM.

In an embodiment, the gNB-Central Unit (CU) in the network might use a configuration message to provide the MBSR with MBSR configuration parameters for the network (e.g., VPLMN), e.g., which PCI is allocated to the MBSR, MBSR beam configurations, etc. The gNB-CU might get this information from the network OAM.

In a related embodiment, the network (e.g., VPLMN (e.g., AMF)) may send a request to the HPLMN (e.g., AMF or NF or function in charge of managing the MBSR) or AF (in charge of the MBSR) to use/terminate/modify the services of the MBSR.

In a related embodiment, the above request to the HPLMN or AF may include the required services required from the MBSR. This might include the location where the services are required, or the timing, etc.

In an embodiment, the MBSR will only accept said security credentials/configuration parameters if the MBSR has received a positive confirmation from the HPLMN or AF in charge of the MBSR or MBSR owner to serve the network. This confirmation might be based on a protected (e.g., integrity protected message) that is sent from the HPLMN/AF to the UE, end-to-end protected.

In a related embodiment, the protected message may include a configuration with details for the MBSR stating which services may be provided to the network (e.g., VPLMN) by the MBSR.

In a related embodiment, this protected message might be end-to-end protected from HPLMN to UE by means of UE Parameters Update (UPU) as per TS 33.501, Clause 6.15.2.1.

In a related embodiment, the MBSR might belong to a third party that manages the MBSR by means of an AF that connects to the MBSR by means of AKMA. In a related embodiment, the protected message is exchanged between AF and MBSR over the Ua* interface.

In a related embodiment, a NF in the VPLMN might contact the AF or a NF in HPLMN so that this latter transmits said confirmation/configuration parameters message as well as other configuration parameters to the MBSR.

In a related embodiment, the MBSR belongs to a third party and the MBSR and the third party authenticate by means of secondary authentication, and configuration parameters are securely exchanged through the EAP connection once secondary authentication has succeeded.

In a related embodiment, the MBSR is configured with authorization tokens securely provided by the entity managing the MBSR. The MBSR may also be configured with a policy determining the (type of) network that the MBSR is supposed to access and provide connectivity services to.

In a related embodiment, the MBSR may be configured with unique authorization tokens and/or share authorization tokens with other MBSRs. The MBSR may also be configured with a unique policy or share the same policy, which determines the (type of) network that it is supposed to access and provide connectivity services to, with other MBSRs.

In a related embodiment, the MBSR sends an authorization token to the network so that the network can verify the credentials/authorization rights to provide an MBSR service to the network. The entity checking said credentials may be, e.g., the gNB-CU or the AMF.

In a related embodiment, the third party managing the MBSRs provides the network willing to use MBSRs with authorization tokens. The authorization tokens determine the access rights (services) that the network requires from the MBSR whose services are requested when the authorization token is disclosed to the MBSR. In this way, the network might acquire/purchase a number of authorization tokens and use them on demand.

In a related embodiment, the MBSR may need to send the “used” tokens to the third party so that the “used” tokens are marked as used. The “used” tokens may be stored in a list of “used” (or revoked) tokens that is shared with all MBSRs so that the MBSRs can check whether the received tokens are/remain valid.

In a related embodiment, the tokens may have a short life, I.e., only be valid for a short period of time so that a revocation list is not required.

In a related embodiment, the MBSR and network exchange the authorization token over a secure interface, e.g., in an RRC message or through the F1-C interface or in a NAS message.

In a related embodiment, the network might send a (protected) confirmation (e.g., an authorization token) confirming that the service is being provided by the MBSR. This confirmation may be shared with the MBSR owner for billing purposes.

Above embodiments may be combined with each other as applicable.

In above embodiments related to smart repeaters and MBSRs may apply in general to other types of network access devices such as smart repeaters, MBSRs, Unmanned Aerial Vehicles (UAVs), Satellites, Reflective Intelligent Surfaces, etc.

In general, it is described a method and apparatus that can be implemented on a (mobile) network access device for handling the authorization to serve a network whereby the apparatus
is configured with a policy determining the conditions under which it can connect to a network and access tokens to connect to the network,
setups a (secure) connection with the network when the conditions,
Sends an access token with the network to prove its authorization.
May receive an authorization token from the network to prove the service provisioning for billing purposes.

### Embodiment 58

TR 33.870, v 0.4.0. studies the privacy of identifiers exchanged over the radio access network. An issue in this TR is Key Issue #2 and relates to the fact that the “priority access” value exchanged in the initial random-access procedure is not protected, in other words, the 5G standard allows the use of establishment cause like “highPriorityAccess”, “mps-PriorityAccess”, “mcs-PriorityAccess” is sent in clear over the air.

A potential solution to this problem includes the following steps:
1. UE performing the Random-access procedure with a base station as usual including a “random value” in message 3 where the base station is in the serving/home network.
2. UE performing primary authentication with the home network through the serving network.
3. Once NAS security context is established, distributing a public-key/private key pair to UE and gNB from the HN. This key pair might be the key pair of the serving network. This configuration might also be pre-configured.
4. Once the AS security has been established, the UE moves to RRC_Connected state.
5. When the UE moves to RRC_idle or RRC_INACTIVE state, and then the UE has to perform again the connection establishment (by means of a new random-access procedure, e.g., a 4-message random access procedure)
   a. UE sends the initial preamble
   b. gNB replies with random access response
   c. UE uses the public key of step 3 to encrypt, e.g., the 5G-S-TMSI-part1 or I-RNTI with establishment or resume cause (“priority access”) and sends this to the gNB.
   d. gNB uses the private key in Step 3 to decrypt the message replying with message 4, RRCSetup.
   e. UE finishes procedure sending the RRCSetupComplete and moving to RRC_Connected state.

Steps 1-4 can be considered as a configuration step and Step 5 as the operational phase in which security assurances can be given to the privacy of the establishment cause (“priority access”).

Problems of above approach include the following:
Public keys are long and public key operations are expensive, so that it would be more efficient to try to replace those long keys/expensive operations by more simple ones when feasible;
Encrypted values with public keys are bulky and might not fit in message 3;
It requires configuring the private key of the serving network in the gNBs that poses a security risk.

Thus, in an embodiment, step 3 is replaced by sharing a symmetric-key and/or a one-time pad and/or identifier (of the key/one time pad) that can be used by the UE to protect step 5c-d.

In an embodiment that can be combined with other embodiments, step 5d is enhanced by means of a request to the AMF (or other NF in the serving network such as the UDM) to decrypt the received message using the private key of the serving network so that the gNB does not need to be configured with the private key of the serving network.

In an embodiment that can be combined with other embodiments, step 3 is replaced by a public key pair that is specific for the gNB so that the gNB does not need to be configured with the private key of the serving network.

In a further embodiment that can be combined with other embodiments, the UE uses the key or the one-time pad to encrypt the message and send the encrypted message in Step 5c.

In a further embodiment that can be combined with other embodiments, the gNB uses the key or the one-time pad to decrypt the message and send the encrypted message in Step 5d.

In a further embodiment that can be combined with other embodiments, the message is encrypted using the key with a NEA algorithm where the plain text input is the part of the message that requires protection and the provided key is used as encryption key.

In a further embodiment, the provided key is derived from K_gNB by means of a key derivation function.

In a further embodiment that can be combined with other embodiments, the message is encrypted using the key with a NEA algorithm where the other inputs include a counter value that depends on the UTC time.

In a further embodiment that can be combined with other embodiments, the message is encrypted by xoring the message fields to be protected with the received one-time pad.

In a further embodiment that can be combined with other embodiments, the one-time pad key may be extracted from a key (e.g., KgNB) or a key derived from it by means of a key derivation function.

In a further embodiment that can be combined with other embodiments, gNB may randomly select and send (e.g., in step 5b) an index that determines the position (e.g., in KgNB) from which the UE should extract the one-time pad key to encrypt the RRC Resume cause.

In a further embodiment that may be combined with other embodiments, gNB and UE may use the first k bits from or a key derived from KgNB, by means of a KDF, to encrypt (e.g., on UE's side) and decrypt (e.g., on gNB's side) the RRC Resume cause. This has the advantage of not having to communicate an index and/or key identifier to UE. The gNB retrieves the correct KgNB from UE's security context based on its identity (e.g., full/short I-RNTI) that is included in the RRCResumeRequest.

In a further embodiment that can be combined with other embodiments, the message fields to be protected may include: 5G-S-TMSI-part1 or establishment cause (“priority access”)

In a further embodiment that can be combined with other embodiments, the message is encrypted by xoring the message to be protected with the output of a key derivation function whose inputs may include the provided key or a UTC-based counter (as used e.g., in TS 33.503) or other fields in the message.

In a further embodiment that can be combined with other embodiments, the encryption parameters (symmetric key/one time pad) are stored in the gNB or in a NF (e.g., AMF) including an identifier.

In a further embodiment that can be combined with other embodiments, the message includes an identifier that allows the gNB to determine the key or one-time pad to be used in decryption.

In a further embodiment that can be combined with other embodiments, the encrypted message includes an identifier (encrypted or in clear) that allows the gNB to determine the key or one-time pad to be used in decryption.

In a further embodiment that can be combined with other embodiments, if a gNB does not store the key/one time pad required to decrypt an incoming message 3, the gNB might look it up in a different gNB (e.g., a close gNB) or in the AMF.

In a further embodiment that can be combined with other embodiments, a gNB may include in the random access response (message 2) a key identifier that UE uses to select the key/one time pad required to encrypt message 3 in step 5-c.

In a further embodiment that can be combined with other embodiments, look up the key/one time pad might require sending a request including the identifier of said one time pad or key.

In a further embodiment that can be combined with other embodiments, the encrypted message consists of 48 bits where: k bits may be for the identifier used to identify the key or one-time pad, t bits are the encrypted message, and 48-k-t are other information (e.g., random data and/or UTC-based counter).

In a further embodiment that can be combined with other embodiments, an identifier field is not included in message 3, e.g., if there is a single symmetric key or a single private key in the serving network.

In a further embodiment that can be combined with the previous embodiment, the concatenation of the fields serves as “random value” in message 3.

In an embodiment that can be combined with other embodiments, the UE may attempt to perform the encryption of Step 5c using the symmetric-key or one time pad, and if the gNB cannot decrypt, the gNB signals this fact in message 4 (step 5d). The gNB might not be able to decrypt it if, e.g., the UE moved to a different gNB that is not aware of the preconfigured key/one time pad or if the gNB does not store those parameters anymore.

In an embodiment that can be combined with the previous embodiments, if the UE received message 4 indicating that message 3 encrypted with a symmetric key/one time pad cannot be decrypted, the UE may attempt to perform Step 5c again using the public key of the serving network to encrypt the privacy sensitive parameters in Step 5c.

Thus, in accordance with this embodiment, it is proposed a method of securely performing a random-access procedure between a User Equipment, UE, and a base station (or access device) in a wireless network, wherein the method comprises receiving a cryptographic key K linked to the access device and the UE; determining or receiving a L-bit sequence s; and encrypting s with K into V; and sending V.

Thus, in accordance with this embodiment, it is proposed a method that further comprises receiving a public key associated to the access device or the serving network.

Thus, in accordance with this embodiment, it is proposed an apparatus for securely performing a random-access procedure wherein the apparatus comprises a transceiver and a control unit, the apparatus arranged to receive a cryptographic key linked to the access device and the UE; determine or receive an L-bit sequence s; and encrypt s with K into V; and send V.

Thus, in accordance with this embodiment, it is proposed a method of securely performing a random-access procedure between a User Equipment, UE, and a base station (or access device) in a wireless network, wherein the method comprises receiving an encrypted message, retrieving a cryptographic key, decrypting the message.

The techniques in different embodiments may be combined with each other.

### Embodiment 58

A potential solution to KI #2 in TR 33.870, which protects the privacy of RRC resume cause may assume that the UE has established an AS security context while in RRC_CONNECTED state prior to transitioning into RRC_INACTIVE state. The UE may indicate to the network whether it supports encryption of the resumeCause and also its capabilities such as, the supported encryption algorithm and the encryption key. This symmetric key may be part of the AS security context of the UE. The encryption may be length-preserving i.e., the length of the bit string representing the resumeCause in plaintext remains the same for the bit string of the encrypted resumeCause.

At the UE side, the solution may use a RRCRelease message sent by the network to inform the UE which key and encryption algorithm to use to encrypt the resumeCause in the successive RRCResumeRequest messages when UE is transitioning from RRC_INACTIVE state to RRC_CONNECTED state by sending RRCResumeRequest.

At the network side, the gNB/ng-eNB uses I-RNTI sent by UE in the RRCResumeRequest message to retrieve the UE context and cryptographic key needed to decrypt the resumeCause. The decryption may be done by the source or the target gNB/ng-eNB.

The following embodiments may be applicable to further improve the security of the scheme.

In a first embodiment, the algorithm and/or key to be used is determined by a policy that may be configured in an initial configuration or on demand. This has the advantage of not requiring the indication of the encryption algorithm and/or key in the RRCRelease message, and no changes are required.

In a second embodiment, the algorithm and/or key to be used is determined and indicated by the UE since not all UEs may have the same capabilities or preferences. This has the advantage of better accommodating UEs with different security preferences.

In a further embodiment, the network may send a message such as the RRCRelease message to inform the UE which key, encryption algorithm and parameters to use to encrypt the resumeCause in the successive RRCResumeRequest messages. For instance, if the UE has to use a NR Encryption Algorithm (NEA) algorithm, it also requires some additional configuration parameters (Counter, Bearer, . . . ) that need to be known to both parties.

In a further embodiment, a UE with capabilities to protect the resumeCause may indicate the fact that the resumeCause is protected so that a gNB can determine whether it is protected or not, and handle it accordingly. This embodiment has the advantage of ensuring backwards compatibility.

In a further embodiment, a UE with capabilities to protect the resumeCause may only protect the resumeCause if the gNB has indicated, e.g., in SIB1, that it can handle protected resumeCause fields. This embodiment has the advantage of ensuring backwards compatibility.

In a further embodiment, the symmetric key may be computed as follows:

When deriving a symmetric key K to protect the resumeCause, one or more of the following parameters may be used to form the input to a KDF used to derive the key:
An identifier, e.g., I-RNTI (short or full-I-RNTI depending on whether the field useFullResumeID is present in SIB1),
The length of the identifier, e.g., length of I-RNTI,
A time counter, e.g., a UTC based counter,
A nonce determined by the gNB,
A nonce determined by the UE.
   The KDF input key may be, e.g., the key KgNB Or KRCEnc established prior to the UE switching into an RRC_INACTIVE state.

In a further embodiment, the bitsequence used to protect the resumeCause is determined and used according to one or more of the following variants:
In a variant, if b bits need to be protected, then b bits of a key are used as bitsequence.
In a variant, the protection is performed by XORing the b bits that need to be protected (e.g., resumeCause) with the bitsequence.
In a variant, regardless of whether the UE uses RRCResumeRequest or RRCResumeRequest1 (depending on useFullResumeID field presence in SIB1), the resumeCause is always four bits (b=4) long. As such, if a one-time pad mechanism is used to protect the resumeCause, the bitsequence used as a one-time pad key could be the, e.g., first, or last b (e.g., b=4) bits, or any subset of b (=4) bits of the symmetric key K derived from K_gNB as described in the previous embodiment.
In a variant, gNB may determine (e.g., at random) an index from which UE should extract the b (e.g., b=4) bits long bitsequence and send it to UE as part of the suspendConf parameter of the RRCRelease message. In this case, gNB may need to save the index within UE's context if, e.g., the index is UE specific.
In a variant, gNB may determine (e.g., randomly) the index from which UE should extract the b (e.g., b=4) bits long bitsequence and send it to UE as part of the random-access procedure message 2 (i.e., random access response), or in SIB1. This has the advantage of gNB not having to save the index for a longer period.
In a variant, the (derived) key is used in a NEA algorithm to protect the ResumeCause where the counter field may be a time-based counter. Thus, the NEA algorithm is used to generate the bitsequence and use it to protect the resumeCause.

In a further embodiment, if a nonce (or more than a nonce) is used in the derivation of the key or in the process of protecting the information, resumeCause, then the gNB may include a randomly generated nonce in the suspendConf parameter of the RRCRelease message, which the UE uses, e.g., as a parameter of the KDF to derive K. Additionally or alternatively, the UE may include this nonce in its message to the gNB. The nonce maybe the 5G-S-TMSI-part1, or part of it. In other words, the nonce(s) may be explicit new fields or implicitly transmitted nonces reusing existing fields.

In a further embodiment, if a UTC-based counter is used in the derivation of the key or in the process of protecting the information, resumeCause, the least significant bits of the counter may be included in a message, either from the gNB to the UE or from the UE to the gNB. The techniques in different embodiments may be combined with each other.

### Embodiment 60

Another potential solution to the problem described in the previous embodiments can be described as follows:

During the access control check procedure (specified in subclause 4.5.4 of TS 24.501), the UE determines whether the network is overloaded or not based on the NG-RAN's broadcasted barring control information. Specifically, if the barring control information is broadcasted by NG-RAN, the UE considers the network overloaded, if the barring control information is not broadcasted, the UE considers that the network is not overloaded.

For UEs with RRC establishment cause value “mps-PriorityAccess” and “mcs-PriorityAccess”, the value of the reported RRC establishment cause is determined by the following rules:
If the network is not overloaded (i.e. barring control information is not broadcasted), the UE hides its high-priority attribute, and the reported RRC re-establishment cause is determined according to the access category of the UE. If the UE is rejected after the RRCSetupRequest, the UE reports its high-priority access cause value (“mps-PriorityAccess” and “mcs-PriorityAccess”) in the next RRC connection request message.
If the network is overloaded (i.e. barring control information is broadcasted), the high-priority access cause value “mps-PriorityAccess” and “mcs-PriorityAccess” are directly used as in the current mechanism.

For UEs with establishment cause “highPriorityAccess”, the reported RRC establishment cause is determined according to the access category of the UE instead of “highPriorityAccess”.

This approach requires several considerations:

In first place, the establishment cause “highPriorityAccess” is not considered by the solution i.e., when UE indicates “highPriorityAccess”, it is proposed to have the establishment cause determined based on the UE's access category instead of using “highPriorityAccess”. However, according to clause 8.7.7 in TS 38.413, if AMF is in an overload state, it may request from NG-RAN to reduce signaling load towards it and only permit certain RRC connection establishments, such as the ones for high priority sessions and mobile terminated services (i.e., only permit traffic corresponding to RRC cause ““highPriorityAcces””, ““mps-PriorityAcces””, ““mcs-PriorityAcces”” and ““mt-Acces”” in TS 38.331 or ““highPriorityAcces””, ““mo-ExceptionDat”” and ““mt-Acces”” in TS 36.331). Hence, the solution misses covering the establishment cause “highPriorityAccess”. Furthermore, the paragraph describing which establishment causes are handled by gNB in clause 7.4 of TS 38.300 reads as follows:

“The gNB handles access attempts with establishment causes” “emergenc””, ““mps-PriorityAcces”” and ““mcs-PriorityAcces”” (i.e. Emergency calls, MPS, MCS subscribers) with high priority and responds with RRC Reject to these access attempts only in extreme network load conditions that may threaten the gNB stability.” This does not align with TS 38.413, as AMF may indicate to NG-RAN that it is overloaded, in which case, it would be expecting the establishment cause “highPriorityAccess” to be handled by NG-RAN. This is in conflict with above solution because based on it, for uEs with establishment cause “highPriorityAccess”, the reported RRC establishment cause is determined according to the access category of the UE instead of “highPriorityAccess”.

Thus, in a first embodiment addressing this problem, the gNB may indicate by means of a message, e.g., in SIB1, whether the AMF is overloaded. This has the advantage of allowing a UE to choose whether to use its normal UE access category (if AMF is not overloaded) or to use “highPriorityAccess” access of AMF is overloaded. This means that in a normal situation, the access cause is not disclosed, only when the AMF is overloaded. This embodiment has the advantage of reducing the privacy risk in a pragmatic way, i.e., the privacy risk may only arise if the AMF is overloaded.

In a further embodiment addressing this problem, UEs with establishment cause “highPriorityAccess” may use as access category the access category of the UE. If the UE is rejected after the RRCSetupRequest, the UE reports its high-priority access cause value (“highPriorityAccess”) in the next RRC connection request message. This means that in a normal situation, the access cause is not disclosed, only when the UE is rejected (e.g., because the AMF is overloaded), the access cause is disclosed. This embodiment reduces the privacy risk in a pragmatic way.

In a further embodiment, an overloaded AMF may set a policy in a gNB to only handle access attempts with establishment causes ““emergency””, ““mps-PriorityAcces”” and ““mcs-PriorityAcces”” and not “highPriorityAccess”. This has the advantage of ensuring consistency in the configured policies and limiting the possibility of misusing the “highPriorityAccess” cause value, e.g., for a DoS attack.

Another issue with the solution is: when the UE reports its high-priority access cause value in the establishment cause (e.g., if the network is not overloaded and UE is rejected after the RRCSetupRequest, or if the network is overloaded), it does so without any form of protection. As such, an attacker (e.g., Man-in-The-Middle attacker) can employ a fake base station to broadcast barring control information or indicate (e.g., via SIB1) that AMF is overloaded, in which case, the victim UE would report its high priority access cause value in clear text in the RRCSetupRequest.

In an embodiment that aims to address the issues above, if a security context, e.g., an AS security context, is available or can be established and the UE has to report its resumeCause (e.g., high priority access cause e.g., because the network is overloaded), then the UE may protect the RRC establishment/resume cause, e.g., using (an existing) symmetric key (e.g., K_gNB) or a key derived from it e.g., by means of a key derivation function.

In a related embodiment that aims at further minimizing the privacy risk priority access cause, the UE may protect the RRC establishment/resume cause with a symmetric key (e.g., K_gNB) or a key derived from it (e.g., by means of a key derivation function), regardless of whether it is required to communicate the high priority access cause value (e.g., due to AMF being overloaded) or not. This has the advantage of not implicitly leaking that the protected part of the message concerns a high priority access cause.

In a related embodiment that aims at further minimizing the privacy risk priority access cause while optimizing performance, the UE may be required to protect the RRC establishment/resume cause if the apparatus has first rejected first message from the apparatus and/or the second device has indicated an overloaded AMF.

In a related embodiment, the gNB may use the UE identity (e.g., I-RNTI) included in the RRCResumeRequest to identify the gNB hosting the UE's security context, and thus retrieve the corresponding keying material, e.g., K_{gNB} Or K_{RRCEnc}, if needed.

In another embodiment, the UE may protect the RRC Establishment/Resume cause by means of a One-time pad mechanism using a subset of a symmetric key (e.g., K_gNB) or a key derived from it (e.g., by means of a key derivation function).

In another embodiment, the cryptographic key used to protect the RRC establishment or resume cause may be K_{RRCenc} or a key derived from it (e.g., by means of a key derivation function).

In another embodiment, the UE may use a (pre-configured) public key (e.g., distributed to UE when the NAS security context is established) to encrypt the RRC Establishment/Resume cause or the whole RRCSetupRequest/RRCResumeRequest message. In such case, the gNB uses the private key associated with the public key used for encryption, to decrypt the RRC Establishment/Resume cause or RRCSetupRequest/RRCResumeRequest message.

In another embodiment, the asymmetric key may be ID based such that a central party (e.g., a NF) is capable of computing the private key associated with the ID. UEs may determine the public key to protect the RRCResume cause protection based on public parameters shared by the central party while UE is in RRC_CONNECTED state, as part of the suspendConf parameter of the RRCRelease message, or through e.g., SIB1 broadcasted by gNB. When gNB receives the RRCResumeRequest, it forwards the UE identity (e.g., I-RNTI), used to derive the public key, to the central party in order to request/retrieve the corresponding private key. gNB uses the provided private key to retrieve the protected resume cause.

In a related embodiment, the information to be used as ID to derive the public key may be explicitly broadcasted by gNB as part of SIB1. As such, UE may protect the whole RRCSetupRequest or RRCResumeRequest/RRCResumeRequest1, including UE identity (e.g., 5G-S-TMSI-Part1 or I-RNTI) and establishment or resume cause, with the derived public key. If gNB does not already have the private key, it requests/retrieves the private key from the relevant central party.

In another related embodiment, the gNB may indicate in a message, e.g., the Random Access Response, a (key) identifier and/or index that UE may use to select and/or determine the key to use for RRC Establishment/Resume cause or RRCSetupRequest/RRCResumeRequest protection.

In another embodiment, when transitioning from RRC_INACTIVE to RRC_ACTIVE, the UE sends an RRCResumeRequest (or RRCResumeRequest1), with a protected resumeCause, to a gNB; this latter uses I-RNTI to resolve the gNB ID of the gNB that allocated the UE context. However, according to clause 9.2.2.4.1 in TS 38.300, gNB might fail in retrieving or verifying UE context, in which case, it performs a fallback to establish a new RRC connection by sending RRCSetup to UE. An alternative approach may be to send an RRCReject to UE with a failure cause (e.g., failure to resolve gNB ID) and request UE to send an RRCResumeRequest1 with full-I-RNTI instead.

In a related embodiment that may be combined with the previous embodiment, gNB may send an RRCReject to UE with a failure cause (e.g., failure to resolve gNB ID) and request UE to use an alternative approach, e.g., based on a (pre-)configured public key, to protect the RRCResumeRequest. gNB may include in the RRCReject message an identifier or part of it to indicate to UE which approach to use, e.g., which public key to use.

In a related embodiment, the usage of encryption/protection of a field such as the resumeCause may require the usage of a long I-RNTI. This can be advantageous to retrieve the correct security context. This also means that if a field is/needs to be encrypted, then a long I-RNTI is used. If the field is not protected, then a short I-RNTI is used. This may be determined by means of a policy. In another embodiment, the RRCResumeRequest may not fail due to gNB resolving the old gNB ID, but due to failure to verify the UE context (e.g., gNB might retrieve the UE context, but the decryption of the resumeCause fails). In such case, gNB may send an RRCReject to UE with a failure cause (e.g., failure to verify UE context), and request UE to use a (pre-)configured public key to retry resuming the RRC connection again.

In a related embodiment, the gNB may determine that the decryption has failed if, e.g.:
The decrypted field (e.g., resumeCause) is not valid, and/or
A CRC fails, and/or
A MIC is available, and the MIC verification fails

In a related embodiment, UE may be configured with a policy (that may also be hardcoded in source code or configured by the CN or RAN) that determines how the UE should (re-)establish or resume an RRC connection, depending on factors including, but not limited to:
Failure cause (e.g., failure to resolve old gNB ID, or UE context verification failure); and/or
I-RNTI type (e.g., short or full); and/or
Whether UE is (pre-)configured with a public key.
   Furthermore, in case a high priority establishment or resume cause cannot be protected (e.g., First time joining the network, or RRCResumeRequest failure due to a failure UE context verification with no available public key), the policy may permit the UE to use a non-high priority cause or “Emergency” cause. This has the advantage of letting the UE establish a connection without revealing its identity.

In a related embodiment, protecting a message may refer to encrypting the message and/or integrity protecting the message and/or freshness protecting the message.

In a further embodiment, if above solution is used, then an AMF that is experiencing load difficulties should not set a policy in a gNB allowing access of “highPriorityAccess”.

In a further embodiment, if above solution is used, then an AMF that is experiencing load difficulties may set a policy in a gNB allowing access of “highPriorityAccess”, however, based on above solutions, “highPriorityAccess” UEs will used

In accordance with above embodiments, it is proposed an apparatus and method to securely communicate from a User Equipment to a network entity (e.g., base station or access device) the establishment/resume cause associated with the access identity of the user equipment in a message of the random-access procedure, wherein the method comprises indicating to/(pre-) configuring the user equipment, by the network entity, with a cryptographic key to use during the (re-)establishment or resuming of an RRC connection; the UE protecting the establishment/Release cause with said cryptographic key, and sending an RRCSetupRequest or RRCResumeRequest containing the protected establishment/resume cause and the UE identity associated with the UE context; the network entity retrieving the UE context and/or cryptographic key associated with UE identity and using said key to reveal the protected establishment/resume cause.

In accordance with above embodiments, it is proposed an apparatus and method that can be implemented in a first device (e.g., user equipment) to securely communicate to a second device (e.g., an access device) a field (e.g., the establishment/resume cause) associated with the access identity of the apparatus wherein the method/apparatus is adapted to one or more of the following:
Receiving an indication from the second device regarding the AMF load status, and only using a “highPriorityAccess” access if the AMF is overloaded;
Using the high-priority access cause value (“highPriorityAccess”) in a second message (e.g., RRC connection request message) only if the UE is rejected after a first message (e.g., RRCSetupRequest);
   Protecting (e.g., encrypting) the priority access cause only if the apparatus has been first rejected and/or the second device has indicated an overloaded AMF.

### Embodiment 62

Subscription Concealed Identifier (SUCI) was introduced to conceal and preserve the privacy of the Subscription Permanent Identifier (SUPI). As specified in clause 6.12.2 of TS 33.501, SUCI contains six parts: SUPI type, Home Network Identifier, Routing Indicator, Protection Scheme Identifier, Home Network Public Key Identifier, and Scheme Output. The Home Network Identifier (HNI) and Routing indicator (RID) (defined in clause 2.2B of TS 23.003) are used to identify and route communication to the home network of the subscriber.

A potential privacy issue might stem from the Home Network Identifier and Routing indicator not being concealed/encrypted/protected in the SUCI. For instance, an adversary listening on the air interface might be able to identify and track subscribers with a sensitive Home Network Identifier e.g., a public safety official (e.g., police) with a UE subscribed to a public safety PLMN may be distinguishable from other (nearby) UEs and/or subscribers to a 5G private network. This is similar to the issue described in other embodiments in which, e.g., the (rough) location of the UE needs to be shared in NTN use cases.

Thus, an aim is to provide a means to prevent an attacker from learning these private information by eavesdropping on the air interface. This aim can be addressed by means of one or several embodiments that may be combined with each other as appropriate.

In an embodiment, a UE trying to connect to a network/performing the initial registration (e.g., Home network) may
conceal/encrypt one or more first identifiers (e.g., SUPI) as described in TS 33.501 hence deriving the SUCI (first concealed identifier)
conceal/encrypts one or more second identifiers (e.g., Home Network Identifier (HNI) and/or routing indicator (RID), etc) using the serving network's (e.g., VPLMN) public key hence deriving the Concealed Home Network Identifier and Routing Indicator (CHNIRI),
Transmit the first concealed identifier (SUCI) and the second concealed identifier (CHNIRI) to the serving network over a radio access network

In a related embodiment, concealing/encrypting may also refer to security protection, e.g., confidentiality protection or integrity protection.

In a related embodiment, if the UE is served by the HPLMN, both the first and second identifiers are concealed/encrypted by means of the same key, e.g., the public key of the HPLMN, for performance purposes.

In a related embodiment, if the UE is served by the HPLMN, the first and second identifiers may be concealed/encrypted by means of two keys, e.g., two public keys, associated to the HPLMN, whereby the first key may be stored in a NF (e.g., UDM) in charge of de-concealing the first concealed identifier and the second key may be stored/used in a NF (e.g., AMF/SEAF) in charge of access and session management.

In a related embodiment, if the identifiers (e.g., SUCI and CHNIRI) are concealed with two different keys, common input parameters for the concealing process may be reused, e.g., for performance purposes. For instance, if a nonce or counter (e.g., time-based counter such as a UTC-based counter) is used, then the same nonce/counter may be used for both concealing/encryption processes.

In a related embodiment, HNI and RID may refer to HNI and RID, but also to other parameters that may need to be received by the VPLMN which may pose a privacy risk.

In a related embodiment, the UE sends the concatenation of SUCI and CHNIRI to the network, in particular, to the VPLMN or to the HPLMN.

In a related embodiment, a NF in the VPLMN receives the concatenation of SUCI and CHNIRI, the VPLMN decrypts HNI and RID from CHNIRI, and routes SUCI to the HPLMN indicated by HNI.

In a related embodiment, the RAN of the (V/H) PLMN makes the public key of the (V/H) PLMN available to the UE. This may allow the UE to encrypt the HNI and RID, e.g., the public key may be shared in a SIB, e.g., on demand.

In a related embodiment, the RAN of the (V/H) PLMN makes the identifier of the (V/H) PLMN it supports available to the UE. This may allow the UE to choose a suitable key, e.g., a public key, to encrypt HNI and RID, where said key may have been (pre-)configured and stored locally in the UE/USIM.

In a related embodiment, the HPLMN is in charge of configuring the UEs with the public keys to use when connecting to different VPLMNs. For instance, if a HPLMN has an agreement with VPLMN1, then HPLMN (pre-)configures UE with a public key to be used when served by VPLMN1, and provides VPLMN1 with the corresponding private key.

This approach has the advantage that the key configuration in the UEs is simplified since it depends on the HPLMN, but a VPLMN may have to perform multiple decryptions (blind decryption) to determine the right key.

In a related embodiment variant, a key may refer to an identity-based key so that the identity of the serving network is used as public key. This reduces the communication overhead to distribute/store public keys in the UEs.

In a related embodiment variant, a UE that has attempts to establish a communication through a VPLMN/serving PLMN may send a temporary identifier (e.g., GUTI) so that neither the first (concealed) identifier nor the second (concealed) identifier(s) need to be exchanged.

In a related embodiment, the first and/or second identifiers are protected (e.g., encrypted) in such a way that the first and/or second protected (e.g., encrypted) identifiers and/or the concatenation of first and second identifiers have constant length. This aims at reducing the communication overhead while preventing an attacker from learning/guessing the first or/and second identifiers.

In a related embodiment, the first and/or second identifiers are protected (e.g., concealed/encrypted, in such a way that the first identifier (e.g., SUCI) is concealed as described in TS 33.501, then the second identifiers (e.g., HNI, RID) are concatenated to the first concealed identifier, and the whole is encrypted/concealed as described in prior/below embodiments. This has the advantage of preventing an attacker from learning/guessing the first and/or second identifiers.

In a related embodiment, the message including the identifiers of the UE includes an implicit/explicit identifier indicating how the first and second identifiers are protected. An implicit identifier maybe based on the fields present in the message or the message length. An explicit identifier may be based on the indication of whether the first and/or second identifiers are protected or not.

In another embodiment variant, the UE might use a symmetric key derived from the UE's Ephemeral key pair (i.e., the key pair used to derive SUPI protection keys) and the serving network's (e.g., VPLMN) public key, wherein the UE uses its Ephemeral private key and VPLMN's public key to derive an Ephemeral Shared key, which is (or a key derived from it) used to encrypt/conceal the HNI and RID. When received (e.g., in the Registration Request, or NAS identity response) by a NF (e.g., AMF) in the serving network (e.g., VPLMN), a deconcealing function may be called to derive the Ephemeral Shared key from UE's Ephemeral Public Key (included in SUCI) and the serving network's private key, then use it (or a key derived from it) to decrypt/deconceal the HNI and RI. This has the advantage of re-using the same Ephemeral Key Pair used to protect SUPI to establish a symmetric key(s) with the serving network, thus ensuring that only the intended serving network obtains HNI and RI.

In another embodiment variant, UE may generate a second Ephemeral Key Pair and use it to derive a symmetric key shared with the serving network (e.g., VPLMN), and protect HNI and RID similarly to the previous embodiment.

In another embodiment, a UE may employ either one of the protection mechanisms described in the above embodiments when sending the Registration Request (e.g., when UE sends SUCI instead of 5G-GUTI) and/or the NAS Identity Response (e.g., when AMF sends a NAS Identity Request), and/or whenever UE is required to communicate the HNI and RI to a serving network.

In general, it is proposed a method that can be implemented in a user equipment device adapted to:
Conceal a first identifier (e.g., SUPI) by using a key associated to the HPLMN into a first concealed identifier (e.g., SUCI);
Conceal a second identifier (e.g., Home Network Identifier) by using a key associated to the VPLMN or serving network into a second concealed identifier.
Sending the first concealed identifier and the second concealed identifier to the VPLMN or serving network over an access network.

Different embodiments and embodiment variants may be combined with each other, as suitable.

### Embodiment 62

The potential privacy issue concerning HNI and RID, described in above embodiments may not only affect SUCI but also the AKMA Key Identifier (A-KID) which has the format username@realm, where username includes the routing indicator (RID) and AKMA temporary ID (A-TID), and realm includes HNI. According to clause 6.2.1 in TS 33.535, UE shall include the derived A-KID in the Application Session Establishment Request message that is sent to an AKMA Application Function. Thus, the HNI and RID may be obtained by intercepting the Application Session Establishment Request message.

In an embodiment, the UE and AF (e.g., local AF e.g., in the same serving network, or an AF in HPLMN, or an external AF in the data network) may establish/agree on a secret key at application level to protect/encrypt A-KID before sending it in the AKMA Application Session Establishment Request.

In a related embodiment, the secret key maybe a symmetric key or it may be a public/private key pair where the public key is configured in the UE and the AF keeps the private key.

In another embodiment, if the UE is roaming in a serving network (e.g., VPLMN) and trying to establish a session with an AF within the same network (e.g., VPLMN), the UE may send A-KID concealed/encrypted (e.g., with VPLMN's public key) to the serving network (e.g., VPLMN) together with the Application Function's ID (AF_ID) and have the VPLMN send/forward the AKMA Session Establishment Request to AF after deconcealing/decrypting A-KID.

In another embodiment variant, if the UE is roaming in a serving network (e.g., VPLMN) and trying to establish a session with an AF within the same VPLMN, UE may send the A-KID encrypted (e.g., with VPLMN's public key) in the AKMA Session Establishment Request message to AF, then AF sends A-KID to a NF (e.g., SEAF) in the serving network for decryption.

In another embodiment, if the UE is roaming in a serving network (e.g., VPLMN) and trying to establish a session with an AF within the HPLMN, the UE may send A-KID concealed/encrypted (e.g., with HPLMN's public key) in the AKMA Session Establishment Request message to AF. AF may then send the encrypted A-KID to a NF (e.g., AUSF) in HPLMN, which decrypts it and sends it back to AF. Alternatively, to obtain K_AF, AF may send its AF_ID with the encrypted A-KID to AUSF (instead of AAnF), which decrypts it and forwards AF_ID and A-KID to the AAnF determined by the RID, then, AAnF may derive K_AF based on AF_ID and K_AKMA linked to A-KID and send it to the AF.

In another embodiment, if the UE is roaming in a serving network (e.g., VPLMN) and trying to establish a session with an AF within the HPLMN, the UE may send A-KID to a NF (e.g., AMF/SEAF) in the serving network, encrypted/concealed with the serving network's public key or a symmetric key (e.g., Ephemeral shared key or a key derived from it, as described in embodiment 7). The encrypted A-KID is then decrypted by a NF (e.g., SEAF) in the serving network (e.g, VPLMN) and forwarded to the AF in HPLMN. In accordance with embodiment 7.1, it is proposed a method which can be implemented in a User Equipment device, whereby the UE is adapted to
establish, or be (pre-)configured with key(s) by a network entity (e.g., AF) or a network (V/H PLMN),
conceal identifiers (e.g., Home Network Identifier, Routing indicator) using the key(s) associated with a network entity (e.g., AF), or with the network (V/H PLMN) where said network entity is serving,
send the concealed identifier(s) to the network entity, or the network (V/H PLMN) where said network entity is serving.

### Embodiment 63

In some situations, a simple (single factor) authentication procedure based on cryptographic keys may not be sufficient, e.g., if devices have been manipulated or compromised. Addressing this need can require enhancing authentication procedures with a second authentication factor or with multiple authentication factors, e.g., location, type of device, speed of the device, behavior of the device, sensor data gathered by the sensors of the device.

According to another aspect that may be used independently of the same purpose of increasing an integrity of signals in a signaling network, a node engaging in a procedural dialogue with a peer (e.g., a UE connecting to an access device, a UE authenticating with the core network, a UE authenticating with an AF, etc) may measure additional parameters, e.g.,
some physical layer parameters of each transmitted signal from the peer received by the node and/or
sensor data from the UE (e.g., from an accelerometer) and/or
biometric data e.g., the voice of the user and/or
Other parameters that may serve as a second authentication factor, e.g. physical layer measurements.
   The measurements may be combined into a ‘fingerprint’ that is representative of, e.g., the transmitted signals from the peer node (e.g., access device), as seen by the first node (e.g., UE) as well as other parameters that may be measured by the UE. If the dialogue is interrupted/modified/etc by a transmission from a third node, whether intentional (e.g., overshadowing attack) or unintentional, measurements made by the first node (e.g., UE) will be combined to form a fingerprint significantly different from that expected. If a different user is making use of the UE, measurements of the UE parameters by a peer node will also result in a different fingerprint than expected. If the location of the UE is different than expected, this will also be detected. This can be used—by any of the communicating parties—to take appropriate action. For example, it might simply discard the signal without attempting to read it, it may set the device/communication as compromised/unauthenticated/etc. For example, it might re-issue the last signal it sent to the peer, or it might instruct the peer to abort or restart the procedure in process.

In one embodiment, the physical parameter includes a measure or measures related to location.

For example, an estimate of the distance between the two nodes. For example, a measurement of angle of arrival of incoming signals from the peer node. The first node may use multiple antennas to collect more detailed information. In another example, the physical parameter may include a measure of the characteristics of the signal itself. For example, a measure of the received signal strength or quality of the signal or a component thereof. For example, a measure of the carrier frequency.

In a related embodiment, a measure of the distance between the fingerprint of the latest received signal and a weighted average of previous fingerprints is calculated. If the calculated distance exceeds a threshold, the first node can assume that the signal did not arrive from the peer node. The weighting used may take into account operational circumstances. For example, if both nodes are relatively static, the weighted average may be used to smooth out measurement noise. In this case, each signal may be weighted equally. In another example, if one or both nodes are in motion, the weighting may favor more recent signals. Alternatively, in the case of motion or other systematic change, previous fingerprints may be used to predict an expected fingerprint for the next signal.

A fingerprint comprising multiple parameters may be represented as a multi-dimensional object. The representation may additionally define a measure of distance that may be used to compare fingerprints. Alternatively, some or all parameters may be processed to reduce the number of dimensions. In the extreme, the fingerprint may be represented as a single figure.

In an embodiment, the parameters that contribute to the fingerprint may have different weights when considered in computing a fingerprint. For example, if the communicating parties are static, a measures or measures related to location may have more weight than e.g., the quality of the signal. Depending on e.g., operational conditions, type of devices, mobility, etc, the parameters considered in a fingerprint may vary (i.e., are accounted for or not) and/or have different weights. In a further embodiment, more than one threshold may be used to determine an appropriate response. For example, a distance exceeding a first threshold may cause a signal to be discarded without further action. A distance exceeding a second threshold may cause the first node to abandon or restart the procedure in progress.

In a further embodiment, the first node may begin a transaction by first determining, e.g., the precise location of the peer node to determine whether the peer node is in a ‘zone of validity’ for the transaction. For example, if the first node is a point of sale terminal, the peer node should be within a small zone of coverage corresponding to the owner being in front of the terminal. At least part of the location information may then form part of the fingerprint. Subsequent signals may then be checked to ensure a) that the peer device stays in the zone for the duration of the transaction and b) that all signals come from the peer device.

In a further embodiment, the fingerprint is alternatively or additionally used to determine whether the peer device is in motion relative to the first device. A change in detected motion may be used to trigger mitigating mechanisms, for example, a change in antenna beam configuration or a handover procedure.

Exemplary procedures that may benefit of the described procedures may include (but are not limited to) a random-access procedure, a (conditional) handover procedure wherein, e.g., the gNB or UE may want to determine that the other party has a suitable signal/fingerprint, a UE-to-UE/Network Relay reselection wherein, e.g., a Remote/End UE may want to switch paths and determine whether the Relay has a suitable signal/fingerprint.

In a further embodiment, a UE may be configured with a policy determining whether the UE requires performing an authentication procedure involving multi-factor authentication. For instance, 5G (or, e.g., 6G) primary authentication or AKMA may be enhanced to support multi-factor authentication (MFA) based on the fingerprint described in other embodiments.

In a further embodiment, the network may communicate the MFA requirements, e.g., in a SIB.

In a further embodiment, the network may communicate the MFA requirements, e.g., in an initial authentication message sent by the core network, e.g., HPLMN of the UE.

In a further embodiment, the network may store different fingerprinting profiles for MFA purposes, depending on e.g., use cases (e.g., handover procedure, or random access procedure), or communicating parties (e.g., End UEs with UE-to-UE relays, or UEs with Access devices e.g., base stations).

In a further embodiment, the MFA requirements may be stored in a NF of the CN in charge of storing UE related data and/or in a NF in the CN in charge of authenticating a UE.

In a further embodiment, measurements of the fingerprint may be securely transferred to the CN (e.g., HPLMN) based on other embodiments, e.g., by encrypting said fingerprint with the public key of the HPLMN, e.g., the RAN of the V/HPLMN may share said measurements with the entity in the CN in charge of performing the authentication.

In a further embodiment, the CN may require the RAN to obtain a fingerprint of the UE with which it is engaging in an authentication procedure. For example, if the UE has been configured with a 2-factor authentication policy involving location, the CN can instruct/pre-configure the RAN to determine the location of the UE (e.g., by means of a positioning method or by means of wireless sensing) and said location (e.g., obtained by the LMF) is sent to an authentication function (e.g., AUSF) that will take into account both the result of the authentication procedure (first factor) and the measured location (second factor) to determine the outcome of the authentication procedure. In a further embodiment, a NF in or outside the CN is performing the MFA authentication of a UE may
perform an authentication handshake (e.g., primary authentication) and
then check whether the MFA fingerprint fits the expected profile of the UE, e.g., whether the reported fingerprint (e.g., location) fits the expected fingerprint (e.g., expected location) of the UE.
   If any of the checks fails, the MFA fails, additionally or alternatively, a risk score may be assigned, e.g. depending on the failure degree of the checks.

In a further embodiment, the authentication function may assign weights to the second or multiple factors considered in the authentication procedure, wherein factors may be probabilistic (e.g., degree of similarity between device fingerprint and the device's expected profile) or deterministic (e.g., a MIC check either succeeds or fails) and the outcome (i.e., whether the authentication is deemed successful or not) may depend on a multi-stage authentication process wherein, initially a primary authentication is performed, and upon success, the other authentication factors are evaluated against e.g., a threshold, to determine whether the authentication is successful or not.

In a further embodiment, if the authentication procedure is MFA based and the result is determined based on a threshold, the network may set the threshold to be variable such that it is updated e.g., every time the device is authenticated. The network may also set limits to how variable the threshold could be.

In a further embodiment, the NF may be the AUSF (or a network function in charge of authentication) or an AF.

In a further embodiment, MFA-AKMA may be defined such that the AKMA anchor function does not only return a key that is derived from K_AKMA but also a fingerprint of the UE, e.g., related to the UE location, so that the AF can base the AKMA-based authentication both on K_AF and the fingerprint of the UE.

In a further embodiment, the fingerprint of a UE may be known only partially to the RAN, and part of the fingerprint may only be known to the UE. For instance, a UE may be able to measure/obtain a fingerprint from:
Physical layer measurements when communicating with the RAN, and/or
The firmware it is running, e.g., the hash of a part (e.g., a number of memory pages) of the firmware, and/or
. . .
   This part of the fingerprint that is only known to the UE may be verified by the CN by means of, e.g., an authentication handshake whereby this part of the fingerprint is used as input of the authentication handshake, e.g., as if it were a key.

In a further embodiment related to the previous one, the network may require:
Indicating to the UE which part of the fingerprint to use as input in the authentication handshake,
Retrieving device related information, e.g., device type,
Retrieving from RAN measurements of the fingerprint (e.g., physical layer measurements) from the physical layer communication between UE and RAN,
Indicating how to incorporate said fingerprint in the authentication handshake.
   For instance, the network may indicate that the fingerprint refers to:
memory pages XYZ and the hash (e.g., SHA-3) of the memory pages should be used as a cryptographic key and/or input in a key derivation function next to a root device secret to derive a key used in the authentication handshake,
the carrier phases measured when exchanging the random-access messages between UE and RAN, and the carrier phases may be used as a cryptographic key and/or input in a key derivation function next to a root device secret to derive a key used in the authentication handshake.

In an embodiment, the authentication procedure may be a fuzzy authentication method that uses non-deterministic or noisy data, like a fingerprint, as an authentication factor whereby a fuzzy extractor is used to extract a key from a noisy fingerprint. Here, “Fuzzy” refers to the fact that the fixed values required for cryptography will be extracted from values close to but not identical (fingerprint) to the original key, without compromising the security required.

In general, above embodiments describe an apparatus that can be implemented on a UE and/or NF for multiple factor authentication wherein the apparatus is adapted to:
Set and/or receive an MFA profile,
Store the MFA profile,
Perform an MFA authentication procedure with a second device wherein the MFA authentication procedure includes an authentication procedure based on a cryptographic key and a fingerprint.

In general, the fingerprint in previous apparatus may include a location.

In general, the apparatus may receive the MFA profile in an initial authentication message from a second device.

In general, the apparatus may securely transfer the fingerprint by encrypting the fingerprint with a key shared with the second device. Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated. Additionally, the expression “at least one of A, B, and C” is to be understood as disjunctive, i.e. as “A and/or B and/or C”.

A single unit or device may fulfill the functions of several items recited in the claims or in the embodiments. The mere fact that certain measures are recited in mutually different dependent claims or in different embodiments does not indicate that a combination of these measures cannot be used to advantage.

The described operations like those indicated in, e.g., FIGS. 4, 5 and 6 be implemented as program code means of a computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus comprising
a processor circuit and a memory circuit, wherein the memory is arranged to store instructions for the processor circuit,
wherein the processor circuit is arranged to send and receive messages,
wherein the processor circuit is arranged to send a first message to a second device,
wherein the first message comprises at least one sensitive fields,
wherein the processor circuit is arranged to receive a verification challenge from the second device,
wherein the processor circuit is arranged to a response based on the verification challenge, keying material shared between a first device and the second device and the at least one sensitive fields,
wherein the processor circuit is arranged to send the response to the second device.

2. The apparatus of claim 1, wherein the at least one sensitive fields are at least one of a security capabilities of the first device and a device type of the first device.

3. The apparatus of claim 1, wherein the response is computed as a cryptographic function of K and the at least one sensitive fields.

4. The apparatus of claim 1, wherein the response is computed as Challenge(K, R, SNname, at least one sensitive fields).

5. The apparatus of claim 1,
wherein the first message comprises a field,
wherein the field indicates that the response is to be computed based on the information exchanged in the first message.

6. An apparatus comprising:
a processor circuit and a memory circuit, wherein the memory is arranged to store instructions for the processor circuit,
wherein the processor circuit is arranged to send and receive messages,
wherein the processor circuit is arranged to receive a first message from a first device,
wherein the first message comprises at least one sensitive fields from,
wherein the processor circuit is arranged to receive a response from the first device,
wherein the processor circuit is arranged to check whether a function of the response matches a value,
wherein the value is based on the at least one sensitive fields in the first message.

7. The apparatus of claim 6,
wherein the apparatus decides the check to based on a field,
wherein the first message comprises the field.

8. The apparatus of claim 6, wherein the apparatus checks whether the response matches a cryptographic function of K and User Equipment security capabilities.

9. The apparatus of claim 8, wherein the apparatus checks whether the response matches a cryptographic function of K.

10. (canceled)

11. A method comprising:
sending a first message to a second device, wherein the first message comprises at least one sensitive fields;
receiving a verification challenge from the second device;
computing a response based on the verification challenge, keying material shared between a first and second device and at least one sensitive fields; and
sending the response to the second device.

12. An apparatus comprising:
a processor circuit and a memory circuit, wherein the memory is arranged to store instructions for the processor circuit,
wherein the processor circuit is arranged retrieving a symmetric-key if a security context is available and a configured policy allows it; or
generating a symmetric-key and using a first public-key bounded to a private-key to encrypt the generated symmetric-key if no security context is available or a configured policy requires it, wherein the private key is owned by the second device; and
) sending to the second device a secure message protected with the symmetric key and the protected symmetric-key or an indication to retrieve the symmetric-key to the second device.

13. The apparatus of claim 12, wherein the message is an initial registration request.

14. The apparatus of claim 13,
wherein processor circuit apparatus is arranged to use the symmetric-key to protect at least one private fields and a secret identifier; or
wherein processor circuit is arranged use the symmetric-key to protect at least one private fields if the message comprises a pseudo identifier of the secret identifier.

15. The apparatus of claim 12, wherein the message is a random-access message.

16. The apparatus of claim 13, wherein the at least one private fields is selected from the group consisting of Security capabilities, Location, User consent preferences and ResumeCause.

17. The apparatus of claim 14, wherein the at least one fields are shared with a third device.

18. The apparatus of claim 12, comprising a receiver circuit, wherein the receiver circuit is arranged to receive a protected message comprising at least one of the request to share the user location, confirmation of the security capabilities and confirmation on user consent preferences.

19. An apparatus comprising:
a processor circuit and a memory circuit, wherein the memory is arranged to store instructions for the processor circuit,
wherein the processor circuit is arranged to store a policy, wherein the policy determines the apparatus behavior when a Direct Security Mode Command is received,
wherein the processor circuit is arranged to reject and/or accept a Direct Security Mode Command,
wherein the Direct Security Mode Command that is unprotected and/or comprises NULL ciphering and integrity algorithms based on the policy,
wherein the policy comprises determining whether the apparatus had previously sent a DCR message,
wherein the DCR message comprises an emergency RSC.

20. The apparatus of claim 19,
wherein the processor circuit is arranged to only accept a received Direct Security Mode Command that is unprotected and/or comprises NULL ciphering and integrity algorithms if the apparatus had previously sent a DCR message,
wherein the DCR messaged comprises an emergency RSC.

21. The apparatus of claim 20,
wherein the processor circuit is arranged to reject a received Direct Security Mode Command that is unprotected and/or comprises NULL ciphering and integrity algorithms if the apparatus has not previously sent a DCR message,
wherein the DCR message comprises an emergency RSC.

22. A method comprising:
storing a policy, wherein the policy is arranged to determine a User Equipment behavior when a Direct Security Mode Command is received; and
rejecting and/or accepting a Direct Security Mode Command that is unprotected and/or comprises NULL ciphering and integrity algorithms based on the policy comprises determining whether the apparatus had previously sent a DCR message, wherein the DCR message comprises an emergency RSC.

23. A method comprising:
signaling Lawful Interception requirements to a first network function in a first network, wherein Lawful Interception requirements are originate from a second network
receiving from the first network function key material; and
decrypting intercepted traffic exchanged between a User Equipment and an application function based on the provided key material.

24. The method of claim 23, further comprising:
receiving key material from the first network function; and
collecting an AKMA keying material.

25. A method for lawful interception comprising:
receiving signaling of Lawful Interception requirements from a second network function in a second network and
transmitting key material to the second network function, so that the second network function can decrypt intercepted traffic exchanged between a User Equipment, UE, and an application function based on the key material.

26. The method of claim 25, further comprising providing key material to the second network function, wherein the second network function collects the AKMA keying material.

27. The method of claim 25,
wherein a Home Network Triggered Primary Authentication is triggered upon reception of an acknowledgement from the second network function,
wherein the second network function is be located in the first network or the second network,
wherein the acknowledgement confirms that the keying material has been received successfully.

28. The method of claim 25, further comprising:
receiving a key request;
computing the requested keying material
sharing keying material with the second network function; and upon confirmation of the correct reception of the key.

29. The method of claim 23, wherein the second network is the same as the first network.

30. The method of claim 25, further comprising:
receiving a key request and security parameters from a third network function; and
determining the key material,
sharing the key material and the security parameters with the second network function
wherein the second network function can monitor or intercept or cache a message sent by the third network function to a further entity,
wherein the second network function verifies the validity of the received security parameters.

31. The method of claim 23, further comprising:
receiving the key material and security parameters from the first network function after to a key request from a third network function, wherein the key request is sent with the security parameters;
intercepting a message sent by the third network function to a further entity; and
verifying the validity of the received security parameters.

32. The method of claim 31, further comprising releasing the message the further entity if the verification is successful.

33. A second Network Function apparatus comprising:
a processor circuit and a memory circuit, wherein the memory is arranged to store instructions for the processor circuit,
wherein the processor circuit is arranged signaling Lawful Interception requirements to a first network function in a first network, and
wherein the processor circuit is arranged to receive key material,
wherein the processor circuit is arranged to decrypt intercepted traffic exchanged between a User Equipment and an application function based on the provided key material.

34. A first Network Function apparatus comprising:
a processor circuit and a memory circuit, wherein the memory is arranged to store instructions for the processor circuit,
wherein the processor circuit is arranged to receive signaling of Lawful Interception requirements from a second network function in a second network,
wherein the processor circuit is arranged to transmit key material to the first network function,
wherein the second network function can decrypt intercepted traffic exchanged between a User Equipment and an application function based on the key material.

35. (canceled)

36. A computer program stored on a non-transitory medium, wherein the computer program when executed on a processor performs the method as claimed in claim 11.

37. A computer program stored on a non-transitory medium, wherein the computer program when executed on a processor performs the method as claimed in claim 22.

38. A computer program stored on a non-transitory medium, wherein the computer program when executed on a processor performs the method as claimed in claim 23.

39. A computer program stored on a non-transitory medium, wherein the computer program when executed on a processor performs the method as claimed in claim 25.
